(19) United States
(12) Patent Application Publication
(10) Pub. No.: US 2025/0254624 A1
(43) Pub. Date: Aug. 7, 2025

(54) METHOD AND APPARATUS FOR UPLINK SCHEDULING CONSIDERING PATHLOSS IN NETWORK COOPERATIVE COMMUNICATION

(71) Applicant: Samsung Electronics Co., Ltd., Gyeonggi-do (KR)

(72) Inventors: Youngrok JANG, Gyeonggi-do (KR); Ameha Tsegaye ABEBE, Gyeonggi-do (KR); Seongmok LIM, Gyeonggi-do (KR); Hyoungju JI, Gyeonggi-do (KR)

(21) Appl. No.: 19/044,068

(22) Filed: Feb. 3, 2025

(30) Foreign Application Priority Data
Feb. 1, 2024 (KR) 10-2024-0016192
May 9, 2024 (KR) 10-2024-0061471

(51) Int. Cl. H04W 52/14; H04W 52/24

(52) U.S. Cl. CPC H04W 52/146; H04W 52/242

(57) ABSTRACT

The disclosure relates to a fifth generation 5G or sixth generation (6G) communication system for supporting a higher data transmission rate. A method of a user equipment includes receiving, via higher layer signaling, a first configuration of a list of transmission configuration indication (TCI) states, receiving a first medium access control (MAC) control element (CE) to activate TCI states among the TCI states in the list, wherein the MAC CE maps the activated TCI states to codepoints of a TCI field in downlink control information (DCI), receiving the DCI including the TCI field with a codepoint, identifying an indicated TCI state based on the codepoint, identifying first transmission power for a first uplink transmission based on a pathloss offset value included in the indicated TCI state, and transmitting the first uplink transmission based on the first transmission power.

### CROSS REFERENCE TO RELATED APPLICATION(S)

The present application claims priority to Korean Patent Application Nos. 10-2024-0016192 and 10-2024-0061471, which were filed in the Korean Intellectual Property Office on Feb. 1, 2024, and May 9, 2024, respectively, the entire content of each of which is incorporated herein by reference.

### BACKGROUND

### 1. Field

The disclosure relates generally to a terminal and a base station (BS) in a wireless communication system, and more particularly, to an uplink (UL) scheduling method and apparatus considering a pathloss (PL) difference (PL offset) in network cooperative communication in a wireless communication system.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered to implement sixth generation (6G) mobile communication technologies referred to as beyond 5G systems in terahertz (THz) bands, such as 95 GHz to 3 THz bands to realize transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of the bandwidth part (BWP), new channel coding methods such as a low density parity check (LDPC) code for a large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel for NR (2-step RACH for NR) to simplify random access procedures. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A wireless communication system has developed from providing a voice centered service in the early stages to broadband wireless communication systems providing high-speed, high-quality packet data services, such as communication standards of high speed packet access (HSPA) of the third generation partnership project (3GPP), long term evolution (LTE), or evolved universal terrestrial radio access (E-UTRA), LTE-advanced (LTE-A), LTE-pro, high rate pack data (HRPD) of 3GPP2, ultra mobile broadband (UMB), institute of electrical and electronics engineers (IEEE) 802.16e or the like.

An LTE system employs an orthogonal frequency division multiplexing (OFDM) scheme in the DL and employs a single carrier frequency division multiple access (SC-FDMA) scheme in the UL, which indicates a radio link through which a UE or a mobile station (MS) transmits data or control signals to a BS (BS) (or eNode B). The DL indicates a radio link through which the BS transmits data or control signals to the UE. The above multiple access scheme may separate data or control information of respective users by allocating and operating time-frequency resources for transmitting the data or control information for each user to avoid overlapping each other, that is, to establish orthogonality.

Since a 5G communication system must freely reflect various requirements of users, service providers, and the like, services satisfying various requirements must be supported. The services considered in the 5G communication system include enhanced mobile broadband (eMBB) communication, massive machine type communication (mMTC), ultra reliability low latency communication (URLLC), and the like.

The eMBB aims to provide a data rate higher than that supported by existing LTE, LTE-A, or LTE-Pro. For example, in the 5G communication system, eMBB must provide a peak data rate of 20 Gbps in the DL and a peak data rate of 10 Gbps in the UL for a single BS. Furthermore, the 5G communication system must provide an increased user-perceived data rate to the UE, as well as the maximum data rate. To satisfy such requirements, transmission/reception technologies including a further enhanced multi input multi output (MIMO) transmission technology are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

The mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, to effectively provide the IoT. Since the IoT provides communication functions while being provided to various sensors and various devices, it must support a large number of UEs (e.g., 1,000,000 UEs/squared kilometers (km2)) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 15 years, because it is difficult to frequently replace the battery of the UE.

The URLLC is a cellular-based mission-critical wireless communication service. For example, the services used for remote control for robots or machines, industrial automation, unmanned aerial vehicles, remote health care, emergency alert, and the like may be considered. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and at the same time, may require a design for assigning a large number of resources in a frequency band to secure reliability of a communication link.

Three services in the 5G, that is, eMBB, URLLC, and mMTC, may be multiplexed and transmitted in a single system. In this case, different transmission/reception techniques and transmission/reception parameters may be used between services to satisfy different requirements of the respective services. 5G is not limited to the above-described three services.

Different than conventional communication systems, a 5G wireless communication system may support both a service having a very short transmission delay and a service requiring a high connection density, as well as a service requiring a high transmission rate. In a wireless communication network including a plurality of cells, transmission and reception points (TRPs), or beams, cooperative communication (coordinated transmission) between cells, TRPs, and/or beams may satisfy various service requirements by increasing the strength of a signal received by the UE or efficiently controlling interference between cells, TRPs, and/or beams.

Joint transmission (JT) is a representative transmission technology for the cooperative communication, which may increase the strength or throughput of a signal received by the UE by transmitting signals to one UE through a number of different cells, TRPs, and/or beams. In this case, the characteristics of the channel between the cells, TRPs, and/or beams and the UE may be significantly different. In particular, non-coherent joint transmission (NC-JT) supporting non-coherent precoding between the cells, TRPs, and/or beams may require individual precoding, modulation and coding scheme (MCS), resource allocation, TCI indication, etc., depending on the channel characteristics for each link between the cells, TRPs, and/or beams and UE.

The NC-JT transmission may be applied to at least one of a physical DL shared channel (PDSCH), a physical DL control channel (PDCCH), a physical UL shared channel (PUSCH), and a physical UL control channel (PUCCH). Transmission information such as precoding, MCS, resource allocation, TCI, and the like is indicated by DL DCI when transmitting a PDSCH. The transmission information must be independently indicated for each cell, TRP, and/or beam for NC-JT transmission, which increases a payload required for DL DCI transmission and may adversely affect reception performance of a PDCCH transmitting DCI.

Therefore, there is a need in the art for a method and apparatus providing a tradeoff between the amount of DCI information and the control information reception performance to support the PDSCH JT.

### SUMMARY

The disclosure has been made to address at least the above-mentioned problems and/or disadvantages and to provide at least the advantages described below.

Accordingly, an aspect of the disclosure is to provide a method and apparatus to support the PDSCH JT in a wireless communication system.

In accordance with an aspect of the disclosure, a method performed by a user equipment (UE) in a communication system includes receiving, via higher layer signaling, a first configuration of a list of transmission configuration indication (TCI) states, receiving a first medium access control (MAC) control element (CE) to activate TCI states among the TCI states in the list, wherein the MAC CE maps the activated TCI states to codepoints of a TCI field in downlink control information (DCI), receiving the DCI including the TCI field with a codepoint, identifying an indicated TCI state based on the codepoint, identifying first transmission power for a first UL transmission based on a pathloss offset value included in the indicated TCI state, and transmitting the first UL transmission based on the first transmission power.

In accordance with an aspect of the disclosure, a user equipment (UE) in a communication system includes a transceiver; and a processor coupled with the transceiver and configured to receive, via higher layer signaling, a first configuration of a list of transmission configuration indication (TCI) states, receive a first medium access control (MAC) control element (CE) to activate TCI states among the TCI states in the list, wherein the MAC CE maps the activated TCI states to codepoints of a TCI field in downlink control information (DCI), receive the DCI including the TCI field with a codepoint, identify an indicated TCI state based on the codepoint, identify first transmission power for a first UL transmission based on a pathloss offset value included in the indicated TCI state, and transmit the first UL transmission based on the first transmission power.

In accordance with an aspect of the disclosure, a method performed by a BS in a communication system includes transmitting, via higher layer signaling, a first configuration of a list of transmission configuration indication (TCI) states, transmitting a first medium access control (MAC) control element (CE) to activate TCI states among the TCI states in the list, wherein the MAC CE maps the activated TCI states to codepoints of a TCI field in downlink control information (DCI), transmitting the DCI including the TCI field with a codepoint, and receiving a first UL transmission associated with first transmission power, wherein the first transmission power is based on a pathloss offset value included in a TCI state indicated by the codepoint.

In accordance with an aspect of the disclosure, a BS in a communication system includes a transceiver, and a processor coupled with the transceiver and configured to transmit, via higher layer signaling, a first configuration of a list of transmission configuration indication (TCI) states, transmit a first medium access control (MAC) control element (CE) to activate TCI states among the TCI states in the list, wherein the MAC CE maps the activated TCI states to codepoints of a TCI field in downlink control information (DCI), transmit the DCI including the TCI field with a codepoint, and receive a first UL transmission associated with first transmission power, wherein the first transmission power is based on a pathloss offset value included in a TCI state indicated by the codepoint.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a basic structure of a time-frequency domain in a wireless communication system according to an embodiment;

FIG. 2 illustrates a frame, a subframe, and a slot structure in a wireless communication system according to an embodiment;

FIG. 3 illustrates a BWP configuration in a wireless communication system according to an embodiment;

FIG. 4 illustrates radio protocol structures of a terminal and BS in single cell, carrier aggregation, and dual connectivity situations in a wireless communication system according to an embodiment;

FIG. 5 illustrates a beam application time to consider in using a unified TCI scheme in a wireless communication system according to an embodiment;

FIG. 6 illustrates another MAC-CE structure for joint TCI state or separate DL (DL) or UL TCI state activation and indication in a wireless communication system according to an embodiment;

FIG. 7 illustrates configuring a control resource set (CORESET) of a DL control channel in a wireless communication system according to an embodiment;

FIG. 8 illustrates a structure of a DL control channel in a wireless communication system according to an embodiment;

FIG. 9 illustrates a process for beam configuration and activation of a PDSCH according to an embodiment;

FIG. 10 illustrates antenna port configuration and resource allocation for cooperative communication in a wireless communication system according to an embodiment;

FIG. 11 illustrates DL DCI configuration for cooperative communication in a wireless communication system according to an embodiment;

FIG. 12 illustrates an enhanced PDSCH TCI state activation/deactivation MAC-CE structure according to an embodiment;

FIG. 13 illustrates operations of a BS and terminal operating with multiple TRPs including a TRP supporting only a UL reception function, according to an embodiment;

FIG. 14 illustrates a method for calculating and updating a PL difference value according to an embodiment;

FIG. 15 illustrates another method for calculating and updating a PL difference value according to an embodiment;

FIG. 16 illustrates a method of a terminal for UL transmission power control according to an embodiment;

FIG. 17 illustrates a method of a BS for UL transmission power control according to an embodiment;

FIG. 18 illustrates a method of a terminal for UL transmission scheme determination according to an embodiment;

FIG. 19 illustrates a method of a BS for UL transmission scheme determination according to an embodiment;

FIG. 20 illustrates the structure of a terminal in a wireless communication system according to an embodiment; and

FIG. 21 illustrates the structure of a BS in a wireless communication system according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification. Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete, and are provided to fully inform the scope of the disclosure to those of ordinary skill in the art to which the disclosure pertains.

Like reference numerals refer to like components throughout the specification.

An element described herein is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements. Hereinafter, a/b may be understood as at least one of a and b.

Embodiments herein may be employed in combination and operated, as necessary. For example, one embodiment, and the embodiments may be implemented in other systems such as frequency division duplex (FDD) LTE systems, time division duplex (TDD) LTE systems, 5G or NR systems, and other variants based on the technical idea of the disclosure.

Some or all of the contents of each embodiment may be implemented in combination without departing from the scope of the disclosure.

Herein, a BS is an entity for performing resource allocation for a terminal, and may be at least one of a gNode B, an eNode B, a Node B, a radio access unit, a BS controller, and a node on a network. A terminal may include a UE, an MS, a cellular phone, a smart phone, a computer, or a multimedia system capable of performing a communication function. In the disclosure, DL refers to a radio transmission path for a signal transmitted from a BS to a UE, and UL refers to a radio transmission path for a signal transmitted from a UE to a BS. LTE or LTE-advanced (LTE-A) systems may be described by way of example, but the disclosure may also be applied to other communication systems having similar technical backgrounds or channel types, such as 5G and NR developed beyond LTE-A. 5G may be the concept that covers the exiting LTE, LTE-A, or other similar services.

The disclosure may be applied in FDD, TDD and/or cross division duplex (XDD) (and/or subband non-overlapping full duplex (SBFD), full duplex) systems. Hereinafter, higher signaling or higher layer signaling is a signal transmission method in which signals are transmitted from a BS to a UE using a DL data channel of a physical layer or from a UE to a BS using a UL data channel of a physical layer, and may be referred to as radio resource control (RRC), packet data convergence protocol (PDCP), or MAC CE signaling.

For convenience of description, higher layer/L1 parameters, such as a TCI state and spatial relation information, or cells, transmission points, panels, beams, and/or transmission directions distinguishable by indicators, such as cell ID, TRP ID, and panel ID, may be collectively described as a transmission reception point (TRP), beam or TCI state. Accordingly, the TRP, beam, or TCI state may be replaced by one of the above terms.

In the disclosure, higher layer signaling may be at least one of a master information block (MIB), a system information block (SIB) or SIB X (X=1, 2, . . . ), RRC, or a MAC CE.

In addition, layer 1 (L1) signaling may use the physical layer channels or signaling including a PDCCH, DCI, UE-specific DCI, group common DCI, common DCI, scheduling DCI (for scheduling DL or UL data), non-scheduling DCI (not for scheduling DL or UL data), PUCCH and UL control information (UCI).

Determining the priority between A and B may be variously construed such as selecting one having a higher priority according to a predetermined priority rule and performing an operation corresponding thereto or omitting an operation on one having a lower priority.

The term slot used herein may refer to a specific time unit corresponding to a transmit time interval (TTI), and may be used in a 5G NR system, or a slot or subframe used in a 4G LTE system.

Herein, greater than or equal to may be replaced with more than, and less than or equal to may be replaced with less than, more than may be replaced with greater than or equal to, and less than may be replaced with less than or equal to.

### NR Time-Frequency Resources

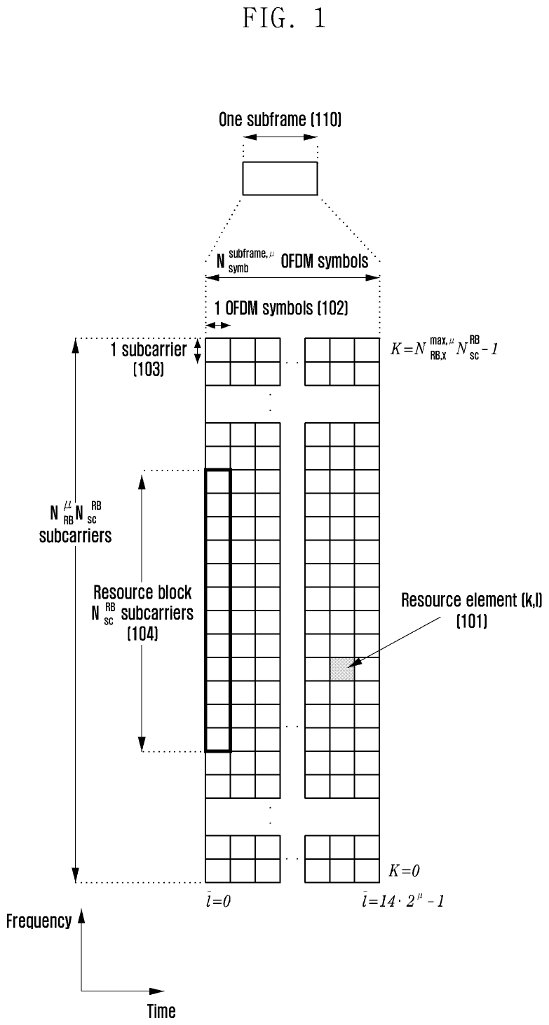

FIG. 1 illustrates a basic structure of a time-frequency domain that is an RRC area in which data or a control channel is transmitted in a 5G system according to an embodiment.

Referring to FIG. 1, a horizontal axis represents a time domain, and a vertical axis represents a frequency domain. A basic unit of a resource in the time and frequency domains is a resource element (RE) 101, and may be defined to be 1 OFDM symbol 102 on the time axis and 1 subcarrier 103 on the frequency axis. N_{SC}^{RB}. (e.g., 12) consecutive REs in the frequency domain may constitute one resource block (RB) 104. One subframe 110 may comprise a plurality of OFDM symbols 102 on the time axis. For example, the length of one subframe may be 1 millisecond (ms).

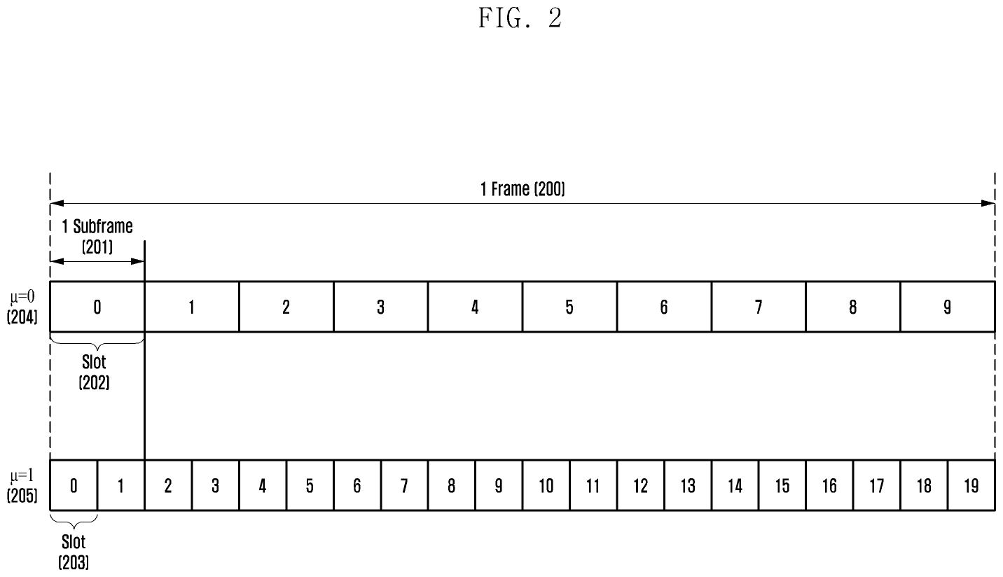

FIG. 2 illustrates a frame, a subframe, and a slot structure in a wireless communication system according to an embodiment.

Referring to FIG. 2, a frame 200, a subframe 201, and a slot 202 structure are shown. One frame 200 may be defined to be 10 ms. One subframe 201 may be defined to be 1 ms, and thus one frame 200 may be constituted with a total of 10 subframes 201. One slot 202 or 203 may be defined to be 14 OFDM symbols (that is, the number of symbols per slot (N_{symb}^{slot})=14). One subframe 201 may be constituted with one or a plurality of slots 202 and 203, the number of slots 202 and 203 per subframe 201 may vary according to a configuration value μ 204 or 205 for a subcarrier spacing. FIG. 2 illustrates a case 204 where μ=0 and a case 205 where μ=1, for subcarrier spacing configuration values. In case 204 where μ=0, one subframe 201 may be constituted with one slot 202, and in the case 205 where μ=1, one subframe 201 may be constituted with two slots 203. That is, the number (Nₛₗₒₜ^{subframe,μ}) of slots per one subframe may vary according to configuration value μ for a subcarrier spacing. Accordingly, the number (Nₛₗₒₜ^{frame,μ}) of slots per one frame may vary. Nₛₗₒₜ^{subframe,μ} and Nₛₗₒₜ^{frame,μ} according to respective slot subcarrier spacing configurations u may be defined in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### BWP

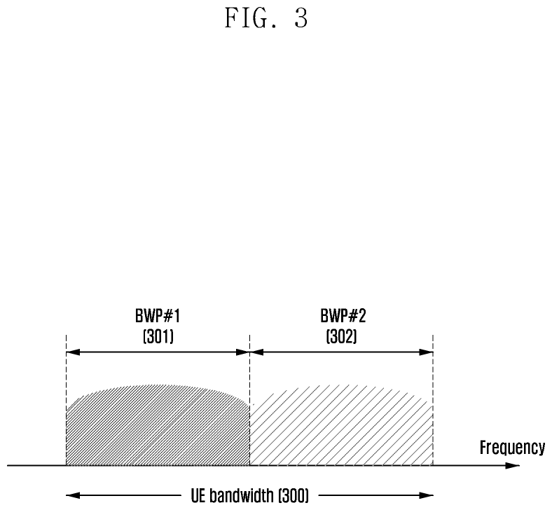

FIG. 3 illustrates a BWP configuration in a wireless communication system according to an embodiment.

Referring to FIG. 3, an example is given in which a UE bandwidth 300 is configured to have two BWPs, that is, BWP #1 301 and BWP #2 302. A BS may configure one or a plurality of BWPs for a UE, and may configure, for each BWP, information as shown in Table 2 below.

TABLE 2

| | |
|---|---|
| BWP ::= | SEQUENCE { |
| bwp-Id | BWP-Id, |

(BWP Identity)

| | |
|---|---|
| locationAndBandwidth | INTEGER (1..65536), |

(BWP location)

| | |
|---|---|
| subcarrierSpacing | ENUMERATED {n0, n1, n2, n3, n4, n5}, |

(Sucarrier spacing)

| | |
|---|---|
| cyclicPrefix | ENUMERATED { extended } |

(Cyclic prefix)

The disclosure is not limited to the above example, and various parameters related to a BWP may be configured for the UE. The BS may transfer the information to the UE through higher layer signaling, such as RRC signaling. At least one BWP among the configured one or a plurality of BWPs may be activated. Whether the configured BWP is active may be transferred from the BS to the UE in a semi-static manner via RRC signaling or may be dynamically transferred via DCI.

The BS may configure an initial BWP for initial access, via an MIB), for the UE before an RRC connection. More particularly, in an initial access stage, the UE may receive configuration information for a search space and a CORESET in which a PDCCH for receiving system information (which may correspond to remaining system information (RMSI) or SIB1) required for initial access may be transmitted via the MIB. Each of the search space and the CORESET configured via the MIB may be identity (ID) 0. The BS may notify the UE of configuration information, such as frequency allocation information, time allocation information, and numerology for CORESET #0, via the MIB. In addition, the BS may notify, via the MIB, the UE of configuration information for a monitoring period and occasion for CORESET #0, that is, configuration information for search space #0. The UE may consider a frequency domain configured to be CORESET #0, which is obtained from the MIB, as an initial BWP for initial access. In this case, an ID of the initial BWP may be 0.

The configuration of a BWP supported by 5G may be used for various purposes.

When a bandwidth supported by the UE is smaller than a system bandwidth, this may be supported via the BWP configuration. For example, the BS may configure, for the UE, a frequency position (configuration information 2) of the BWP, and the UE may thus transmit or receive data at a specific frequency position within the system bandwidth.

For supporting different numerologies, the BS may configure multiple BWPs for the UE. For example, to support both data transmission or reception using a subcarrier spacing of 15 kHz and a subcarrier spacing of 30 kHz for a certain UE, two BWPs may be configured with subcarrier spacings of 15 kHz and 30 kHz, respectively. Different BWPs may be frequency-division-multiplexed (FDMed). When data is to be transmitted or received at a specific subcarrier spacing, a BWP configured with the subcarrier spacing may be activated.

In addition, for reducing power consumption of the UE, the BS may configure, for the UE, BWPs having different bandwidth sizes. For example, when the UE supports a very large bandwidth, for example, 100 MHz, and always transmits or receives data via the corresponding bandwidth, excessive power consumption may occur. In particular, when there is no traffic, it may be very inefficient, in terms of power consumption, to perform monitoring for an unnecessary DL control channel with a large bandwidth of 100 MHz. For reducing the power consumption of the UE, the BS may configure, for the UE, a BWP of a relatively small bandwidth, for example, a BWP of 20 MHz. When there is no traffic, the UE may perform monitoring in the BWP of 20 MHz. When data is generated, the UE may transmit or receive the data by using the BWP of 100 MHz according to an indication of the BS.

In the method for configuring the BWP, UEs before an RRC connection may receive configuration information for an initial BWP via a MIB at initial access stage. In particular, a UE may be configured with a CORESETCORESET for a DL control channel via which DCI for scheduling of a SIB may be transmitted from an MIB of a physical broadcast channel (PBCH). The bandwidth of the CORESET, which is configured via the MIB, may be the initial BWP, and the UE may receive a PDSCH, through which the SIB is transmitted, via the configured initial BWP. In addition to receiving the SIB, the initial BWP may be used for other system information (OSI), paging, and random access.

### BWP Change

In case that one or more BWPs are configured for the UE, the BS may indicate the UE to change (or switch or transit) a BWP, by using a BWP indicator field in DCI. For example, in FIG. 3, in case that a currently active BWP of the UE is BWP #1 301, the BS may indicate BWP #2 302 to the UE by using the BWP indicator in the DCI, and the UE may switch the BWP to BWP #2 302 indicated using the BWP indicator in the received DCI

As described above, the DCI-based switching of the BWP may be indicated by the DCI for scheduling of a PDSCH or PUSCH, and therefore in case that a request for switching a BWP is received, the UE may need to receive or transmit the PDSCH or PUSCH scheduled by the corresponding DCI, with ease in the switched BWP. To this end, requirements for a delay time (T_{BWP}) required when a BWP is switched are regulated in the standards and may be defined as shown in Table 3 below.

TABLE 3

| | |
|---|---|
| NR Slot length | BWP switch delay T_{BWP} (slots) |

| μ | milliseconds (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
^{Note 2}:
If the BWP switch involves changing of SCS, the BWP switch delay is determined by the larger one between the SCS before BWP switch and the SCS after BWP switch.

The requirements for a BWP switch delay time support type 1 or type 2 according to capability of the UE. The UE may report a supportable BWP delay time type to the BS.

According to the above-described requirements for the BWP switch delay time, in case that the UE receives DCI including the BWP switch indicator in slot n, the UE may complete switching to a new BWP indicated by the BWP switch indicator at a time point no later than slot n+T_{BWP}, and may perform transmission or reception for a data channel scheduled by the corresponding DCI in the switched new BWP. In case that the BS is to schedule a data channel with a new BWP, time domain resource allocation for the data channel may be determined by considering the BWP switch delay time (T_{BWP}) of the UE. That is, in a method for determining time domain resource allocation for a data channel when the BS schedules the data channel with a new BWP, the corresponding data channel may be scheduled after a BWP switch delay time. Accordingly, the UE may not expect that DCI indicating BWP switching indicates a slot offset (K0 or K2) value smaller than a value of the BWP switch delay time (T_{BWP}).

If the UE receives DCI (for example, DCI format 1_1 or 0_1) indicating BWP switching, the UE may not perform any transmission or reception during a time interval from a third symbol of a slot in which a PDCCH including the corresponding DCI is received to a start point of a slot indicated by a slot offset (K0 or K2) value indicated using a time domain resource allocation indicator field in the corresponding DCI. For example, when the UE receives the DCI indicating BWP switching in slot n, and a slot offset value indicated by the corresponding DCI is K, the UE may not perform any transmission or reception from a third symbol of slot n to a symbol (i.e., the last symbol in slot n+K−1) before slot n+K.

### Carrier Aggregation (CA)/Dual Connectivity (DC)

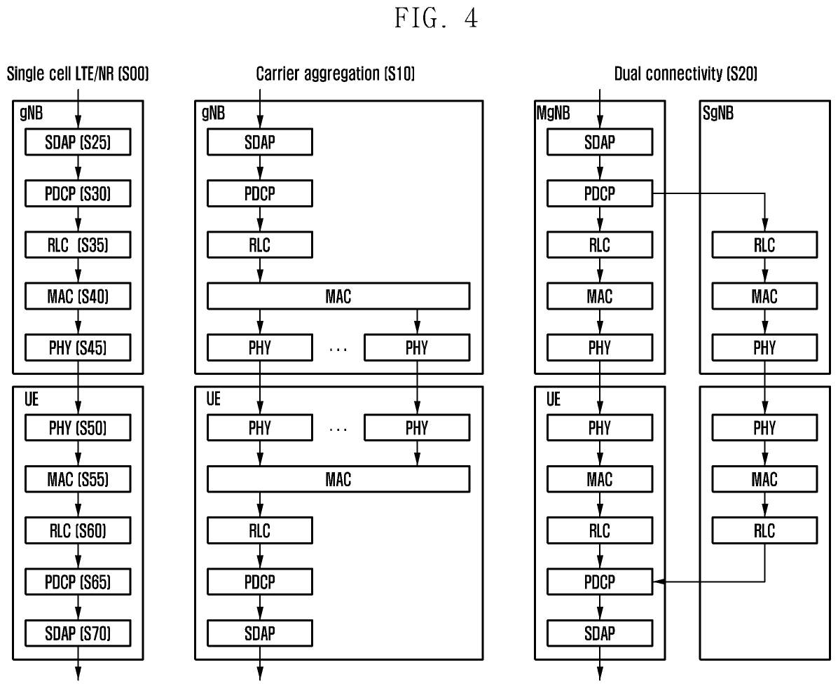

FIG. 4 illustrates a radio protocol structure of a BS and a UE in single cell, CA, and DC situations according to an embodiment.

Referring to FIG. 4, radio protocols of a next-generation mobile communication system is consisted with NR service data adaptation protocols (SDAPs) S25 and S70, NR PDCPs S30 and S65, NR radio link controls (RLCs) S35 and S60, and NR MACs S40 and S55 in a UE and NR BS, respectively.

Main functions of the NR SDAPs S25 and S70 may include at least one of transfer of user plane data, UL DL mapping between a QoS flow and a DRB for both DL and ULUL DL, marking QoS flow ID in both DL and UL packets, and mapping reflective QoS flow to data bearer for UL SDAP PDUs.

With respect to an SDAP layer entity, the UE may be configured, via an RRC message, whether to use a header of the SDAP layer entity or whether to use a function of the SDAP layer entity for each PDCP layer entity, for each bearer, or for each logical channel. When the SDAP header is configured, a non-access stratum (NAS) quality of service (QOS) reflection configuration 1-bit indicator (NAS reflective QoS) and AS QoS reflection configuration 1-bit indicator (AS reflective QoS) in the SDAP header may indicate the UE to update or reconfigure mapping information for data bearers and QoS flows in the UL and DL. The SDAP header may include QoS flow ID information indicating QoS. The QoS information may be used as a data processing priority, scheduling information, etc. to support a smooth service.

Main functions of the NR PDCPs S30 and S65 may include some of the following functions.
Header compression and decompression: robust header compression (ROHC) only
User data transfer
In-sequence delivery of upper layer PDUs
Out-of-sequence delivery of upper layer PDUs
PDCP PDU reordering for reception
Duplicate detection of lower layer SDUs
Retransmission of PDCP SDUs
Encryption and decryption function (Ciphering and deciphering)
Timer-based SDU discard in UL

In the above, the reordering function of the NR PDCP entity refers to a function of reordering PDCP PDUs received from a lower layer in order based on a PDCP sequence number (SN) and may include delivering data to a higher layer according to the reordered sequence. Alternatively, the reordering function of the NR PDCP entity may include direct delivery without considering a sequence, may include reordering the sequence to record lost PDCP PDUs, may include reporting states of the lost PDCP PDUs to a transmission side, and may include requesting retransmission of the lost PDCP PDUs.
Main functions of the NR RLCs S35 and S60 may include some of the following functions.
Data transmission of upper layer PDUs
In-sequence delivery of upper layer PDUs
Out-of-sequence delivery of upper layer PDUs
Error Correction through ARQ
Concatenation, segmentation, and reassembly of RLC SDUs
Re-segmentation of RLC data PDUs
Reordering of RLC data PDUs
Duplicate detection
Protocol error detection
RLC SDU discard
RLC Re-Establishment

In the above, the in-sequence delivery function of the NR RLC entity may refer to a function of sequentially delivering, to a higher layer, RLC SDUs received from a lower layer. The in-sequence delivery function of the NR RLC entity may include, in case that originally one RLC SDU is segmented into multiple RLC SDUs and then received, reassembling and delivering the same, may include reordering the received RLC PDUs based on an RLC SN or a PDCP SN, may include reordering a sequence and recording lost RLC PDUs, may include reporting states of the lost RLC PDUs to a transmission side, and may include requesting retransmission of the lost RLC PDUs. The in-sequence delivery function of the NR RLC entity may include, in case that there is a lost RLC SDU, sequentially delivering only RLC SDUs before the lost RLC SDU to a higher layer, or may include sequentially delivering all the received RLC SDUs to a higher layer before a predetermined timer starts if a predetermined timer expires even if there is a lost RLC SDU. Alternatively, the in-sequence delivery function of the NR RLC entity may include sequentially delivering all the RLC SDUs received up to the current time to a higher layer if the predetermined timer expires even if there is a lost RLC SDU. In addition, the RLC PDUs may be processed in the order of reception thereof (in order of arrival regardless of the order of the SNs or serial numbers) and may be delivered to the PDCP entity regardless of the order (out-of-sequence delivery). In a case of segments, segments stored in a buffer or to be received at a later time may be received, reconfigured into one complete RLC PDU, processed, and then may be delivered to the PDCP entity. The NR RLC layer may not include a concatenation function, and the function may be performed in an NR MAC layer or may be replaced with a multiplexing function of the NR MAC layer.

The out-of-sequence delivery function of the NR RLC entity refers to a function of delivering RLC PDUs received from a lower layer to an immediate higher layer in any order, may include, in case that originally one RLC SDU is divided into multiple RLC SDUs and then received, reassembling the divided RLC SDUs and delivering the same, and may include storing RLC SNS or PDCP SNs of the received RLC PDUs, arranging the order thereof, and recording lost RLC PDUs.

The NR MAC S40 or S55 may be connected to multiple NR RLC layer entities included in one UE, and main functions of the NR MAC may include some of the following functions.
Mapping between logical channels and transport channels
Multiplexing/demultiplexing of MAC SDUs
Scheduling information reporting
Error correction through hybrid automatic repeat request (HARQ)
Priority handling between logical channels of one UE
Priority handling between UEs by means of dynamic scheduling
MBMS service identification
Transport format selection
Padding

The NR PHY layers S45 and S50 may perform channel-coding and modulation of higher layer data, make the channel-coded and modulated higher layer data into OFDM symbols, and transmit the OFDM symbols via a radio channel, or may perform demodulation and channel-decoding of the OFDM symbols received through the radio channel and deliver the same to the higher layer.

The detailed structure of the radio protocol structure may be variously changed according to a carrier (or cell) operating scheme. For example, in case that the BS transmits, based on a single carrier (or cell), data to the UE, the BS and UE use a protocol structure having a single structure for each layer, as in S00. On the other hand, in case that the BS transmits data to the UE, based on carrier aggregation (CA) using multiple carriers in a single TRP, the BS and UE use a protocol structure in which up to the RLC layer has a single structure but the PHY layer is multiplexed via the MAC layer, as in S10. Alternatively, in case that the BS transmits data to the UE, based on dual connectivity (DC) using multiple carriers in multiple TRPs, the BS and UE use a protocol structure in which up to the RLC layer has a single structure but the PHY layer is multiplexed via the MAC layer, as in S20.

### Unified TCI State

In an embodiment, a single TCI state indication and activation method based on a unified TCI scheme is described. The unified TCI scheme may indicate a scheme for unifying and managing the transmission and reception beam management scheme divided into the TCI state scheme used in the DL reception and the spatial relation information scheme used in the UL transmission of the UE in the existing Rel-15 and 16, as the TCI state scheme. Hence, when indicated from the BS based on the unified TCI scheme, the UE may perform beam management using the TCI state even for the UL transmission. If the UE is configured with higher layer signaling TCI-State having higher layer signaling tci-stateId-r17 from the BS, the UE may perform an operation based on the unified TCI scheme using the corresponding TCI-State. TCI-State may include two types of a joint TCI state and a separate TCI state.

The first type is the joint TCI state, and the UE may be indicated from the BS with the TCI state to apply for both the UL transmission and the DL reception through one TCI-State. If the UE is indicated with TCI-State based on the joint TCI state, the UE may be indicated with a parameter to use for DL channel estimation using an RS corresponding to qcl-Type of the corresponding joint TCI state based TCI-State, and a parameter to use as a DL reception beam or a reception filter using an RS corresponding to qcl-Type2. If the UE is indicated with TCI-State based on the joint TCI state, the UE may be indicated with a parameter to use as a UL transmission beam or a transmission filter using the RS corresponding to qcl-Type2 of the corresponding joint DL/UL TCI state based TCI-State. When the UE is indicated with the joint TCI state, the UE may apply the same beam to the UL transmission and the DL reception.

The second type is the separate TCI state, and the UE may be indicated from the BS individually with a UL TCI state to apply for the UL transmission and a DL TCI state to apply for the DL reception. If the UE is indicated with the UL TCI state, the UE may be indicated with a parameter to use as a UL transmission beam or a transmission filter using a reference RS or a source RS configured in the corresponding UL TCI state. If the UE is indicated with the DL TCI state, the UE may be indicated with a parameter to use for DL channel estimation using the RS corresponding to qcl-Type 1 configured in the corresponding DL TCI state, and a parameter to use as a DL reception beam or a reception filter using the RS corresponding to qcl-Type2.

If the UE is indicated with the DL TCI state and the UL TCI state together, the UE may be indicated with the parameter to use as the UL transmission beam or the transmission filter using the reference RS or the source RS configured in the corresponding UL TCI state. The UE may be indicated with the parameter to use for the DL channel estimation using the RS corresponding to qcl-Type1 configured in the corresponding DL TCI state, and the parameter to use as the DL reception beam or the reception filter using the RS corresponding to qcl-Type2. In this case, when the reference RSs or the source RSs configured in the DL TCI state and the UL TCI state indicated to the UE are different, the UE may individually apply the beam to the UL transmission and the DL reception based on the indicated UL TCI state and DL TCI state

The UE may be configured from the BS with up to 128 joint TCI states for each specific BWP in a specific cell through higher layer signaling. Up to 64 or 128 DL TCI states of the separate TCI state may be configured for each specific BWP in a specific cell through higher layer signaling based on a UE capability report. The DL TCI state of the separate TCI state and the joint TCI state may use the same higher layer signaling structure. For example, if 128 joint TCI states are configured and 64 DL TCI states are configured in the separate TCI state, 64 DL TCI states may be included in 128 joint TCI states.

Up to 32 or 64 UL TCI states of the separate TCI state may be configured for each specific BWP in a specific cell through higher layer signaling based on a UE capability report, the UL TCI state of the separate TCI state and the joint TCI state may use the same higher layer signaling structure, similar to the relationship of the DL TCI state of the separate TCI state and the joint TCI state, and the UL TCI state of the separate TCI state may use a different higher layer signaling structure from the joint TCI state and the DL TCI state of the separate TCI state.

As such, using the different or the same higher layer signaling structure may be defined in the standard, and may be distinguished through yet another higher layer signaling configured by the BS, based on a UE capability report containing information of whether to use one of the two types supported by the UE.

The UE may receive transmission and reception beam related indication in the unified TCI scheme using one of the joint TCI state and the separate TCI state configured from the BS. The UE may be configured from the BS whether to use one of the joint TCI state and the separate TCI state through higher layer signaling.

The UE may receive the transmission and reception beam related indication using one scheme selected from the joint TCI state and the separate TCI state through higher layer signaling. In this case, the transmission and reception beam indication method from the BS may include two methods of a MAC-CE based indication method and a MAC-CE based activation and DCI based indication method.

In case that the UE receives the transmission and reception beam related indication using the joint TCI state through the higher layer signaling, the UE may perform a transmission and reception beam application operation by receiving a MAC-CE indicating the joint TCI state from the BS, and the BS may schedule to the UE PDSCH reception including the corresponding MAC-CE through the PDCCH. If the MAC-CE includes one joint TCI state, the UE may determine a UL transmission beam, a transmission filter and a DL reception beam, or a reception filter using the joint TCI state indicated from 3 ms after PUCCH transmission including HARQ-ACK information indicating whether the PDSCH including the corresponding MAC-CE is successfully received or not. If the MAC-CE includes two or more joint TCI states, the UE may identify that the plurality of the joint TCI states indicated by the MAC-CE correspond to respective codepoints of the TCI state field of DCI format 1_1 or 1_2 and activate the indicated joint TCI state, from 3 ms after PUCCH transmission including HARQ-ACK information indicating whether the PDSCH including the corresponding MAC-CE is successfully received or not. Thereafter, the UE may receive DCI format 1_1 or 1_2 and apply one joint TCI state indicated by the TCI state field of the corresponding DCI to the UL transmission and DL reception beams. In this case, DCI format 1_1 or 1_2 may include DL data channel scheduling information (with DL assignment), or may not include the same (without DL assignment).

In case that the UE receives the transmission and reception beam related indication using the separate TCI state through higher layer signaling, the UE may perform the transmission and reception beam application operations by receiving the MAC-CE indicating the separate TCI state from the BS, and the BS may schedule to the UE PDSCH reception including the corresponding MAC-CE through the PDCCH. If the MAC-CE includes one separate TCI state set, the UE may determine a UL transmission beam, a transmission filter and a DL reception beam, or a reception filter using the separate TCI states included in the separate TCI state set indicated from 3 ms after PUCCH transmission including HARQ-ACK information indicating whether the corresponding PDSCH is successfully received or not. In this case, the separate TCI state set may indicate a single or plurality of separate TCI states that one codepoint in the TCI state field in DCI format 1_1 or 1_2 may have, and one separate TCI state set may include one DL TCI state, one UL TCI state, or one DL TCI state and one UL TCI state. If the MAC-CE includes two or more separate TCI state sets, the UE may identify that the plurality of the separate TCI state sets indicated by the MAC-CE correspond to respective codepoints of the TCI state field of DCI format 1_1 or 1_2 and activate the indicated separate TCI state set, from 3 ms after PUCCH transmission including HARQ-ACK information indicating whether the corresponding PDSCH is successfully received or not. In this case, each codepoint of the TCI state field of DCI format 1_1 or 1_2 may indicate one DL TCI state, one UL TCI state, or one DL TCI state and one UL TCI state, respectively. The UE may receive DCI format 1_1 or 1_2 and apply the separate TCI state set indicated by the TCI state field of the corresponding DCI to the UL transmission and DL reception beams. In this case, DCI format 1_1 or 1_2 may include DL data channel scheduling information (with DL assignment), or may not include the same (without DL assignment).

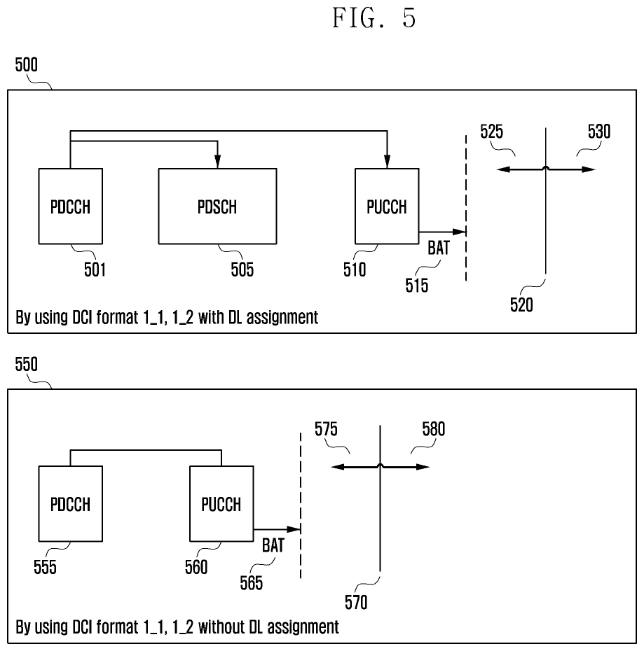

FIG. 5 illustrates a beam application time to consider in using a unified TCI scheme in a wireless communication system according to an embodiment. As mentioned above, with or without DL assignment of the DL data channel scheduling information from the BS, the UE may receive DCI format 1_1 or 1_2 and apply one joint TCI state or separate TCI state set indicated by the TCI state field of the corresponding DCI to the UL transmission and DL reception beams DCI format 1_1 or 1_2 with DL assignment (500):

In case that the UE receives from the BS DCI format 1_1 or 1_2 including the DL data channel scheduling information (501) to indicate one joint TCI state or separate TCI state set based on the unified TCI scheme, the UE may receive a PDSCH scheduled based on the received DCI (505), and transmit a PUCCH including HARQ-ACK referring to reception success or failure of the DCI and the PDSCH (510). In this case, the HARQ-ACK may include success or failure of the DCI and the PDSCH both, the UE may transmit NACK when not receiving at least one of the DCI and the PDSCH, and the UE may transmit ACK in case of successfully receiving both the DCI and the PDSCH.

DCI format 1_1 or 1_2 without the DL assignment (550): In case that the UE receives (555) from the BS DCI format 1_1 or 1_2 not including the DL data channel scheduling information to indicate one joint TCI state or separate TCI state set based on the unified TCI scheme, the UE may assume at least one of the following combinations for the corresponding DCI:
including CRC scrambled with CS-RNTI every bit value allocated to all fields used as redundancy version (RV) fields is 1.
every bit value allocated to all fields used as modulation and coding scheme (MCS) fields is 1,
every bit value allocated to all fields used as new data indication (NDI) fields is 0. every bit value allocated to an FDRA field is 0 for frequency domain resource allocation (FDRA) type 0,
every bit value allocated to the FDRA field is 1 for FDRA type 1, and
every bit value allocated to the FDRA field is 0 for FDRA scheme dynamicSwitch.

The UE may transmit a PUCCH including the HARQ-ACK indicating reception success or failure of DCI format 1_1 or 1_2 for which the above details are assumed (560).

With respect to DCI format 1_1 or 1_2 with the DL assignment (500) and without the DL assignment (550), if a new TCI state indicated by the DCI 501 and 555 is already indicated and identical to the TCI state applied to the UL transmission and DL reception beams, the UE may maintain the TCI state that has been previously applied. If the new TCI state is different from the previously indicated TCI state, the UE may determine an application time of the joint TCI state or separate TCI state set indicated from the TCI state field included in the DCI after an initial slot 520 and 570 after a time corresponding to a beam application time (BAT) 515 and 565 after the PUCCH transmission (530 and 580), and may use the previously indicated TCI state until the corresponding slot 520 and 570 (525, 575).

With respect to both DCI format 1_1 or 1_2 with the DL assignment (500) and without the DL assignment (550), the BAT may be configured with higher layer signaling based on UE capability report information using a specific number of OFDM symbols. Numerology of the BAT and the first slot after the BAT may be determined based on the smallest numerology among all the cells applying the joint TCI state or separate TCI state set indicated by the DCI

The UE may apply one joint TCI state indicated by the MAC-CE or the DCI in receiving CORESETs connected to every UE-specific search space, receiving the PDSCH scheduled with the PDSCCH transmitted from the corresponding CORESET and transmitting the PUSCH, and transmitting every PUCCH resource.

In case that one separate TCI state set indicated by the MAC-CE or the DCI includes one DL TCI state, the UE may apply the one separate TCI state set in receiving CORESETs connected to every UE-specific search space, and receiving the PDSCH scheduled with the PDCCH transmitted from the corresponding CORESET, and apply to every PUSCH and PUCCH resource based on the previously indicated UL TCI state.

In case that one separate TCI state set indicated by the MAC-CE or the DCI includes one UL TCI state, the UE may apply it to every PUSCH and PUCCH resource and apply based on the previously indicated DL TCI state in receiving CORESETs connected to every UE-specific search space, and receiving the PDSCH scheduled with the PDCCH transmitted from the corresponding CORESET.

In case that one separate TCI state set indicated by the MAC-CE or the DCI includes one DL TCI state and one UL TCI state, the UE may apply the DL TCI state to receiving CORESETs connected to every UE-specific search space, and receiving the PDSCH scheduled with the PDCCH transmitted from the corresponding CORESET, and apply the UL TCI state to every PUSCH and PUCCH resource.

### Unified TCI State MAC-CE

A UE may receive scheduling of a PDSCH including the following MAC-CE from a BS, and from 3 slots after transmission of HARQ-ACK for the corresponding PDSCH to the BS, may interpret each codepoint of a TCI state field in DCI format 1_1 or 1_2, based on information in the MAC-CE received from the BS. In other words, the UE may activate each entry of the MAC-CE received from the BS at each codepoint in the TCI state field in DCI format 1_1 or 1_2.

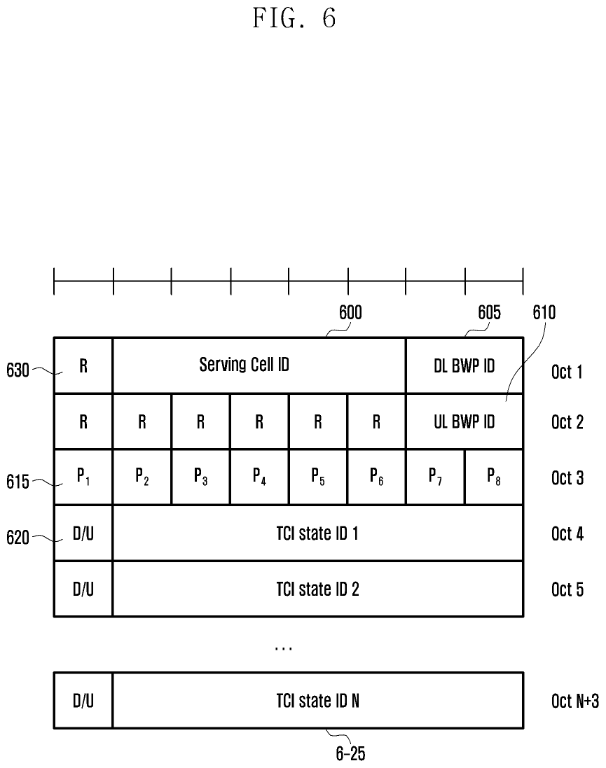

FIG. 6 illustrates another MAC-CE structure for activating and indicating a joint TCI state or a separate DL or UL TCI state in a wireless communication system according to an embodiment. The meaning of each field in the corresponding MAC-CE structure may be as follows. Serving Cell ID (600) indicates a serving cell to which the corresponding MAC-CE is to be applied and may be 5 bits in length. If a serving cell indicated by this field is included in one or more of simultaneousU-TCI-UpdateList1, simultaneousU-TCI-UpdateList2, simultaneousU-TCI-UpdateList3, or simultaneousU-TCI-UpdateList4, which are higher layer signaling, the corresponding MAC-CE may be applied to all of serving cell included in one or more of the following lists of simultaneousU-TCI-UpdateList1, simultaneousU-TCI-UpdateList2, simultaneousU-TCI-UpdateList3, simultaneousU-TCI-UpdateList4 that includes the serving cell indicated by this field.

DL BWP ID (605) indicates a DL BWP to which the corresponding MAC-CE is to be applied, and the meaning of each codepoint in this field may correspond to each codepoint of a BWP indicator in DCI. This field may be 2 bits in length

UL BWP ID (610) indicates to which UL BWP the corresponding MAC-CE applies, and the meaning of each codepoint in this field may correspond to each codepoint of the BWP indicator in the DCI. This field may be 2 bits in length.

Pᵢ (615) indicates whether each codepoint of the TCI state field in DCI format 1_1 or 1_2 has a plurality of TCI states or one TCI state. If Pi has a value of 1, this may indicate that the corresponding i-th codepoint has a plurality of TCI states, and this may indicate that the corresponding codepoint may include a separate DL TCI state and a separate UL TCI state. If Pi has a value of 0, this may indicate that the corresponding i-th codepoint has a single TCI state, and this may indicate that the corresponding codepoint may include either a joint TCI state, a separate DCI TCI state, or a separate UL TCI state.

D/U (620) indicates whether the TCI state ID field within the same octet is a joint TCI state, a separate DL TCI state, or a separate UL TCI state. If this field is 1, the TCI state ID field within the same octet may be a joint TCI state or a separate DL TCI state. If this field is 0, the TCI state ID field within the same octet may be a separate UL TCI state.

TCI state ID (625) indicates the TCI state that may be identified by TCI-StateId which is higher layer signaling. In case that the D/U field is configured to be 1, this field may be used to represent the TCI-StateId, which can be represented by 7 bits. In case that the D/U field is configured as 0, the most significant bit (MSB) of this field may be considered as a reserved bit, and the remaining 6 bits may be used to represent UL-TCIState-Id which is higher layer signaling. The maximum number of TCI states that can be activated is 8 for joint TCI states and 16 for separate DL or UL TCI states.

R indicates a reserved bit, which may be configured as 0.

For the MAC-CE structure in FIG. 6 described above, the UE may include a third octet including the fields P₁, P₂, . . . , P₈ in FIG. 6 in the corresponding MAC-CE structure, regardless of whether the unifiedTCI-StateType-r17 in MIMOparam-r17 in ServingCellConfig, which is higher layer signaling, is configured as joint or separate. In this case, the UE may perform TCI state activation using a fixed MAC-CE structure independent of the higher layer signaling configured from the BS. In another example, for the MAC-CE structure in FIG. 6 described above, the UE may omit the third octet including the fields P₁, P₂, . . . , P₈ in FIG. 6 in case that the unifiedTCI-StateType-r17 in MIMOparam-r17 in ServingCellConfig, which is higher layer signaling, is configured as joint. In this case, the UE may save up to 8 bits of the payload of the corresponding MAC-CE depending on the higher layer signaling configured from the BS. Furthermore, all of the D/U fields located in the first bit of the fourth octet in FIG. 6 may be considered R fields, and all of the corresponding R fields may be configured to be 0 bits.

### PDCCH: DCI

In the 5G system, scheduling information on UL a PUSCH or a PDSCH is transferred from the BS to the UE via DCI. The UE may monitor a DCI format for fallback and a DCI format for non-fallback with respect to a PUSCH or a PDSCH. The fallback DCI format may be configured with a fixed field predefined between the BS and the UE, and the non-fallback DCI format may include a configurable field.

DCI may be transmitted through a PDCCH via channel coding and modulation. A cyclic redundancy check (CRC) is attached to a DCI message payload, and may be scrambled with a radio network temporary identifier (RNTI) corresponding to an identity of the UE. Different RNTIs may be used according to a purpose of the DCI message, for example, UE-specific data transmission, a power control command, a random access response, etc. That is, the RNTI is not explicitly transmitted, but is included in CRC calculation so as to be transmitted. When the DCI message transmitted on a PDCCH is received, the UE identifies a CRC by using an assigned RNTI and determines, if the CRC identification result is correct, that the corresponding message has been transmitted to the UE.

For example, DCI for scheduling of a PDSCH for system information (SI) may be scrambled with an SI-RNTI. DCI for scheduling of a PDSCH for a random access response (RAR) message may be scrambled with an RA-RNTI. DCI for scheduling of a PDSCH for a paging message may be scrambled with a P-RNTI. DCI for notification of a slot format indicator (SFI) may be scrambled with an SFI-RNTI. DCI for notification of a transmit power control (TPC) may be scrambled with a TPC-RNTI. DCI for scheduling of a UE-specific PDSCH or PUSCH may be scrambled with a cell RNTI (C-RNTI).

DCI format 0_0 may be used for fallback DCI for scheduling of a PUSCH, in which a CRC may be scrambled with a C-RNTI. DCI format 0_0 in which a CRC is scrambled with a C-RNTI may include the information in Table 4 below.

TABLE 4
- Identifier for DCI formats - [1] bit
- Frequency domain resource assignment-[┌log₂( N_{RB}^{UL,BWP}(N_{RB}^{UL,BWP} + 1)/2)┐] bits
- Time domain resource assignment - X bits
- Frequency hopping flag- 1 bit.
- Modulation and coding scheme - 5 bits
- New data indicator- 1 bit
- Redundancy version- 2 bits
- HARQ process number - 4 bits
- TPC command for scheduled PUSCH- [2] bits
- UL/SUL indicator - 0 or 1 bit

DCI format 0_1 may be used for non-fallback DCI for scheduling of a PUSCH, in which a CRC may be scrambled with a C-RNTI. DCI format 0_1 in which a CRC is scrambled with a C-RNTI may include the information in Table 5 below.

```
TABLE 1
  - Carrier indicator - 0 or 3 bits
  - UL/SUL indicator - 0 or 1 bit
  - Identifier for DCI formats - [1] bits
  - BWP indicator - 0, 1 or 2 bits
  - Frequency domain resource assignment
For resource allocation type 0, ┌N_{RB}^{UL,BWP}/P┐ bits
For resource allocation type 1, ┌log₂ (N_{RB}^{UL,BWP}(N_{RB}^{UL,BWP} + 1)/2)┐ bits
  - Time domain resource assignment - 1, 2, 3, or 4 bits
  - virtual resource block (VRB)-to-physical resource block (PRB) mapping - 0 or 1 bit,
only for resource allocation type 1.
0 bit if only resource allocation type 0 is configured;
1 bit otherwise.
  - Frequency hopping flag - 0 or 1 bit, only for resource allocation type 1.
0 bit if only resource allocation type 0 is configured;
1 bit otherwise.
  - Modulation and coding scheme - 5 bits
  - New data indicator - 1 bit
  - Redundancy version - 2 bits
  - HARQ process number - 4 bits
  - 1st DL assignment index- 1 or 2 bits
1 bit for semi-static HARQ-ACK codebook;
2 bits for dynamic HARQ-ACK codebook with single HARQ-ACK codebook.
  - 2nd DL assignment index) - 0 or 2 bits
2 bits for dynamic HARQ-ACK codebook with two HARQ-ACK sub-codebooks;
0 bit otherwise.
  - TPC command for scheduled PUSCH - 2 bits
  -  $SRS resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{SRS} ) ⌉ bits$
$⌈ {log}_{2} ( {\sum }_{k = 1}^{{L}_{max} \sum } ( \begin{matrix}{N}_{SRS} \\ k\end{matrix} ) ) ⌉ bits for non \text{-codebook based} PUSCH transmission ;$
┌log₂(NSRS)┐ bits for codebook based PUSCH transmission.
  - Precoding information and number of layers - up to 6 bits
  - Antenna ports - up to 5 bits
  - SRS request - 2 bits
  - CSI request - 0, 1, 2, 3, 4, 5, or 6 bits
  - Code block group (CBG)transmission information - 0, 2, 4, 6, or 8 bits
  - phase tracking reference signal (PTRS)-demodulation reference signal (DMRS)
association - 0 or 2 bits.
  - beta_offset indicator - 0 or 2 bits
  - DMRS sequence initialization - 0 or 1 bit
```

DCI format 1_0 may be used for fallback DCI for scheduling of a PDSCH, in which a CRC may be scrambled with a C-RNTI. DCI format 1_0 in which a CRC is scrambled with a C-RNTI may include the information in Table 6 below.

TABLE 2
- Identifier for DCI formats - [1] bit
- Frequency domain resource assignment - [┌log₂(N_{RB}^{DL,BWP}(N_{RB}^{DL,BWP} + 1)/2)┐] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- PUCCH resource indicator - 3 bits
- PDSCH-to-HARQ feedback timing indicator- [3] bits

DCI format 1_1 may be used for non-fallback DCI for scheduling of a PDSCH, in which a CRC may be scrambled with a C-RNTI. DCI format 1_1 in which a CRC is scrambled with a C-RNTI may include the information in Table 7 below.

TABLE 3

| | |
|---|---|
| - | Carrier indicator - 0 or 3 bits |
| - | Identifier for DCI formats - [1] bits |
| - | BWP indicator - 0, 1 or 2 bits |
| - | Frequency domain resource assignment |

For resource allocation type 0, ┌N_{RB}^{DL,BWP}/P┐ bits
For resource allocation type 1, ┌log₂(N_{RB}^{DL,BWP}(N_{RB}^{DL,BWP} + 1)/2)┐ bits

| | |
|---|---|
| - | Time domain resource assignment -1, 2, 3, or 4 bits |
| - | VRB-to-PRB mapping - 0 or 1 bit, only for resource allocation type 1. |

0 bit if only resource allocation type 0 is configured;
1 bit otherwise.

| | |
|---|---|
| - | PRB bundling size indicator - 0 or 1 bit |
| - | Rate matching indicator- 0, 1, or 2 bits |
| - | zero power (ZP) channel state information reference signal (CSI-RS) trigger - 0, 1, or 2 |

bits

| For transport block 1: | |
|---|---|
| - | Modulation and coding scheme - 5 bits |
| - | New data indicator - 1 bit |
| - | Redundancy version - 2 bits |
| For transport block 2: | |
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication- 0 or 3 bits |
| - | SRS request - 2 bits |
| - | CBG transmission information - 0, 2, 4, 6, or 8 bits |
| - | CBG flushing out information- 0 or 1 bit |
| - | DMRS sequence initialization - 1 bit |

### PDCCH: CORESET, REG, CCE, Search Space

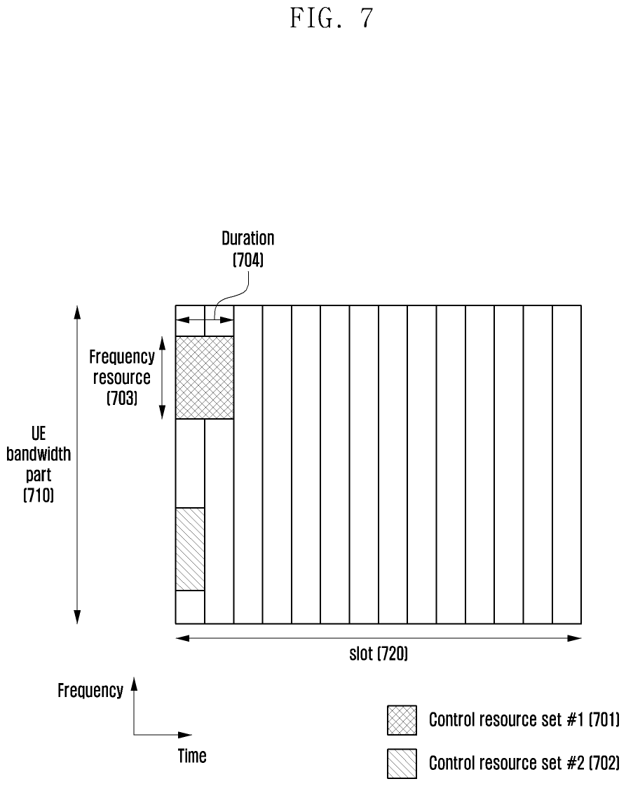

FIG. 7 illustrates a CORESETCORESET in which a DL control channel is transmitted in the 5G wireless communication system according to an embodiment. Referring to FIG. 7, an example is shown in which a UE BWP 710 is configured on the frequency axis, and two CORESETs (CORESET #1 701 and CORESET #2 702) are configured within one slot 720 on the time axis. The CORESETs 701 and 702 may be configured in a specific frequency resource 703 within the entire terminal BWP 710 on the frequency axis. One or a plurality of OFDM symbols may be configured on the time axis and may be defined as a CORESET duration 704. With reference to the example illustrated in FIG. 7, CORESET #1 701 is configured to have a CORESET duration of 2 symbols, and CORESET #2 702 is configured to have a CORESET duration of 1 symbol.

The above-described CORESET in 5G may be configured for the UE by the BS through higher layer signaling (e.g., system information, an MIB, and RRC signaling). Configuring the CORESET for the UE may refer to providing information, such as an identity of the CORESET, a frequency position of the CORESET, and a symbol length of the CORESET. For example, information in Table 8 below may be included.

TABLE 4

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE (45)), |

(frequency domain resource allocation information)

| | |
|---|---|
| duration | INTEGER |

(1..maxCoReSetDuration),
(time domain resource allocation information)

| | |
|---|---|
| cce-REG-MappingType | CHOICE { |

```
  (CCE-to-REG mapping scheme)
      interleaved
    SEQUENCE {
          reg-BundleSize
    ENUMERATED {n2, n3, n6},
      (REG bundle size)
          precoderGranularity
    ENUMERATED {sameAsREG-bundle, allContiguousRBs},
          interleaverSize
    ENUMERATED {n2, n3, n6}
          (interleaver size)
          shiftIndex
    INTEGER(0..maxNrofPhysicalResourceBlocks-1)
            OPTIONAL
        (interleaver shift)
    },
```

| | |
|---|---|
| nonInterleaved | NULL |

},

| | |
|---|---|
| tci-StatesPDCCH | SEQUENCE(SIZE |

```
(1..maxNrofTCI-StatesPDCCH)) OF TCI-StateId
    OPTIONAL,
  (QCL configuration information)
```

| | |
|---|---|
| tci-PresentInDCI | ENUMERATED {enabled} |

OPTIONAL, -- Need S
}

In Table 8, tci-StatesPDCCH (simply, referred to as a transmission configuration indication (TCI) state) configuration information may include information about one or a plurality of synchronization signal (SS)/PBCH block indices or CSI-RS indices having the quasi co-location (QCL) relationship with a DMRS transmitted in the corresponding CORESET.

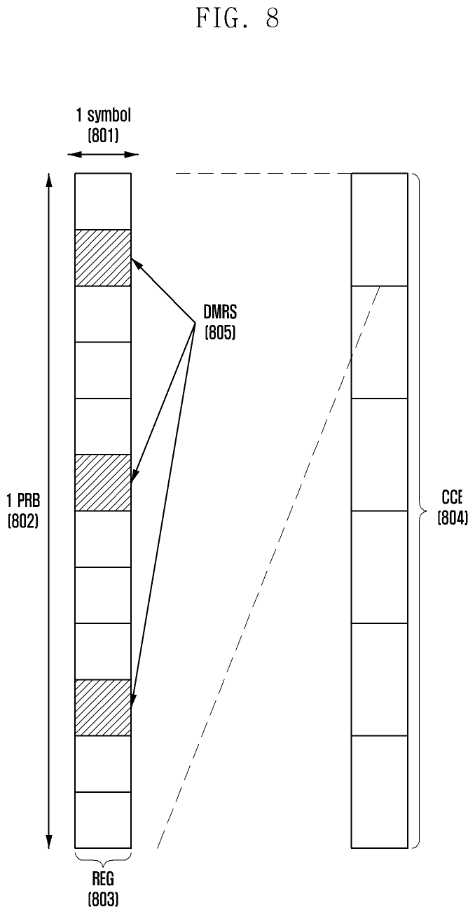

FIG. 8 illustrates a basic unit of time and frequency resources configuring a DL control channel which may be used in 5G. Referring to FIG. 8, a basic unit of time and frequency resources configuring a control channel is referred to as a resource element group (REG) 803, and an REG 803 may be defined to have 1 OFDM symbol 801 on the time axis and 1 physical resource block (PRB) 802, that is, 12 subcarriers, on the frequency axis. A BS may configure a DL control channel allocation unit by concatenation with the REG 803.

As illustrated in FIG. 8, in case that a basic unit for allocation of a DL control channel in 5G is a control channel element (CCE) 804, 1 CCE 804 may include a plurality of REGs 803. When the REG 803 illustrated in FIG. 8 is described as an example, the REG 803 may include 12 REs, and if 1 CCE 804 is constituted with 6 REGs 803, 1 CCE 804 may be constituted with 72 REs. When a DL CORESET is configured, the corresponding area may be constituted with a plurality of CCEs 804, and a specific DL control channel may be mapped to one or a plurality of CCEs 804 so as to be transmitted according to an aggregation level (AL) within the CORESET. The CCEs 804 within the CORESET are divided by numbers, and in this case, the numbers of the CCEs 804 may be assigned according to a logical mapping scheme.

The basic unit of the DL control channel illustrated in FIG. 8, that is, the REG 803, may include both REs, to which DCI is mapped, and an area, to which a DMRS 805 that is a reference signal for decoding the REs, is mapped. As shown in FIG. 8, 3 DMRSs 805 may be transmitted in 1 REG 803. The number of CCEs required to transmit a PDCCH may be 1, 2, 4, 8, or 16 depending on the aggregation level (AL), and different numbers of CCEs may be used to implement link adaptation of the DL control channel. For example, when AL=L, one DL control channel may be transmitted via the L number of CCEs. A UE needs to detect a signal without knowing information about the DL control channel, wherein a search space representing a set of CCEs is defined for blind decoding. The search space is a set of DL control channel candidates include CCEs, for which the UE needs to attempt to decode on a given aggregation level. Since there are various aggregation levels that make one bundle with 1, 2, 4, 8, or 16 CCEs, the UE may have a plurality of search spaces. A search space set may be defined as a set of search spaces at all configured aggregation levels.

The search space may be divided into a common search space and a UE-specific search space. A certain group of UEs or all UEs may monitor a common search space of a PDCCH to receive cell-common control information, such as a dynamic scheduling or paging message for system information. For example, PDSCH scheduling assignment information for transmission of an SIB including cell operator information, etc. may be received by monitoring the common search space of a PDCCH. When the common search space, the certain group of UEs or all UEs need to receive a PDCCH, and may thus be defined as a set of previously agreed CCEs. Scheduling assignment information for a UE-specific PDSCH or PUSCH may be received by monitoring a UE-specific search space of a PDCCH. The UE-specific search space may be defined UE-specifically, based on an identity of the UE and functions of various system parameters.

In 5G, a parameter for the search space of the PDCCH may be configured from the BS to the UE through higher layer signaling (e.g., SIB, MIB, and RRC signaling). For example, the BS may configure, to the UE, the number of PDCCH candidates at each aggregation level L, a monitoring period for a search space, a monitoring occasion in units of symbols in the slot for the search space, a search space type (common search space or UE-specific search space), a combination of an RNTI and a DCI format which is to be monitored in the corresponding search space, a CORESET index for monitoring of the search space, etc. For example, information in Table 9 below may be included.

TABLE 5

| | |
|---|---|
| SearchSpace ::= | SEQUENCE { |

-- Identity of the search space. SearchSpaceId = 0 identifies the SearchSpace configured
via PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(CORESET identity)

| | |
|---|---|
| monitoringSlotPeriodicityAndOffset | CHOICE { |

```
  (monitoring slot level period)
      sl1
    NULL,
      sl2
    INTEGER (0..1),
      sl4
    INTEGER (0..3),
```

| | |
|---|---|
| sl5 | INTEGER |

```
(0..4),
      sl8
    INTEGER (0..7),
```

| | |
|---|---|
| sl10 | INTEGER |
| (0..9), | |
| sl16 | INTEGER |
| (0..15), | |
| sl20 | INTEGER |

(0..19)
}

| | |
|---|---|
| | OPTIONAL, |
| duration(monitoring duration) | INTEGER (2..2559) |
| monitoringSymbolsWithinSlot | BIT STRING (SIZE |

```
(14))
    OPTIONAL,
  (monitoring symbol in slot)
```

| | |
|---|---|
| nrofCandidates | SEQUENCE { |

(The number of PDCCH candidates for each aggregation level)

| | |
|---|---|
| aggregationLevel1 | ENUMERATED |

{n0, n1, n2, n3, n4, n5, n6, n8},

| | |
|---|---|
| aggregationLevel2 | ENUMERATED |

{n0, n1, n2, n3, n4, n5, n6, n8},

| | |
|---|---|
| aggregationLevel4 | ENUMERATED |

{n0, n1, n2, n3, n4, n5, n6, n8},

| | |
|---|---|
| aggregationLevel8 | ENUMERATED |

{n0, n1, n2, n3, n4, n5, n6, n8},

| | |
|---|---|
| aggregationLevel16 | ENUMERATED |

{n0, n1, n2, n3, n4, n5, n6, n8}
},

| | |
|---|---|
| searchSpaceType | CHOICE { |

```
    (search space type)
      -- Configures this search space as common search space (CSS) and DCI formats
to monitor.
      common
    SEQUENCE {
    (common search space)
    }
      ue-Specific
    SEQUENCE {
    (UE-specific search space)
        -- Indicates whether the UE monitors in this USS for DCI formats 0-0 and
1-0 or for formats 0-1 and 1-1.
        formats
    ENUMERATED {formats0-0-And-1-0, formats0-1-And-1-1},
        ...
      }
```

According to configuration information, the BS may configure one or a plurality of search space sets for the UE. The BS may configure search space set 1 and search space set 2 to the UE, may configure DCI format A, which is scrambled with X-RNTI in search space set 1, to be monitored in the common search space, and may configure DCI format B, which is scrambled with Y-RNTI in search space set 2, to be monitored in the UE-specific search space.

According to the configuration information, one or a plurality of search space sets may exist in the common search space or the UE-specific search space. For example, search space set #1 and search space set #2 may be configured to be a common search space, and search space set #3 and search space set #4 may be configured to be a UE-specific search space. In the common search space, the following combinations of DCI formats and RNTIs may be monitored. Apparently, the disclosure is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of DCI formats and RNTIs may be monitored. Apparently, the disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs specified above may comply with the following definition and purpose.
C-RNTI (Cell RNTI): Purpose for UE-specific PDSCH scheduling
TC-RNTI (Temporary Cell RNTI): Purpose for UE-specific PDSCH scheduling
CS-RNTI (Configured Scheduling RNTI): Purpose for semi-statically configured UE-specific PDSCH scheduling
RA-RNTI (Random Access RNTI): Purpose for PDSCH scheduling in random-access stage
P-RNTI (Paging RNTI): Purpose for scheduling PDSCH on which paging is transmitted
SI-RNTI (System Information RNTI): Purpose for scheduling PDSCH on which system information is transmitted
INT-RNTI (Interruption RNTI): Purpose for indicating whether to puncture PDSCH
TPC-PUSCH-RNTI (Transmit Power Control for PUSCH RNTI): Purpose for indicating power control command for PUSCH
TPC-PUCCH-RNTI (Transmit Power Control for PUCCH RNTI): Purpose for indicating power control command for PUCCH
TPC-SRS-RNTI (Transmit Power Control for SRS RNTI): Purpose for indicating power control command for SRS

The above-mentioned DCI formats may conform to the following definition in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In 5G, a search space of aggregation level L in search space set s, and CORESET p may be expressed as in Equation (1) below.

$$L \cdot \{ ( {Y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{C C E , p}}{L} ⌋ \} + i \qquad ( 1 )$$

In Equation (1),
L: aggregation level
n_{CI}: carrier index
N_{CCE,p}: the total number of CCEs existing in CORESET p
n_{s,f}^{μ}: slot index
M_{s,max}^{(L)}: the number of PDCCH candidates for aggregation level L
m_{s,n}_{_{CI}}=0, . . . , M_{s,max}^{(L)}−1: PDCCH candidate index of aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

A value of

$${Y}_{p , {n}_{s , f}^{μ}}$$

may correspond to 0 in the common search space.

In the UE-specific search space, a value of

$${Y}_{p , {n}_{s , f}^{μ}}$$

may correspond to a value that varies depending on a time index and the identity (ID configured for the UE by the BS or C-RNTI) of the UE.

In 5G, a plurality of search space sets may be configured by different parameters as shown in Table 9, and therefore a set of search spaces monitored by the UE at each time point may vary. For example, in case that search space set #1 is configured with an X-slot period, search space set #2 is configured with a Y-slot period, and X and Y are thus different from each other, the UE may monitor both search space set #1 and search space set #2 in a specific slot, and may monitor one of search space set #1 and search space set #2 in the specific slot.

### PUCCH Transmission

In the NR system, the UE may transmit control information (UCI) to the BS via a PUCCH. The control information may include at least one of HARQ-ACK) indicating a success or a failure of demodulation/decoding for a transport block (TB) received by the UE via a PDSCH, a scheduling request (SR) for requesting resource allocation from the PUSCH BS by the UE for UL data transmission, and channel state information (CSI) that is information for channel state reporting of the UE.

PUCCH resources may be mainly classified into a long PUCCH and a short PUCCH according to a length of an assigned symbol. In the NR system, a long PUCCH has a length of 4 symbols or more in a slot, and a short PUCCH has a length of 2 symbols or fewer in a slot.

The long PUCCH may be used to improve UL cell coverage, and thus may be transmitted in a DFT-S-OFDM scheme, which is a single carrier transmission, rather than OFDM transmission. The long PUCCH supports transmission formats, such as PUCCH format 1, PUCCH format 3, and PUCCH format 4, depending on the number of supportable control information bits and whether UE multiplexing via Pre-DFT OCC support at a previous stage of IFFT is supported.

PUCCH format 1 is a DFT-S-OFDM-based long PUCCH format capable of supporting control information of up to 2 bits, and uses a frequency resource equivalent to 1 RB. The control information may be configured with a combination of HARQ-ACK and SR or each of them. PUCCH format 1 is configured with an OFDM symbol that includes DMRS and an OFDM symbol that includes UCI repeatedly.

For example, in case that the number of transmission symbols of PUCCH format 1 is 8 symbols, starting from a first start symbol of the 8 symbols, a DMRS symbol, a UCI symbol, a DMRS symbol, a UCI symbol, a DMRS symbol, a UCI symbol, a DMRS symbol, and a UCI symbol may be included in sequence. A DMRS symbol may be spread using an orthogonal code (or orthogonal sequence or spreading code, wᵢ(m)) on the time axis to a sequence corresponding to a length of 1 RB on the frequency axis within one OFDM symbol, and may be transmitted after IFFT is performed.

For a UCI symbol, the UE may generate d(0) by BPSK-modulating 1-bit control information and QPSK-modulating 2-bit control information, multiply generated d(0) by a sequence corresponding to the length of 1 RB on the frequency axis so as to perform scrambling, perform spreading using the orthogonal code (or orthogonal sequence or spreading code, wᵢ(m)) on the time axis to the scrambled sequence, perform IFFT, and then perform transmission.

The UE may generate the sequence, based on a configured ID and a group hopping or sequence hopping configuration configured from the BS via higher layer signaling, and generate a sequence corresponding to a length of 1 RB by cyclic shifting the generated sequence with an initial cyclic shift (CS) value configured via a higher signal.

In case that a length (NSF) of a spreading code is given, wᵢ(m) is determined as in

$${w}_{i} ( m ) = {e}^{\frac{j 2 π ϕ ( m )}{{N}_{S F}}} ,$$

which is shown below in Table 11, wherein i indicates an index of the spreading code itself, and m indicates indices of elements of the spreading code. Numbers within [ ] in Table 11 refer to φ(m) in case that a length of the spreading code is 2. When an index of the configured spreading code is 0 (i=0), spreading code wᵢ(m) becomes wᵢ(0)=e^{j2π·0/N}^{_{SF}}=1, wᵢ(1)=e^{j2π·0/N}^{_{SF}}=1, so that wᵢ(m)=[1_1].

TABLE 6
$Spreading code for PUCCH format 1 {w}_{i} ( m ) = {e}^{\frac{j 2 πϕ ( m )}{{N}_{S F}}}$

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

PUCCH format 3 is a DFT-S-OFDM-based long PUCCH format capable of supporting control information exceeding 2 bits, and the number of used RBs is configurable via a higher layer. The control information may be configured with each of or a combination of HARQ-ACK, SR, and CSI. In PUCCH format 3, a DMRS symbol position is shown below in Table 12 according to whether an additional DMRS symbol is configured and whether frequency hopping is configured within a slot.

TABLE 7

| | DMRS position within PUCCH format 3/4 transmission | | | |
|---|---|---|---|---|
| | No additional DMRS | | Additional DMRS | |
| | configured | | configured | |
| Transmission | No | | No | |
| length of | frequency | frequency | frequency | frequency |
| PUCCH | hopping | hopping | hopping | hopping |
| format 3/4 | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

In case that the number of transmission symbols of PUCCH format 3 is 8 symbols, starting with a first start symbol being 0 among the 8 symbols, DMRSs are transmitted via the first and fifth symbols. Table 12 is applied in the same manner as a DMRS symbol position of PUCCH format 4.

PUCCH format 4 is a DFT-S-OFDM-based long PUCCH format capable of supporting control information exceeding 2 bits, and uses a frequency resource of 1 RB. The control information may be configured with each of or a combination of HARQ-ACK, SR, and CSI. A difference between PUCCH format 4 and PUCCH format 3 is that, for PUCCH format 4, PUCCH format 4 of multiple UEs may be multiplexed within one RB. Multiplexing of PUCCH format 4 of a plurality of UEs is possible via application of Pre-DFT orthogonal cover code (OCC) to control information at a previous stage of IFFT. However, the number of transmittable control information symbols of one UE decreases according to the number of multiplexed UEs. The number of multiplexable UEs, that is, the number of different available OCCs, may be 2 or 4, and the number of OCCs and the OCC index to be applied may be configured via a higher layer.

A short PUCCH may be transmitted in both a DL centric slot and a UL centric slot and, in general, the short PUCCH may be transmitted at a last symbol of a slot or an OFDM symbol at the end (e.g., the last OFDM symbol, a second OFDM symbol from the last, or last 2 OFDM symbols at the end). Apparently, transmission of the short PUCCH at a random position in the slot is also possible. Further, the short PUCCH may be transmitted using one OFDM symbol or two OFDM symbols. The short PUCCH may be used to shorten a delay time compared to a long PUCCH when UL cell coverage is good, and may be transmitted in a CP-OFDM scheme.

The short PUCCH may support transmission formats, such as PUCCH format 0 and PUCCH format 2, according to the number of supportable control information bits. PUCCH format 0 is a short PUCCH format capable of supporting control information of up to 2 bits, and uses a frequency resource of 1 RB. The control information may be configured with each of or a combination of HARQ-ACK and SR. PUCCH format 0 has a structure of transmitting no DMRS and transmitting only a sequence mapped to 12 subcarriers in the frequency axis within one OFDM symbol. The UE may generate a sequence, based on a configured ID and a group hopping or sequence hopping configuration received via a higher signal from the BS, cyclic-shifts the generated sequence by using a final CS value obtained by adding a different CS value to an indicated initial CS value depending on ACK or NACK, and maps the cyclic-shifted sequence to 12 subcarriers, so as to perform transmission.

For example, for HARQ-ACK of 1 bit, as shown below in Table 13, if ACK, the UE may generate the final CS by adding 6 to the initial CS value, and if NACK, the UE may generate the final CS by adding 0 to the initial CS. The CS value of 0 for NACK and the CS value of 6 for ACK are defined in the standard, and the UE may generate PUCCH format 0 according to the value defined in the standard to transmit 1-bit HARQ-ACK.

TABLE 8

| 1-bit HARQ-ACK | NACK | ACK |
|---|---|---|
| final CS | (initial CS + 0) mod | (initial CS + |
| | 12 = initial CS | 6) mod 12 |

For example, in case that HARQ-ACK is 2 bits, as shown below in Table 14, the UE adds 0 to the initial CS value for (NACK, NACK), adds 3 to the initial CS value for (NACK, ACK), adds 6 to the initial CS value for (ACK, ACK), and adds 9 to the initial CS value for (ACK, NACK). The CS value of 0 for (NACK, NACK), the CS value of 3 for (NACK, ACK), the CS value of 6 for (ACK, ACK), and the CS value of 9 for (ACK, NACK) are defined in the standard, and the UE may generate PUCCH format 0 according to the value defined in the standard so as to transmit a 2-bit HARQ-ACK. In case that the final CS value exceeds 12 due to the CS value added to the initial CS value according to ACK or NACK, since a sequence length is 12, modulo 12 may be applied to the final CS value.

TABLE 9

| 2-bit | NACK, | NACK, | ACK, | ACK, |
|---|---|---|---|---|
| HARQ-ACK | NACK | ACK | ACK | NACK |
| final CS | (initial CS + | (initial CS + | (initial CS + | (initial CS + |
| | 0) mod 12 = | 3) mod 12 | 6) mod 12 | 9) mod 12 |
| | initial CS | | | |

PUCCH format 2 is a short PUCCH format supporting control information exceeding 2 bits, and the number of used RBs may be configured via a higher layer. The control information may be configured with each of or a combination of HARQ-ACK, SR, and CSI. When an index of a first subcarrier is #0, in PUCCH format 2, positions of subcarriers in which a DMRS is transmitted may be fixed to subcarriers having indices of #1, #4, #7, and #10 within one OFDM symbol. The control information may be mapped to subcarriers remaining after excluding the subcarriers, in which the DMRS is positioned, via modulation after channel coding.

In summary, values configurable for the above-described respective PUCCH formats and ranges of the values may be organized as shown in Table 15 below, which illustrates N.A. in case that no value needs to be configured.

TABLE 10

| | | PUCCH | PUCCH | PUCCH | PUCCH | PUCCH |
|---|---|---|---|---|---|---|
| | | Format 0 | Format 1 | Format 2 | Format 3 | Format 4 |
| Starting | Configurability | ✓ | ✓ | ✓ | ✓ | ✓ |
| symbol | Value range | 0-13 | 0-10 | 0-13 | 0-10 | 0-10 |
| Number of | Configurability | ✓ | ✓ | ✓ | ✓ | ✓ |
| symbols in a | Value range | 1, 2 | 4-14 | 1,2 | 4-14 | 4-14 |
| slot | | | | | | |
| Index for | Configurability | ✓ | ✓ | ✓ | ✓ | ✓ |
| identifying | Value range | 0-274 | 0-274 | 0-274 | 0-274 | 0-274 |
| starting PRB | | | | | | |
| Number of | Configurability | N.A. | N.A. | ✓ | ✓ | N.A. |
| PRBs | Value range | N.A. (default | N.A. (default | 1-16 | 1-6, 8-10, 12, | N.A. (default |
| | | is 1) | is 1) | | 15, 16 | is 1) |
| Enabling | Configurability | ✓ | ✓ | ✓ | ✓ | ✓ |
| frequency | Value range | On/Off (only | On/Off | On/Off (only | On/Off | On/Off |
| hopping | | for 2 | | for 2 | | |
| (intra-slot) | | symbol) | | symbol) | | |
| Frequency | Configurability | ✓ | ✓ | ✓ | ✓ | ✓ |
| resource of 2^{nd} | Value range | 0-274 | 0-274 | 0-274 | 0-274 | 0-274 |
| hop if intra- | | | | | | |
| slot frequency | | | | | | |
| hopping is | | | | | | |
| enabled | | | | | | |
| Index of | Configurability | ✓ | ✓ | N.A. | N.A. | N.A. |
| initial cyclic | Value range | 0-11 | 0-11 | N.A. | N.A. | N.A. |
| shift | | | | | | |
| Index of time- | Configurability | N.A. | ✓ | N.A. | N.A. | N.A. |
| domain OCC | Value range | N.A. | 0-6 | N.A. | N.A. | N.A. |
| Length of Pre- | Configurability | N.A. | N.A. | N.A. | N.A. | ✓ |
| DFT OCC | Value range | N.A. | N.A. | N.A. | N.A. | 2, 4 |
| Index of Pre- | Configurability | N.A. | N.A. | N.A. | N.A. | ✓ |
| DFT OCC | Value range | N.A. | N.A. | N.A. | N.A. | 0, 1, 2, 3 |

To improve UL coverage, multi-slot repetition may be supported for PUCCH formats 1, 3, and 4, and PUCCH repetition may be configured for each PUCCH format. The UE may repeatedly transmit a PUCCH including UCI as many times as the number of slots configured via nrofSlots that is higher layer signaling. For the repeated PUCCH transmission, PUCCH transmission in each slot may be performed using the same number of consecutive symbols, and the number of the corresponding consecutive symbols may be configured via nrofSymbols in PUCCH-format 1, PUCCH-format 3, or PUCCH-format 4, which is higher layer signaling. For the repeated PUCCH transmission, PUCCH transmission in each slot may be performed using the same start symbol, and the corresponding start symbol may be configured via startingSymbolIndex in PUCCH-format 1, PUCCH-format 3, or PUCCH-format 4, which is higher layer signaling. For the repeated PUCCH transmission, a single PUCCH-spatialRelationInfo may be configured for a single PUCCH resource. For the repeated PUCCH transmission, if the UE is configured to perform frequency hopping in PUCCH transmission in different slots, the UE may perform frequency hopping in units of slots. In addition, if the UE is configured to perform frequency hopping in PUCCH transmission in different slots, the UE may start, in an even-numbered slot, the PUCCH transmission from a first PRB index configured via startingPRB that is higher layer signaling, and the UE may start, in an odd-numbered slot, the PUCCH transmission from a second PRB index configured via secondHopPRB that is higher layer signaling. Additionally, if the UE is configured to perform frequency hopping in PUCCH transmission in different slots, an index of a slot indicated to the UE for first PUCCH transmission is 0, and during the configured total number of repeated PUCCH transmissions, a value of the number of repeated PUCCH transmissions may be increased in each slot regardless of execution of the PUCCH transmission. If the UE is configured to perform frequency hopping in PUCCH transmission in different slots, the UE does not expect configuration of frequency hopping within the slot during PUCCH transmission. If the UE is not configured to perform frequency hopping in PUCCH transmission in different slots, but is configured with frequency hopping within a slot, a first PRB index and a second PRB index are applied equally in the slot. If the number of UL symbols available for PUCCH transmission is less than nrofSymbols configured through higher layer signaling, the UE may not transmit a PUCCH. Even if the UE fails to transmit a PUCCH in a certain slot during repeated PUCCH transmission, the UE may increase the number of repeated PUCCH transmissions.

In NR technical specification Release 17, the number of slots repeatedly transmitted for each PUCCH resource may be configured through pucch-RepetitionNrofSlots-r17, which is higher layer signaling, in PUCCH-ResourceExt, which is an extension of PUCCH-Resource, which is the higher layer signaling for PUCCH resources. If the higher layer signaling, pucch-RepetitionNrofSlots-r17, is configured, the corresponding PUCCH resource is scheduled. When the higher layer signaling, nrofSlots, is also configured, the UE determines the number of slots in which the corresponding PUCCH resource is repeatedly transmitted through pucch-RepetitionNrofSlots-r17 and ignores the higher layer signaling, nrofSlots.

### PUCCH Transmission Power

The following concerns when a UE configures transmission power of a UL control channel for transmission in case that UL control information is transmitted through the UL PUCCH in response to a power control command received from a BS. With the PUCCH power control adjustment state corresponding to the i-th transmission unit, closed-loop index l, the UL control channel transmission power (PPUCCH) of the UE may be determined as shown in Equation (2) below, expressed in the unit of decibel-milliwatts (dBm). In Equation (2), in case that the UE supports a plurality of carrier frequencies in a plurality of cells, each parameter may be set for the primary cell c, the carrier frequency f, and the BWP b, and each parameter may be classified as indices b, f, and c.

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{0 \_ PUCCH , b , f , c} ( {q}_{u} ) + 10 {log}_{10} ( {2}^{μ} * {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {f}_{b , f , c} ( i , l )\end{matrix}\end{matrix} \} [ dBm ] \qquad ( 2 )$$

In Equation (2), P_{CMAX,f,c}(i) is the maximum transmission power available to the UE in the i-th transmission unit and is determined by the power level of the UE, the parameters activated by the BS, and various parameters embedded in the UE.

P_{0_PUCCH,b,f,c}(qᵤ): P_{0_PUCCH,b,f,c}(qᵤ) may be composed of the sum of P_{0_NOMINAL_PUCCH} P_{0_UE_PUCCH}(qᵤ). P_{0_NOMINAL_PUCCH} is a cell specific value and is configured by P0-nominal as cell specific higher layer signaling, and if there is no corresponding configuration, P_{0_NOMINAL_PUCCH} may be 0 dBm. P_{0_UE_PUCCH}(qᵤ) is a UE-specific value and is configured through P0-PUCCH-Value in P0-PUCCH which is higher layer signaling, having a BWP b, a carrier frequency f, and a primary cell c, qᵤ may be a value greater than or equal to 0 and less than Qᵤ, Qᵤ may indicate the magnitude of a set of P_{0_UE_PUCCH} values and may be configured through maxNrofPUCCH-P0-PerSet, which is higher layer signaling. The set of P_{0_UE_PUCCH} values may be configured through P0-Set, which is higher layer signaling, and if there is no corresponding configuration, it may be considered as

$${P}_{{0}_{{UE}_{PUCCH}}} ( {q}_{u} ) = 0.$$

μ is a subcarrier spacing configuration value

M_{RB,b,f,c}^{PUCCH}(i) may represent the amount of resources (e.g., the number of Resource Blocks (RBs) for PUCCH transmission in the frequency axis) used in the i-th PUCCH transmission unit in BWP b, carrier frequency f and primary cell c.

PL_{b,f,c}(q_{d}) is a PL representing a PL between a BS and a UE, and the UE calculates the PL from a difference between a transmission power of a Reference Signal (RS) resource q_{d} signaled by the BS and a signal level received by the UE of the reference signal

Δ_{F_PUCCH} (F): for PUCCH format 0, if deltaF-PUCCH-f0, which is higher layer signaling, is configured, the corresponding value is used; for PUCCH format 1, if deltaF-PUCCH-f1, which is higher layer signaling, is configured, the corresponding value is used; for PUCCH format 2, if deltaF-PUCCH-f2, which is higher layer signaling, is configured, the corresponding value is used; for PUCCH format 3, if deltaF-PUCCH-f3, which is higher layer signaling, is configured, the corresponding value is used; for PUCCH format 4, if deltaF-PUCCH-f4, which is higher layer signaling, is configured, the corresponding value is used; for all PUCCH formats, if higher layer signaling is not configured, 0 may be used.

Δ_{TF,b,f,c}(i) is the PUCCH transmission power adjustment factor having the BWP b, the carrier frequency f, and the primary cell c, different calculation schemes may be used according to PUCCH formats.

g_{b,f,c}(i, l) indicates a PUCCH power control adjustment state value for an i-th PUCCH transmission unit corresponding to closed-loop index l in a BWP b, a carrier frequency f, and a primary cell c. Here, closed-loop power adjustment for PUCCH transmission may use an accumulation method that accumulates values indicated by TPC commands for application.

PUCCH power control adjustment state g_{b,f,c}(i, l) can be determined by BWP b, carrier frequency f, primary cell c, i-th transmission unit, and closed-loop index l.

δ_{PUCCH,b,f,c} (i, l) is a value indicated by a TPC command field included in DCI format 1_0, 1_1 or 1_2, which schedules a PDSCH reception and an i-th PUCCH transmission unit corresponding to closed-loop index/in BWP b, carrier frequency f and primary cell c, or a value indicated by a TPC command field included in DCI format 2_2 transmitted with CRC scrambled with TPC-PUCCH-RNTI.

The closed-loop index l may have a value of 0 or 1 if the UE is configured with twoPUCCH-PC-AdjustmentStates and PUCCH-SpatialRelationInfo, which are higher layer signaling.

The closed-loop index l may have a value of 0 if the UE is not configured with twoPUCCH-PC-AdjustmentStates or PUCCH-SpatialRelationInfo, which are higher layer signaling.

If the UE obtains a TPC command value through TPC command fields included in DCI formats 1_0, 1_1 or 1_2 scheduling PDSCH reception and the UE is configured with PUCCH-SpatialRelationInfo, which is higher layer signaling, the UE may obtain a connection relationship between the pucch-SpatialRelationInfold value and closeLoopIndex value that configures a closed-loop index/value, based on an index that may be configured through p0-PUCCH-Id, which is higher layer signaling. If the UE receives a MAC-CE corresponding to pucch-SpatialRelationInfoId, the UE may determine closeLoopIndex value to configure the closed-loop index/value based on the corresponding p0-PUCCH-Id index.

If the UE obtains one TPC command value from the TPC command field included in DCI format 2_2, which is transmitted along with the CRC scrambled with TPC-PUCCH-RNTI, it may obtain the/value based on the closed-loop index field included in the corresponding DCI format 2_2.

PUCCH power control adjustment state g_{b,f,c}(i, l) for the i-th PUCCH transmission unit corresponding to closed-loop index l in a BWP b, a carrier frequency f, and a primary cell c may be calculated as in Equation (3) below.

$${g}_{b , f , c} ( i , l ) = {g}_{b , f , c} ( i - {i}_{0} , l ) + {\sum }_{m = 0}^{c ( {C}_{i} ) - 1} {δ}_{PUCCH , b , f , c} ( m , l ) \qquad ( 3 )$$

In Equation (3), δ_{PUCCH,b,f,c}(m, l) may be a value indicated by a TPC command field included in DCI format 1_0, 1_1 or 1_2, which schedules an m-th PUCCH transmission unit corresponding to PDSCH reception and closed-loop index l in a BWP b, a carrier frequency f and a primary cell c, or a value indicated by a TPC command field included in DCI format 2_2 transmitted with CRC scrambled with TPC-PUCCH-RNTI. In case that TPC command accumulation operation is possible, δ_{PUCCH,b,f,c} may have a value in unit of dB corresponding to a value indicated by a TPC command field included in DCI format 1_0, 1_1, 1_2, or 2_2, as shown in Table 18 below. For example, in case that the value of the TPC command field is 0, δ_{PUCCH,b,f,c} may have a value of −1 dB.

Σₘ₌₀^{c(C}^{ᵢ}⁾⁻¹ δ_{PUCCH,b,f,c}(m, l) may indicate the sum of the above TPC command values δ_{PUCCH,b,f,c} for all corresponding transmission units within a specific set Cᵢ. Here, c(Cᵢ) may indicate the number of all elements belonging to the set Cᵢ. Cᵢ may refer to a set of DCIs including all TPC command values to perform a TPC command accumulation operation for the i-th PUCCH transmission unit. To determine Cᵢ, a start point and end point may be defined in a time dimension, and all DCIs received by the UE between the two points may be included as elements of Cᵢ.

The end point for determining Cᵢ may be a point before the K_{PUCCH}(i) symbol from the start symbol of the i-th PUCCH transmission unit.

The starting point for determining Cᵢ may be a point before the K_{PUCCH}(i−i₀)−1 symbol from the start symbol of the i−i₀ th PUCCH transmission unit. The positive integer i₀ may be determined as a minimum value that satisfies that a point in time before the K_{PUCCH} (i−i₀) symbol from the start symbol of the i−i₀ th PUCCH transmission unit to be earlier in time than the end point at which Cᵢ is determined (the point before the K_{PUCCH}(i) symbol from the start symbol of the i-th PUCCH transmission unit).

For example, in case that sym(i) refers to determining the end point of Cᵢ and sym(i−i₀) refers to the time point before the K_{PUCCH}(i−i₀) symbol from the start symbol of the i−i₀ th PUCCH transmission unit, i₀ may be determined as 2 in case of sym(i)=sym(i−1)>sym(i−2)>sym(i−3).

### PUSCH Transmission Scheme

The PUSCH transmission may be dynamically scheduled by UL grant in DCI or may operate by configured grant Type 1 or Type 2. A dynamic scheduling indication regarding the PUSCH transmission is enabled by a DCI format 0_0 or 0_1.

The configured grant Type 1 PUSCH transmission may be quasi-statically configured through reception of configuredGrantConfig including rrc-ConfiguredUplinkGrant of Table 16 through higher layer signaling, without receiving the UL grant in the DCI. The configured grant Type 2 PUSCH transmission may be semi-persistently scheduled by the UL grant in the DCI after reception of configuredGrantConfig not including rrc-ConfiguredUplinkGrant of Table 16, through higher layer signaling. In case that the PUSCH transmission operates by configured grant, parameters applied to the PUSCH transmission are applied through configuredGrantConfig that is higher layer signaling of Table 16, except for dataScramblingIdentityPUSCH, txConfig, codebookSubset, maxRank, and scaling of UCI-OnPUSCH provided through pusch-Config of Table 17 that is higher layer signaling. When the UE is provided with transformPrecoder in the configuredGrantConfig that is higher layer signaling of Table 16 below, the UE applies tp-pi2BPSK in the pusch-Config of Table 17 below with respect to the PUSCH transmission operating by the configured grant.

TABLE 11

| | |
|---|---|
| ConfiguredGrantConfig ::= | SEQUENCE { |
| frequencyHopping | ENUMERATED {intraSlot, interSlot} |

| | |
|---|---|
| OPTIONAL, | -- Need S, |

| | |
|---|---|
| cg-DMRS-Configuration | DMRS-UplinkConfig, |
| mcs-Table | ENUMERATED { qam256, qam64LowSE} |

| | |
|---|---|
| OPTIONAL, | -- Need S |

| | |
|---|---|
| mcs-TableTransformPrecoder | ENUMERATED {qam256, qam64LowSE} |

| | |
|---|---|
| OPTIONAL, | -- Need S |

| | |
|---|---|
| uci-OnPUSCH | SetupRelease { CG-UCI-OnPUSCH } |

| | |
|---|---|
| OPTIONAL, | -- Need M |

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

| | |
|---|---|
| OPTIONAL, | -- Need S |

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

| | |
|---|---|
| OPTIONAL, | -- Need S |

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

| | |
|---|---|
| OPTIONAL, | -- Need R |

| | |
|---|---|
| periodicity | ENUMERATED { |
| | sym2, sym7, sym1x14, sym2x14, |

sym4x14, sym5x14, sym8x14, sym10x14, sym16x14, sym20x14,

sym32x14, sym40x14, sym64x14,

sym80x14, sym128x14, sym160x14, sym256x14, sym320x14, sym512x14,

sym640x14, sym 1024x14,

sym 1280x14, sym2560x14, sym5120x14,

sym6, sym1x12, sym2x12,

sym4x12, sym5x12, sym8x12, sym 10x12, sym16x12, sym20x12, sym32x12,

sym40x12, sym64x12, sym80x12,

sym128x12, sym160x12, sym256x12, sym320x12, sym512x12, sym640x12,

sym1280x12, sym2560x12

},

| | |
|---|---|
| configuredGrantTimer | INTEGER (1..64) |

| | |
|---|---|
| OPTIONAL, | -- Need R |

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

| | |
|---|---|
| OPTIONAL, | -- Need R |

| | |
|---|---|
| precodingAndNumberOfLayers | INTEGER (0..63), |
| srs-ResourceIndicator | INTEGER (0..15) |

| | |
|---|---|
| OPTIONAL, | -- Need R |

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

```
PathlossReferenceRSs-1),
    ...
  }
```

| | |
|---|---|
| OPTIONAL, | -- Need R |

...
}

A DMRS antenna port for PUSCH transmission is the same as an antenna port for SRS transmission. The PUSCH transmission may follow a codebook-based transmission method or a non-codebook-based transmission method, depending on whether a value of txConfig in the pusch-Config of Table 17 that is higher layer signaling is ‘codebook’ or ‘nonCodebook’.

As described above, the PUSCH transmission may be dynamically scheduled through the DCI format 0_0 or 0_1, and may be configured quasi-statically by the configured grant. When scheduling regarding the PUSCH transmission is indicated to the UE through the DCI format 0_0, the UE may perform beam configuration for the PUSCH transmission by using pucch-spatialRelationInfoID corresponding to a UE-specific PUCCH resource corresponding to a minimum ID in a UL BWP activated in a serving cell, and in this case, the PUSCH transmission is based on a single antenna port. The UE does not expect the scheduling regarding the PUSCH transmission through the DCI format 0_0, in a BWP in which a PUCCH resource including pucch-spatialRelationInfo is not configured. When the UE is not configured with txConfig in the pusch-Config of Table 17 below, the UE does not expect to be scheduled through the DCI format 0_1.

TABLE 12

| | |
|---|---|
| PUSCH-Config ::= | SEQUENCE { |
| dataScramblingIdentityPUSCH | INTEGER (0..1023) |

| | |
|---|---|
| OPTIONAL, | -- Need S |

| | |
|---|---|
| txConfig | ENUMERATED {codebook, |
| nonCodebook} | OPTIONAL, -- Need S |
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

| | |
|---|---|
| OPTIONAL, | -- Need M |

| | |
|---|---|
| frequencyHopping | ENUMERATED {intraSlot, interSlot} |

| | |
|---|---|
| OPTIONAL, | -- Need S |

| | |
|---|---|
| frequencyHoppingOffsetLists | SEQUENCE (SIZE (1..4)) OF INTEGER |

(1..maxNrofPhysicalResourceBlocks-1)

| | |
|---|---|
| OPTIONAL, | -- Need M |

| | |
|---|---|
| resourceAllocation | ENUMERATED |

{ resourceAllocationType0, resourceAllocationType1, dynamicSwitch },

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

| | |
|---|---|
| OPTIONAL, | -- Need S |

| | |
|---|---|
| mcs-Table | ENUMERATED {qam256, |
| qam64LowSE} | OPTIONAL, -- Need S |
| mcs-TableTransformPrecoder | ENUMERATED {qam256, |
| qam64LowSE} | OPTIONAL, -- Need S |
| transformPrecoder | ENUMERATED {enabled, disabled} |

| | |
|---|---|
| OPTIONAL, | -- Need S |

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

The codebook-based PUSCH transmission may be dynamically scheduled through the DCI format 0_0 or 0_1, or may quasi-statically operate by the configured grant. When the codebook-based PUSCH transmission is dynamically scheduled by the DCI format 0_1 or quasi-statically configured by the configured grant, the UE determines a precoder for the PUSCH transmission, based on an SRS resource indicator (SRI), a transmission precoding matrix indicator (TPMI), and a transmission rank (the number of PUSCH transmission layers).

The SRI may be provided through an SRI field in the DCI or via srs-ResourceIndicator that is higher layer signaling. The UE is configured with at least one SRS resource, and may be configured up to two SRS resources, during the codebook-based PUSCH transmission. In case that the UE is provided with the SRI through the DCI, an SRS resource indicated by the corresponding SRI refers to an SRS resource corresponding to the SRI, from among SRS resources transmitted before a PDCCH including the corresponding SRI. The TPMI and transmission rank may be provided through field precoding information and number of layers in the DCI or may be configured via precodingAndNumberOfLayers that is higher layer signaling. The TPMI is used to indicate a precoder applied to the PUSCH transmission. When the UE is configured with one SRS resource, the TPMI is used to indicate the precoder to be applied to the one configured SRS resource. When the UE is configured with a plurality of SRS resources, the TPMI is used to indicate the precoder to be applied to the SRS resource indicated through the SRI.

The precoder to be used for the PUSCH transmission is selected from a UL codebook having the number of antenna ports equal to a value of nrofSRS-Ports in SRS-Config that is higher layer signaling. In the codebook-based PUSCH transmission, the UE determines a codebook subset, based on the TPMI and the codebookSubset in the pusch-Config that is higher layer signaling. The codebookSubset in the pusch-Config that is higher layer signaling may be configured to be one of ‘fullyAndPartialAndNonCoherent’, ‘partialAndNonCoherent’, and ‘nonCoherent’, based on UE capability reported by the UE to the BS. If the UE reported ‘partial AndNonCoherent’ as the UE capability, the UE does not expect a value of codebook Subset that is higher layer signaling to be configured to ‘fully AndPartialAndNonCoherent’. If the UE reported ‘nonCoherent’ as the UE capability, the UE does not expect the value of codebook Subset that is higher layer signaling to be configured to ‘fullyAndPartialAndNonCoherent’ or ‘partialAndNonCoherent’. In case that nrofSRS-Ports in SRS-ResourceSet that is higher layer signaling indicates two SRS antenna ports, the UE does not expect the value of codebook Subset that is higher layer signaling to be configured to ‘partialAndNonCoherent’.

The UE may be configured with one SRS resource set in which a value of usage in SRS-ResourceSet that is higher layer signaling is configured to ‘codebook’, and one SRS resource in the corresponding SRS resource set may be indicated through SRI. If several SRS resources are configured in the SRS resource set in which the value of usage in SRS-ResourceSet that is higher layer signaling is configured to ‘codebook’, the UE expects a value of nrofSRS-Ports in SRS-Resource that is higher layer signaling to be the same for all SRS resources.

The UE transmits, to the BS, one or a plurality of SRS resources included in the SRS resource set in which the value of usage is configured to ‘codebook’ according to higher layer signaling, and the BS selects one of the SRS resources transmitted by the UE and indicates the UE to perform the PUSCH transmission, by using transmission beam information of the corresponding SRS resource. In the codebook-based PUSCH transmission, SRI is used as information for selecting an index of one SRS resource, and is included in the DCI. In addition, the BS includes, to the DCI, information indicating the TPMI and rank to be used by the UE for the PUSCH transmission. The UE performs the PUSCH transmission by applying the precoder indicated by the rank and TPMI indicated based on a transmission beam of the corresponding SRS resource, by using the SRS resource indicated by the SRI.

The non-codebook-based PUSCH transmission may be dynamically scheduled through the DCI format 0_0 or 0_1, or may quasi-statically operate by the configured grant. In case that at least one SRS resource is configured in the SRS resource set in which a value of usage in SRS-ResourceSet that is higher layer signaling is configured to ‘nonCodebook’, the UE may receive scheduling of the non-codebook-based PUSCH transmission through the DCI format 0_1.

Regarding the SRS resource set in which the value of usage in SRS-ResourceSet that is higher layer signaling is configured to ‘nonCodebook’, the UE may receive configuration of one connected non-zero power (NZP) CSI-RS resource. The UE may perform calculation regarding a precoder for SRS transmission through measurement on the NZP CSI-RS resource connected to the SRS resource set. If a difference between a last reception symbol of an aperiodic NZP CSI-RS resource connected to the SRS resource set and a first symbol of aperiodic SRS transmission is less than 42 symbols, the UE does not expect information regarding the precoder for SRS transmission to be updated.

If a value of resourceType in SRS-ResourceSet that is higher layer signaling is configured to be ‘aperiodic’, the connected NZP CSI-RS is indicated by an SRS request that is a field in the DCI format 0_1 or 1_1. When the connected NZP CSI-RS resource is an aperiodic NZP CSI-RS resource, it is indicated that the connected NZP CSI-RS is present regarding when a value of SRS request that is the field in the DCI format 0_1 or 1_1 is not ‘00’. In this case, corresponding DCI does not indicate cross carrier or cross BWP scheduling. Also, when the value of SRS request indicates the presence of NZP CSI-RS, the corresponding NZP CSI-RS is located at a slot on which PDCCH including an SRS request field is transmitted. TCI states configured in a scheduled subcarrier are not configured to be QCL-TypeD.

If a periodic or semi-persistent SRS resource set is configured, the connected NZP CSI-RS may be indicated through associatedCSI-RS in the SRS-ResourceSet that is higher layer signaling. Regarding the non-codebook-based transmission, the UE does not expect spatialRelationInfo that is higher layer signaling for the SRS resource and associatedCSI-RS in SRS-ResourceSet that is higher layer signaling to be configured together.

In case that a plurality of SRS resources are configured, the UE may determine the precoder and a transmission rank to be applied to the PUSCH transmission, based on SRI indicated by the BS. The SRI may be indicated through a field SRI in the DCI or configured through srs-ResourceIndicator that is higher layer signaling. Similar to the above-described codebook-based PUSCH transmission, in case that the UE receives the SRI through the DCI, the SRS resource indicated by the corresponding SRI refers to an SRS resource corresponding to the SRI from among SRS resources transmitted prior to the PDCCH including the corresponding SRI. The UE may use one or a plurality of SRS resources for SRS transmission, and the maximum number of SRS resources capable of being simultaneously transmitted from a same symbol in one SRS resource set is determined by UE capability reported by the UE to the BS. The SRS resources simultaneously transmitted by the UE occupy a same RB. The UE configures one SRS port for each SRS resource. Only one SRS resource set, in which the value of usage in SRS-ResourceSet that is higher layer signaling is configured to be ‘nonCodebook’, may be configured, and up to 4 SRS resources for the non-codebook-based PUSCH transmission may be configured.

The BS transmits, to the UE, one NZP-CSI-RS connected to an SRS resource set, and the UE calculates a precoder to be used to transmit one or a plurality of SRS resources in the corresponding SRS resource set, based on a result measured when receiving the NZP-CSI-RS. The UE applies the calculated precoder when transmitting, to the BS, one or plurality of SRS resources in the SRS resource set, in which the usage is configured to be ‘nonCodebook’, and the BS selects one or plurality of SRS resources from among the received one or plurality of SRS resources. In the non-codebook-based PUSCH transmission, the SRI denotes an index capable of representing one SRS resource or a combination of a plurality of SRS resources, and the SRI is included in the DCI. The number of SRS resources indicated by the SRI transmitted by the BS may be the number of transmission layers of the PUSCH, and the UE transmits the PUSCH by applying, to each layer, the precoder applied for the SRS resource transmission.

### PUSCH Power Control

A method will be described in which a UE configures transmission power of a UL data channel for transmission in case that UL data is transmitted through the UL (PUSCH in response to a power control command received from a BS. With the PUSCH power control adjustment state, the parameter set configuration index j, and the closed-loop index l corresponding to the i-th PUSCH transmission unit, the UL data channel transmission power of the UE may be determined as shown in Equation (4) below, expressed in dBm units. In Equation (4), in case that the UE supports a plurality of carrier frequencies in a plurality of cells, each parameter may be determined for cell c, carrier frequency f, and BWP b, and each parameter may be classified by indices b, f, and c.

$${P}_{PUSCH , b , f , c} ( i , j , {q}_{d} , l ) = min \{ \begin{matrix}{P}_{CMAX , f , c} ( i ) , \\ \begin{matrix}{P}_{0 \_ PUSCH , b , f , c} ( j ) + 10 {log}_{10} ( {2}^{μ} * {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] \qquad ( 4 )$$

In Equation (4), P_{CMAX,f,c} (i) is the maximum transmission power available to the UE in the i-th transmission unit and is determined by the power level of the UE, the parameters activated by the BS, and various parameters embedded in the UE.

P_{0_PUSCH,b,f,c} (j) is composed of the sum of P_{0_NOMINAL_PUSCH,f,c} (j) and P_{0_UE_PUSCH,b,f,c} (j). P_{0_NOMINAL_PUSCHb,f,c} (j) is configured to the UE through cell-specific higher layer signaling, P_{0_UE_PUSCH,b,f,c} (j) is a value configured through UE-specific higher layer signaling. When j=0, this represents PUSCH for transmitting msg 3, when j=1, this represents the configured grant PUSCH, when it is one value of j={2, . . . , J−1}, this represents grant PUSCH.

μ: subcarrier spacing configuration value

M_{RB,b,f,c}^{PUSCH}(i) may represent the amount of resources used in the i-th PUSCH transmission unit (e.g., the number of Resource Blocks (RBs) used for PUSCH transmission in the frequency axis).

α_{b,f,c}(j) refers to a value that may be determined (in case of dynamic grant PUSCH) through higher layer configuration and SRI as a value to compensate for PL.

PL_{b,f,c}(q_{d}) is a PL representing a PL between a BS and a UE, and the UE calculates the PL from a difference between a transmission power of a Reference Signal (RS) resource q_{d} signaled by the BS and a signal level received by the UE of the reference signal. It refers to a DL PL estimate estimated by the UE through a reference signal with reference signal index q_{d}, and the reference signal index q_{d} may be determined by the UE through higher layer configuration and SRI (when dynamic grant PUSCH or configuration grant PUSCH (type 2 configuration grant PUSCH) based on ConfiguredGrantConfig not including higher layer configuration, rrc-ConfiguredUplinkGrant) or through higher layer configuration.

Δ_{TE,b,f,c}(i) refers to a value determined according to a Modulation Coding Scheme (MCS) and a format of information transmitted on PUSCH (TF: transport format, e.g., whether UL-SCH or CSI is included, etc.).

f_{b,f,c}(i, l) is a closed-loop power control adjustment value, represents the value of the closed-loop index/that can be determined by the higher layer configuration and the SRI of PUSCH. Closed-loop power adjustment of PUSCH transmission may be classified into an accumulation method of accumulating a value indicated by TPC command for application and an absolute method of directly applying a value indicated by TPC command, which may be determined according to whether the higher layer parameter TPC-accounting is configured. If the higher layer parameter tpc-Accumulation is configured to disable, closed-loop power adjustment is performed on the PUSCH transmission using an absolute method; if tpc-Accumulation is not configured, closed-loop power adjustment is performed on the PUSCH transmission using the accumulation method.

PUSCH power control adjustment state f_{b,f,c}(i, l) may be determined based on BWP b, carrier frequency f, cell c, i-th transmission unit, and closed-loop index l.

δ_{PUSCH,b,f,c}(i, l) is a value indicated by a TPC command field included in DCI format 0_0, 0_1 or 0_2, which schedules an i-th PUSCH transmission unit corresponding to a closed-loop index l in a BWP b, a carrier frequency f, a cell c, or a value indicated by a TPC command field included in DCI format 2_2 transmitted with CRC scrambled with TPC-PUSCH-RNTI.

The closed-loop index l may have a value of 0 or 1 if the UE is configured with twoPUSCH-PC-AdjustmentStates that is higher layer signaling.

The closed-loop index/may have a value of 0 if the UE is not configured with twoPUSCH-PC-AdjustmentStates that is higher layer signaling or is scheduled with PUSCH transmissions based on RAR UL grants.

In case that the UE is configured with ConfiguredGrantConfig that is higher layer signaling and performs PUSCH transmission or retransmission for this purpose, the closed-loop index/may follow powerControlLoopToUse value that is higher layer signaling.

If the UE is configured with SRI-PUSCH-PowerControl that is higher layer signaling, the UE may obtain a connection relation between a value indicated by an SRI field in a DCI format in which PUSCH transmission is scheduled and a closed-loop index l configured through sri-PUSCH-ClosedLoopIndex that is higher layer signaling, and determine the closed-loop index l based on the value indicated by the SRI field in the DCI format based on the corresponding connection relation.

The UE may consider the closed-loop index l as 0 if the UE is scheduled with PUSCH transmissions based on a DCI format that does not include an SRI field or is not configured with SRI-PUSCH-PowerControl that is higher layer signaling.

If the UE is indicated to receive TPC command values through a TPC command field included in DCI format 2_2, which DCI format 2_2 is transmitted with TPC-PUSCH-RNTI scrambled CRC, the closed-loop index l may be indicated through a closed-loop index field included in DCI format 2_2.

The PUSCH power control adjustment state f_{b,f,c}(i, l) for the i-th PUSCH transmission unit corresponding to the closed-loop index/in a BWP b, a carrier frequency f and in a cell c may be calculated as in Equation (5) below if the UE is not configured with tpc-Accumulation that is higher layer signaling, i.e., if the corresponding UE may perform TPC command Accumulation operation.

$${f}_{b , f , c} ( i , l ) = {f}_{b , f , c} ( i - {i}_{0} , l ) + {\sum }_{m = 0}^{c ( {D}_{i} ) - 1} {δ}_{PUSCH , b , f , c} ( m , l ) \qquad ( 5 )$$

In Equation (5), δ_{PUSCH,b,f,c}(m, l) may be a value indicated by a TPC command field included in DCI format 0_0, 0_1 or 0_2, which schedules an m-th PUSCH transmission unit corresponding to a closed-loop index l in a BWP b, a carrier frequency f and a cell c, as described above, or a value indicated by a TPC command field included in DCI format 2_2 transmitted with CRC scrambled with TPC-PUSCH-RNTI. In case that the TPC command accumulation operation is possible, the value of δ_{PUSCH,b,f,c} may have a corresponding value in dB units depending on which value with which the TPC command field included in the DCI format 0_0, 0_1, 0_2, or 2_2 is indicated, as shown in Table 18 below. For example, in case that the value of the TPC command field is 0, δ_{PUSCH,b,f,c} may have a value of −1 dB.

Σₘ₌₀^{c(D}^{ᵢ}⁾⁻¹ δ_{PUSCH,b,f,c}(m, l) may refer to the sum of the above TPC command values, δ_{PUSCH,b,f,c} for all transmission units belonging to a particular set Dᵢ. Here, c(Dᵢ) may refer to the number of all elements belonging to the set Dᵢ. Dᵢ may refer to a set of DCIs including all TPC command values to perform TPC command accumulation operations for the i-th PUSCH transmission unit. To determine Dᵢ, a start point and end point may be defined in a time dimension, and all DCIs received by the UE between the two points may be included as elements of Dᵢ.

The end point for determining Dᵢ may be a point before the K_{PUSCH}(i) symbol from the start symbol of the i-th PUSCH transmission unit.

The starting point for determining Dᵢ may be a point before the K_{PUSCH}(i−i₀)−1 symbol from the start symbol of the i−i₀ th PUSCH transmission unit. The positive integer i₀ may be determined as a minimum value that satisfies that a point in time before the K_{PUSCH} (i−i₀) symbol from the start symbol of the i−i₀ th PUSCH transmission unit to be earlier in time than the end point at which Dᵢ is determined (the point before the K_{PUSCH}(i) symbol from the start symbol of the i-th PUSCH transmission unit).

For example, in case that sym(i) may be defined to determine the end point of Dᵢ and the time point before the K_{PUSCH}(i−i₀) symbol from the start symbol of the i−i₀ th PUSCH transmission unit may be defined as sym(i−i₀), i₀ may be determined as 2 in case of sym(i−1)>sym(i−2)>sym(i−3).

The PUSCH power control adjustment state f_{b,f,c}(i, l) for the i-th PUSCH transmission unit corresponding to the closed-loop index/in a BWP b, a carrier frequency f and a cell c may be calculated as in Equation (6) below, when the UE is configured with tpc-Accumulation that is higher layer signaling and the UE is unable to perform TPC command accumulation operation.

$${f}_{b , f , c} ( i , l ) = {δ}_{PUSCH , b , f , c} ( i , l ) \qquad ( 6 )$$

In Equation (6), δ_{PUSCH,b,f,c}(i, l) may be a value indicated by a TPC command field included in DCI format 0_0, 0_1 or 0_2, which schedules an i-th PUSCH transmission unit corresponding to a closed-loop index/in a BWP b, a carrier frequency f and a cell c, as described above, or a value indicated by a TPC command field included in DCI format 2_2 transmitted with CRC scrambled with TPC-PUSCH-RNTI. In case that the TPC command accumulation operation is impossible, the value of δ_{PUSCH,b,f,c} may have a corresponding value in dB units depending on the value with which the TPC command field included in the DCI format 0_0, 0_1, 0_2, or 2_2 is indicated, as shown in Table 18 below. For example, when the value of the TPC command field is 0, δ_{PUSCH,b,f,c} may have a value of −4 dB.

TABLE 13

| TPC | Accumulated | Absolute |
|---|---|---|
| command | δ_{PUSCH, b, f, c} | δ_{PUSCH, b, f, c} |
| field | [dB] | [dB] |
| 0 | −1 | −4 |
| 1 | 0 | −1 |
| 2 | 1 | 1 |
| 3 | 3 | 4 |

### SRS

UL A BS may configure the UE with at least one SRS configuration for each UL BWP and at least one SRS resource set for each SRS configuration, so as to transmit configuration information for the SRS transmission. For example, the BS and UE may exchange higher layer signaling information as below to transfer information about the SRS resource set.
srs-ResourceSetId is an index of SRS resource set
srs-ResourceIdList is a group of SRS resource indices referred to by an SRS resource set
resourceType is a time axis transmission configuration of an SRS resource referred to by an SRS resource set, and may be configured to be one of ‘periodic’, ‘semi-persistent’, and ‘aperiodic’. When configured to be ‘periodic’ or ‘semi-persistent’, associated CSI-RS information may be provided depending on where the SRS resource set is used. When configured to be ‘aperiodic’, an aperiodic SRS resource trigger list and slot offset information may be provided, and the associated CSI-RS information may be provided depending on where the SRS resource set is used.
usage is a configuration regarding where an SRS resource referred to by an SRS resource set is used, and may be configured to be one of ‘beamManagement’, ‘codebook’, ‘nonCodebook’, and ‘antennaSwitching’.
alpha, p0, pathlossReferenceRS, srs-PowerControlAdjustmentStates provides a parameter configuration for transmission power control of an SRS resource referred to by an SRS resource set.

The UE may interpret that an SRS resource included in a group of SRS resource indices referred to by an SRS resource set follows information configured in the SRS resource set.

The BS and UE may transmit and receive higher layer signaling information to transfer individual configuration information regarding the SRS resource. For example, the individual configuration information regarding the SRS resource may include time-frequency axis mapping information in a slot of the SRS resource, and the time-frequency axis mapping information may include information about frequency hopping within a slot or between slots of the SRS resource. The individual configuration information regarding the SRS resource may include a time axis transmission configuration of the SRS resource, and may be configured to be one of ‘periodic’, ‘semi-persistent’, and ‘aperiodic’. The individual configuration information may be limited to have a same time axis transmission configuration as the SRS resource set including the SRS resource. In case that the time axis transmission configuration of the SRS resource is configured to be ‘periodic’ or ‘semi-persistent’, an SRS resource transmission period and a slot offset (for example, periodicity AndOffset) may be additionally included in the time axis transmission configuration.

The BS may activate, deactivate, or trigger the SRS transmission in the UE through higher layer signaling including RRC signaling or MAC CE signaling, or through L1 signaling (for example, DCI). For example, the BS may activate or deactivate periodic SRS transmission in the UE through higher layer signaling. The BS may indicate an SRS resource set in which resource Type is configured to be periodic to be activated through higher layer signaling, and the UE may transmit an SRS resource referred to by the activated SRS resource set. Time-frequency axis resource mapping in a slot of the transmitted SRS resource follows resource mapping information configured in the SRS resource, and slot mapping including a transmission period and slot offset follows periodicityAndOffset configured in the SRS resource. A spatial domain transmission filter applied to the transmitted SRS resource may refer to spatial relation information configured in the SRS resource or to associated CSI-RS information configured in the SRS resource set including the SRS resource. The UE may transmit the SRS resource in a UL BWP activated regarding the periodic SRS resource activated through the higher layer signaling.

For example, the BS may activate or deactivate semi-persistent SRS transmission in the UE through higher layer signaling. The BS may indicate an SRS resource set to be activated through MAC CE signaling, and the UE may transmit an SRS resource referred to by the activated SRS resource set. The SRS resource set activated through the MAC CE signaling may be limited to an SRS resource set in which resource Type is configured to be semi-persistent. Time-frequency axis resource mapping in a slot of the transmitted SRS resource follows resource mapping information configured in the SRS resource, and slot mapping including a transmission period and slot offset follows periodicityAndOffset configured in the SRS resource. A spatial domain transmission filter applied to the transmitted SRS resource may refer to spatial relation information configured in the SRS resource or to associated CSI-RS information configured in the SRS resource set including the SRS resource. In case that the spatial relation information is configured in the SRS resource, the spatial domain transmission filter may be determined by with reference to configuration information regarding the spatial relation information transmitted through MAC CE signaling for activating semi-persistent SRS transmission, without following the spatial relation information configured in the SRS resource. The UE may transmit the SRS resource in a UL BWP activated regarding the semi-persistent SRS resource activated through the higher layer signaling.

For example, the BS may trigger aperiodic SRS transmission in the UE through DCI. The BS may indicate one of aperiodic SRS resource triggers (aperiodicSRS-ResourceTrigger) through an SRS request field of the DCI. The UE may interpret that an SRS resource set including an aperiodic SRS resource trigger indicated through the DCI has been triggered from an aperiodic SRS resource trigger list from among configuration information of the SRS resource set. The UE may transmit an SRS resource referred to by the triggered SRS resource set. A time-frequency axis resource mapping in a slot of the transmitted SRS resource may follow resource mapping information configured in the SRS resource. Also, slot mapping of the transmitted SRS resource may be determined through a slot offset between the SRS resource and a PDCCH including the DCI, and the slot offset may refer to a value(s) included in a slot offset group configured in the SRS resource set. In detail, the slot offset between the SRS resource and the PDCCH including the DCI may be applied with a value indicated by a time domain resource assignment field of the DCI among an offset value(s) included in the slot offset group configured in the SRS resource set. A spatial domain transmission filter applied to the transmitted SRS resource may refer to spatial relation information configured in the SRS resource or to associated CSI-RS information configured in the SRS resource set including the SRS resource. The UE may transmit the SRS resource in a UL BWP activated regarding the aperiodic SRS resource triggered through the DCI. In case that the BS triggers aperiodic SRS transmission in the UE through DCI, a minimum time interval between a PDCCH including the DCI triggering the aperiodic SRS transmission and a transmitted SRS may be required for the UE transmit the SRS by applying configuration information regarding the SRS resource. A time interval for SRS transmission of the UE may be defined by the number of symbols between a last symbol of the PDCCH including the DCI triggering the aperiodic SRS transmission and a first symbol to which an SRS resource transmitted the earliest from among transmitted SRS resource(s) is mapped. The minimum time interval may be determined by with reference to a PUSCH preparation procedure time required for the UE to prepare for PUSCH transmission. The minimum time interval may have different values according to the usage of an SRS resource set including the transmitted SRS resource. For example, the minimum time interval may refer to the PUSCH preparation procedure time of the UE and may be determined to be N2 symbols defined in consideration of UE processing capability according to capability of the UE. Also, in case that the SRS resource set is configured to be used for ‘codebook’ or ‘antennaSwitching’, considering where the SRS resource set including the transmitted SRS resource is used, the minimum time interval may be determined to be N2 symbols. When the SRS resource set is configured to be used for ‘nonCodebook’ or ‘beamManagement’, the minimum time interval may be determined to be N2+14 symbols. In case that the time interval for aperiodic SRS transmission is equal to or greater than the minimum time interval, the UE may transmit aperiodic SRS. When the time interval for aperiodic SRS transmission is smaller than the minimum time interval, the UE may ignore the DCI triggering the aperiodic SRS.

TABLE 14

| | |
|---|---|
| SRS-Resource ::= | SEQUENCE { |
| srs-ResourceId | SRS-ResourceId, |
| nrofSRS-Ports | ENUMERATED {port1, ports2, |

ports4},

| | |
|---|---|
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, |

n4},

| | |
|---|---|
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS- |

```
PeriodicityAndOffset,
      ...
    },
```

| | |
|---|---|
| periodic | SEQUENCE |
| periodicityAndOffset-p | SRS- |

```
PeriodicityAndOffset,
      ...
    }
  },
```

| | |
|---|---|
| sequenceId | INTEGER (0..1023), |
| spatialRelationInfo | SRS-SpatialRelationInfo |

OPTIONAL, -- Need R
...
}

The spatialRelationInfo configuration information in Table 19 above may be applied to a beam used for SRS transmission corresponding to beam information of a reference signal with reference to one reference signal. For example, a spatialRelationInfo configuration may include information in Table 20 below.

TABLE 15

| SRS-SpatialRelationInfo ::= | SEQUENCE { |
|---|---|
| servingCellId | ServCellIndex |
| OPTIONAL, -- Need S | |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

With reference to the spatialRelationInfo configuration, an SS/PBCH block index (or SS block (SSB)), a CSI-RS index, or an SRS index may be configured as an index of a reference signal to be referred to, so as to use beam information of a specific reference signal. Higher layer signaling, referenceSignal, is configuration information indicating beam information of which reference signal is to be referred to for corresponding SRS transmission, and ssb-Index denotes an index of a SS/PBCH block, csi-RS-Index denotes an index of CSI-RS, and srs denotes an index of SRS, respectively. If a value of the higher layer signaling referenceSignal is configured to be ‘ssb-Index’, the UE may apply a reception beam used when an SS/PBCH block corresponding to the ssb-Index is received, as a transmission beam of the corresponding SRS transmission. If the value of the higher layer signaling referenceSignal is configured to be ‘csi-RS-Index’, the UE may apply a reception beam used when CSI-RS corresponding to the csi-RS-Index is received, as a transmission beam of the corresponding SRS transmission. If the value of the higher layer signaling referenceSignal is configured to be ‘srs’, the UE may apply a transmission beam used when SRS corresponding to the srs is transmitted, as a transmission beam of the corresponding SRS transmission.

### Sounding Reference Signal (SRS) Transmission Power

As an embodiment of the disclosure, a method will be described in which in case of transmitting a UL SRS in response to a power control command received from a BS, the UE configures and transmits the transmission power of the UL reference signal. With the SRS power control adjustment state corresponding to the i-th transmission unit and the closed-loop index l, the UL reference signal transmission power (P_{SRS}) of the UE may be determined as shown in Equation (7) below, expressed in dBm units. In Equation (7), in case that the UE supports a plurality of carrier frequencies in a plurality of cells, each parameter may be set for cell c, carrier frequency f, and BWP b, and each parameter may be identified by indices b, f, and c.

$${P}_{SRS , b , f , c} ( i , {q}_{s} , l ) = min \{ \begin{matrix}{P}_{CMAX , f , c} ( i ) , \\ \begin{matrix}{P}_{0 \_ SRS , b , f , c} ( {q}_{s} ) + 10 {log}_{10} ( {2}^{μ} * {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ] \qquad ( 7 )$$

In Equation (7), P_{CMAX,f,c} (i) is the maximum transmission power available to the UE in the i-th transmission unit and is determined by the power level of the UE, the parameters activated by the BS, and various parameters embedded in the UE.

P_{0_SRS,b,f,c} (qₛ) is configured by p0, which is higher layer signaling, for BWP b, carrier frequency f, and cell c, and the SRS resource set qₛ may be configured through SRS-ResourceSet and SRS-ResourceSetId, which are higher layer signaling.

μ: subcarrier spacing configuration values

M_{SRS,b,f,c} (i) may indicate a resource amount (e.g., the number of RBs used for SRS transmission in the frequency axis) used in the i-th SRS transmission unit.

α_{SRS,b,f,c} (j) is configured by alpha, which is higher layer signaling, for BWP b, carrier frequency f, and cell c, and the SRS resource set qₛ may be configured by SRS-ResourceSet and SRS-ResourceSetId, which are higher layer signaling.

PL_{b,f,c} (q_{d}) is a PL between the BS and the UE, and the UE may calculate a PL from a difference between the transmission power of the reference signal (RS) resource q_{d} signaled by the BS and the UE reception signal level of a reference signal.

h_{b,f,c} (i, l) may refer to an SRS power control adjustment state value for the i-th SRS transmission unit corresponding to closed-loop index/in a BWP b, a carrier frequency f, and a cell C.

The SRS power control adjustment state may be determined by the BWP b, carrier frequency f, and cell c, and the i-th transmission unit.

In case that the UE is configured to have the same power control adjustment state value between SRS transmission and PUSCH transmission by srs-PowerControlAdjustmentStates that is higher layer signaling, the SRS power control adjustment state may be represented in Equation (8) below, wherein f_{b,f,c} (i, l) may represent the current PUSCH power control adjustment state. In this case, f_{b,f,c} (i, l) can be calculated by the various methods of the above-described embodiment 1, and the value can be replaced with h_{b,f,c} (i, l) for use

$${h}_{b , f , c} ( i , l ) = {f}_{b , f , c} ( i , l ) \qquad ( 8 )$$

In case that the UE is not configured for PUSCH transmission with BWP b, carrier frequency f, and cell c, or is configured by srs-PowerControlAdjustmentStates that is higher layer signaling with separate power control adjustment state values between SRS transmission and PUSCH transmission, and tpc-accounting, which is higher layer signaling, is not configured, the SRS power control adjustment state may be represented as in Equation (9) below, regardless of the closed-loop l.

$${h}_{b , f , c} ( i ) = {h}_{b , f , c} ( i - {i}_{0} ) + {Σ}_{m = 0}^{c ( {S}_{i} ) - 1} {δ}_{SRS , b , f , c} ( m ) \qquad ( 9 )$$

In Equation (9), δ_{SRS,b,f,c} (m) is a value indicated by the TPC command field included in the DCI format 2_3, and its value may follow the above Table 17.

Σₘ₌₀^{c(S}^{ᵢ}⁾⁻¹δ_{SRS,b,f,c} (m) may refer to the sum of the above TPC command values δ_{SRS,b,f,c} for all transmission units belonging to a particular set Sᵢ. Here, c(Sᵢ) may indicate the number of all elements belonging to the set Sᵢ. Sᵢ may refer to a set of DCIs including all TPC command values to perform a TPC command accumulation operation for the i-th PUSCH transmission unit. To determine Sᵢ, a start and end point may be defined in a time dimension, and all DCIs received by the UE between the two points may be included as elements of Sᵢ.

The end point for determining Sᵢ may be a point before the K_{SRS}(i) symbol from the start symbol of the i-th SRS transmission unit.

The starting point for determining Sᵢ may be a point before the K_{SRS} (i−i₀)−1 symbol from the start symbol of the i−i₀ th SRS transmission unit. The positive integer i₀ may be determined as a minimum value that satisfies that a point in time before the K_{SRS} (i−i₀) symbol from the start symbol of the i−i₀ th SRS transmission unit to be earlier in time than the end point at which Sᵢ is determined (the point before the K_{SRS} (i) symbol from the start symbol of the i-th SRS transmission unit).

For example, in case that sym(i) may define the end point for determining Sᵢ, and sym(i−i₀) may define the time point before the K_{SRS} (i−i₀) symbol from the start symbol of the i−i₀ th SRS transmission unit, i₀ may be determined as 2 in case of sym(i)=sym(i−1)>sym(i−2)>sym(i−3).

In case that the UE is not configured for PUSCH transmission with BWP b, carrier frequency f and cell c, or is configured by srs-PowerControlAdjustmentStates that is higher layer signaling to have a separate power control adjustment state value between SRS transmission and PUSCH transmission, and tpc-Accumulation, which is higher layer signaling, is configured (i.e., TPC command accumulation operation cannot be performed and absolute TPC command value can be applied), the SRS power control adjustment state can be expressed as in Equation (10) below, regardless of the closed-loop l.

$${h}_{b , f , c} ( i ) = {δ}_{S R S , b , f , c} ( i ) \qquad ( 10 )$$

In Equation (10), δ_{SRS,b,f,c} (i) may be a value indicated by a TPC command field included in the DCI format 2_3 having the BWP b, the carrier frequency f, and in the cell c as described above, and the value thereof may follow the above Table 18. For example, in case that the value of the TPC command field is 0, δ_{SRS,b,f,c} may have a value of −4 dB.

### UE Capability Report

In LTE and NR, a UE may perform a procedure in which, while being connected to a serving BS, the UE reports capability supported by the UE to the corresponding BS, referred to herein as a UE capability report.

The BS may transfer a UE capability enquiry message to the UE in a connected state so as to request a capability report. The message may include a UE capability request with regard to each radio access technology (RAT) type of the BS. The request for each RAT type may include supported frequency band combination information and the like. In addition, when the UE capability inquiry message, UE capability with regard to a plurality of RAT types may be requested through one RRC message container transmitted by the BS, or the BS may transfer a UE capability inquiry message including a plurality of UE capability requests with regard to respective RAT types. That is, the UE capability inquiry may be repeated multiple times within a single message, and may configure a UE capability information message corresponding thereto and report it multiple times. In next-generation mobile communication systems, a UE capability request may be made regarding multi-RAT dual connectivity (MR-DC), such as NR, LTE, E-UTRA-NR dual connectivity (EN-DC). In addition, the UE capability inquiry message is transmitted initially after the UE is connected to the BS, in general, but may be requested in any condition if needed by the BS.

Upon receiving the UE capability report request from the BS in the above stage, the UE configures UE capability according to band information and RAT type as may be required by the BS. The method in which the UE configures UE capability in an NR system is summarized below.

1 If the UE receives a list regarding LTE and/or NR bands from the BS at a UE capability request, the UE configures band combinations (BCs) regarding EN-DC and NR standalone (SA). That is, the UE configures a candidate list of BCs regarding EN-DC and NR SA, based on bands received from the BS at a request through FreqBandList. In addition, bands have priority in the order described in FreqBandList.

2 If the BS has set eutra-nr-only flag or eutra flag and requested a UE capability report, the UE removes everything related to NR SA BCs from the configured BC candidate list. Such an operation may occur only in case that an LTE BS (eNB) requests eutra capability.

3. The UE then removes fallback BCs from the BC candidate list configured in the above stage. As used herein, a fallback BC refers to a BC that may be obtained by removing a band corresponding to at least one SCell from a certain BC, and since a BC before removal of the band corresponding to at least one SCell may already cover a fallback BC, the same may be omitted. This stage is applied in MR-DC as well, that is, LTE bands are also applied. BCs remaining after this stage configure the final candidate BC list.

4. The UE selects BCs appropriate for the requested RAT type from the final candidate BC list and selects BCs to report. In this stage, the UE configures supportedBandCombinationList in a determined order. That is, the UE configures BCs and UE capability to report according to a preconfigured rat-Type order (nr→eutra-nr→eutra). In addition, the UE configures featureSetCombination regarding the configured supportedBandCombinationList and configures a list of candidate feature set combinations from a candidate BC list from which a list regarding fallback BCs (including capability of the same or lower step) is removed. The candidate feature set combinations include all feature set combinations regarding NR and EUTRA-NR BCs, and are obtainable from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the BS. The BS performs scheduling and transmission/reception management appropriate for the corresponding UE, based on the UE capability received from the UE.

### Non-Coherent Joint Transmission (NC-JT

The NC-JT may be used for the UE to receive PDSCHs from multiple TRPs.

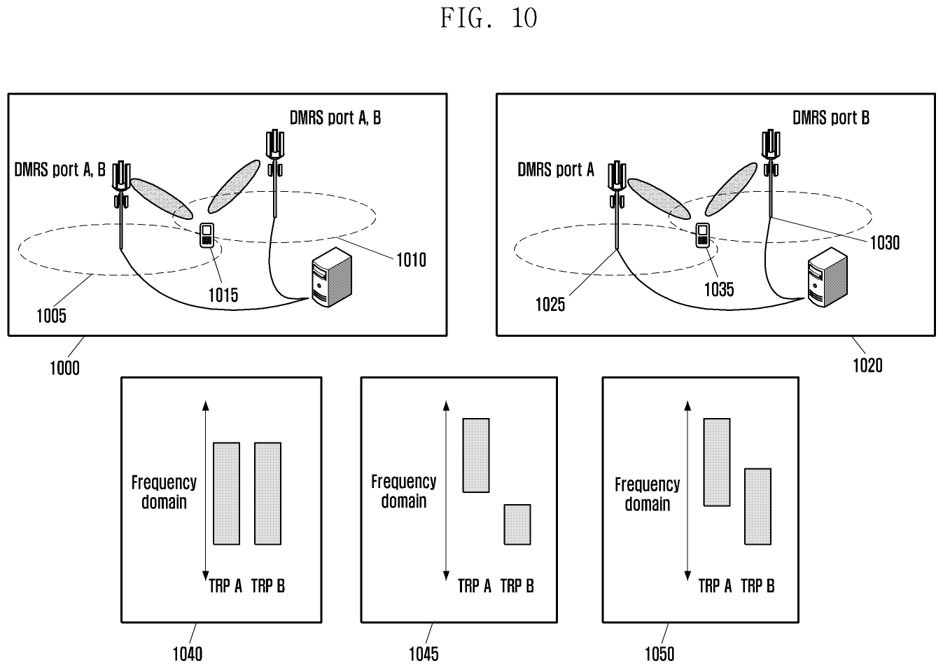

FIG. 10 illustrates antenna port configuration and resource allocation for transmitting a PDSCH using cooperative communication in a wireless communication system according to an embodiment.

Referring to FIG. 10, examples of PDSCH transmission are described according to techniques of joint transmission (JT), and examples of allocating radio resources for each TRP are illustrated.

Referring to FIG. 10, an example 1000 of coherent joint transmission (C-JT) supporting coherent precoding between cells, TRPs and/or beams is illustrated.

When C-JT, TRP A 1005 and TRP B 1010 may transmit a single piece of data on a PDSCH to a UE 1015, and multiple TRPs may perform joint precoding. This may indicate that a DMRS are transmitted through the same DMRS ports so that TRP A 1005 and TRP B 1010 transmit the same PDSCH. For example, TRP A 1005 and TRP B 1010 may transmit the DRMS to the UE through DMRS port A and DMRS port B. In this case, the UE may receive one piece of DCI information for receiving one PDSCH demodulated based on the DMRS transmitted through DMRS port A and DMRS port B.

FIG. 10 shows an example 1020 of non-coherent joint transmission (NC-JT) supporting non-coherent precoding between cells, TRPs, and/or beams for PDSCH transmission.

When NC-JT, each cell, TRP, and/or beam may transmit a PDSCH to the UE 1035, and individual precoding may be applied to each PDSCH. The respective cells, TRPs, and/or beams may transmit different PDSCHs or different PDSCH layers to the UE, thereby improving throughput, compared to single-cell, TRP, and/or beam transmission. In addition, it is possible to improve reliability, compared to single-cell, TRP, and/or beam transmission, by repeatedly transmitting the same PDSCH to the UE by the respective cells, TRPs, and/or beams. For convenience of description, the cell, the TRP, and/or the beam is hereinafter collectively referred to as a TRP.

Various radio resource allocation cases may be considered, such as when the frequency and time resources used by a plurality of TRPs for PDSCH transmission are all the same (1040), when the frequency and time resources used by a plurality of TRPs do not overlap at all (1045), and when the frequency and time resources used by the plurality of TRPs partially overlap (1050).

For support of NC-JT, to allocate a plurality of PDSCHs to one UE at the same time, DCI of various types, structures, and relationships may be considered.

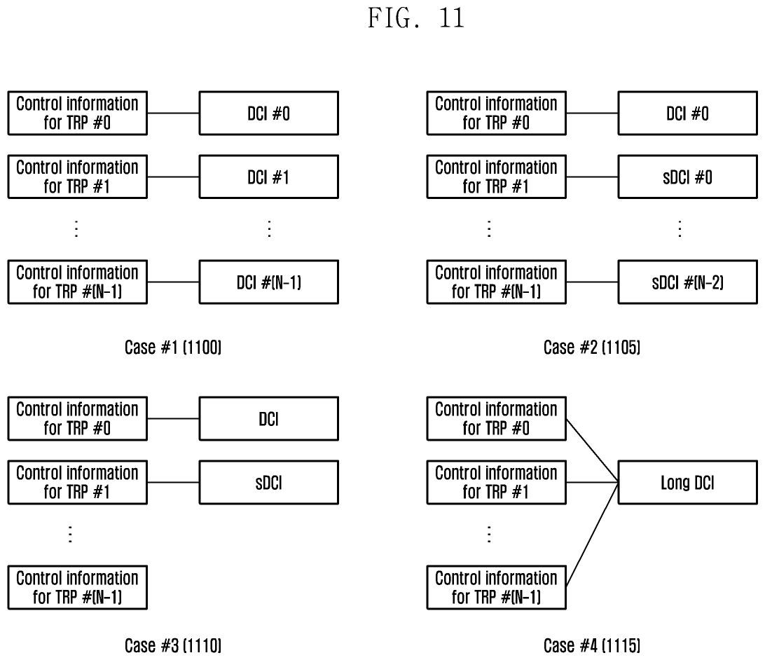

FIG. 11 illustrates a configuration of DCI for NC-JT in which respective TRPs transmit different PDSCHs or different PDSCH layers to a UE in a wireless communication system according to an embodiment.

Referring to FIG. 11, Case #1 1100 is an example in which when (N−1) different PDSCHs are transmitted from (N−1) additional TRPs (TRP #1 to TRP #(N−1)) in addition to a serving TRP (TRP #0) used in single PDSCH transmission, control information about the PDSCHs transmitted from the (N−1) additional TRPs is transmitted independently of control information about the PDSCH transmitted from the serving TRP. That is, the UE may obtain control information about the PDSCHs transmitted from different TRPs (TRP #0 to TRP #(N−1)) through independent DCI (DCI #0 to DC1 #(N−1)). The formats of the independent DCI may be the same or different from each other, and the payloads of the DCI may also be the same or different from each other. In Case #1 described above, although control or allocation freedom of respective PDSCHs may be completely guaranteed, transmission of each DCI from different TRPs may cause a difference in coverage between DCI, thereby degrading the reception performance.

Case #2 1105 shows an example in which when (N−1) different PDSCHs are transmitted from (N−1) additional TRPs (TRP #1 to TRP #(N−1)) in addition to a serving TRP (TRP #0) used in single PDSCH transmission, control information (DCI) about the PDSCHs of the (N−1) additional TRPs is transmitted, respectively, and the DCI thereof is dependent on control information about the PDSCH transmitted from the serving TRP.

For example, although DCI #0, which is control information about the PDSCH transmitted from the serving TRP (TRP #0), may include all information elements of DCI format 1_0, DCI format 1_1, and DCI format 1_2, shortened DCI (hereinafter, sDCI) (sDCI #0 to sDCI #(N−2)), which is control information about the PDSCHs transmitted from the cooperative TRPs (TRP #1 to TRP #(N−1)), may include some of the information elements of DCI format 1_0, DCI format 1_1, and DCI format 1_2. Accordingly, sDCI transmitting control information about the PDSCHs transmitted from the cooperative TRPs has a smaller payload than normal DCI (nDCI) transmitting control information related to the PDSCH transmitted from the serving TRP, so sDCI may include reserved bits, compared to nDCI.

In Case #2 described above, although control or allocation freedom of respective PDSCHs may be restricted depending on the content of information elements included in sDCI, the reception performance of sDCI is superior to that of nDCI, thereby reducing the probability of occurrence of a coverage difference between respective DCI.

Case #3 1110 shows an example in which when (n−1) different PDSCHs are transmitted from (N−1) additional TRPs (TRP #1 to TRP #(N−1)) in addition to a serving TRP (TRP #0) used in single PDSCH transmission, a single piece of control information about the PDSCHs of the (N−1) additional TRPs is transmitted, respectively, and the DCI thereof is dependent on control information about the PDSCH transmitted from the serving TRP.

For example, DCI #0, which is control information about the PDSCH transmitted from the serving TRP (TRP #0), may include all information elements of DCI format 1_0, DCI format 1_1, and DCI format 1_2, and when control information about the PDSCHs transmitted from the cooperative TRPs (TRP #1 to TRP #(N−1)), some of the information elements of DCI format 1_0, DCI format 1_1, and DCI format 1_2 may be collected in one piece of ‘secondary’ DCI (sDCI) and transmitted. For example, sDCI may include at least one piece of information among HARQ-related information, such as frequency domain resource assignment, time domain resource assignment, and MCS of the cooperative TRPs. In addition, information, which is not included in sDCI, such as a BWP (BWP) indicator, a carrier indicator, or the like, may follow DCI (DCI #0, normal DCI, nDCI) of the serving TRP.

In Case #3 1110, although control or allocation freedom of respective PDSCHs may be restricted depending on the content of information elements included in sDCI, it is possible to control the reception performance of sDCI, and the DCI blind decoding complexity of the UE may be reduced, compared to Case #1 1100 or Case #2 1105.

Case #4 1115 shows an example in which when (N−1) different PDSCHs are transmitted from (N−1) additional TRPs (TRP #1 to TRP #(N−1)) in addition to a serving TRP (TRP #0) used in single PDSCH transmission, control information about the PDSCHs transmitted from the (N−1) additional TRPs are transmitted in the same DCI (long DCI) as control information about the PDSCH transmitted from the serving TRP. That is, the UE may obtain control information about the PDSCHs transmitted from different TRPs (TRP #0 to TRP #(N−1)) through a single piece of DCI. When Case #4 1115, although the DCI blind decoding complexity of the UE may not increase, control or allocation freedom of PDSCHs may be lowered such that the number of cooperative TRPs may be restricted according to restriction of a long DCI payload and the like.

In the following description and embodiments, sDCI may refer to various auxiliary DCIs, such as shortened DCI, secondary DCI, or normal DCI (DCI formats 1_0 to 1_1 described above) including PDSCH control information transmitted from the cooperative TRPs, and a description thereof may be applied to various auxiliary DCIs in a similar manner in case that specific restrictions are not specified.

In the following description and embodiments, Case #1 1100, Case #2 1105, and Case #3 1110 described above in which one or more PDCCHs are used to support NC-JT will be differentiated as multiple PDCCH-based NC-JT, and Case #4 1115 described above in which a single PDCCH is used to support NC-JT will be differentiated as single PDCCH-based NC-JT. In the multiple PDCCH-based PDSCH transmission, the CORESET in which DCI of the serving TRP (TRP #0) is scheduled may be differentiated from the CORESET in which DCI of the cooperative TRPs (TRP #1 to TRP #(N−1)) is scheduled. As a method for differentiating the CORESETs, a method for differentiating the CORESETs through a higher layer indicator for each CORESET, a method for differentiating the CORESETs through beam configuration for each CORESET, and the like may be provided. In addition, in the single PDCCH-based NC-JT, a single piece of DCI may schedule a single PDSCH having a plurality of layers, instead of scheduling a plurality of PDSCHs, and the plurality of layers described above may be transmitted from a plurality of TRPs. In this case, a connection relationship between a layer and a TRP transmitting the corresponding layer may be indicated through a transmission configuration indicator (TCI) for a layer.

Cooperative TRP in the embodiments of the disclosure may be replaced with various terms such as cooperative panel or cooperative beam when applied in practice.

In the embodiments of the disclosure, although the case to which NC-JT is applied may be variously interpreted depending on the situation, such as when the UE simultaneously receives one or more PDSCHs in one BWP, when the UE simultaneously receives PDSCHs, based on two or more transmission configuration (TCI) indicators in one BWP, when the PDSCH received by the UE is associated with one or more DMRS port groups, and the like, one expression is used for convenience.

In the disclosure, the wireless protocol structure for NC-JT may be used in various ways according to the TRP deployment scenario. For example, in case that there is no or small backhaul delay between the cooperative TRPs, a method using the structure based on MAC layer multiplexing (a CA-like method), similarly to S10 in FIG. 4, is possible. On the other hand, in case that the backhaul delay between the cooperative TRPs is too large to ignore (e.g., when information exchange of CSI, scheduling, HARQ-ACK, etc. between the cooperative TRPs requires a time of 2 ms or more), a method for securing a characteristic resistant to delay using an independent structure for each TRP from the RLC layer (a DC-like method), similarly to S20 in FIG. 4, is possible.

The UE supporting C-JT and/or NC-JT may receive C-JT and/or NC-JT-related parameters or setting values and the like from the higher layer configuration and set RRC parameters of the UE, based on the same. The UE may utilize UE capability parameters, for example, tci-StatePDSCH, for the higher layer configuration. The UE capability parameter, for example, tci-StatePDSCH, may define the TCI states for PDSCH transmission, and the number of TCI states may be configured as 4, 8, 16, 32, 64, and 128 in FR1 and as 64 and 128 in FR2, and up to 8 states that may be indicated by 3 bits of TCI field in DCI through a MAC CE message may be configured, among the configured numbers. The maximum value 128 indicates the value indicated by max NumberConfiguredTCIstatesPerCC in the parameters tci-StatePDSCH included in the UE capability signaling. As described above, a series of configuration procedures from the higher layer configuration to the MAC CE configuration may be applied to beamforming indication or beamforming switching command for at least one PDSCH in one TRP.

### Multi-DCI-Based Multi-TRP

A multi-DCI-based multi-TRP transmission method will be described. In the multi-DCI-based multi-TRP transmission method, a DL control channel for NC-JT transmission may be configured based on multiple PDCCHs.

NC-JT based on multiple PDCCHs may have CORESETs or search spaces divided for each TRP when transmitting DCI for scheduling PDSCHs of the respective TRPs. The CORESET or search space for each TRP may be configured as at least one of the following cases.

Higher layer index configuration for each CORESET: CORESET configuration information configured by a higher layer may include an index value, and the TRP transmitting a PDCCH in the corresponding CORESET may be differentiated by the index value configured for each CORESET. That is, a set of CORESETs having the same higher layer index value may be considered that the same TRP transmits a PDCCH or that a PDCCH scheduling the PDSCH of the same TRP is transmitted. The index value for each CORESET described above may be referred to as CORESETPoolIndex, and a PDCCH may be regarded as being transmitted from the same TRP for CORESETs in which the same value of CORESETPoolIndex is configured. When CORESET in which the value CORESETPoolIndex is not configured, it may be considered that a default value of CORESETPool Index is configured, and the above-described default value may be 0.

When the number of types of CORESETPoolIndex provided in each of the plurality of CORESETs included in PDCCH-Config, which is the higher layer signaling, exceeds one, that is, in case that the respective CORESETs have different CORESETPoolIndex values, the UE may consider that the BS may use a multi-DCI-based multi-TRP transmission method.

Alternatively, in the disclosure, if the number of types of CORESETPoolIndex provided in each of the plurality of CORESETs included in PDCCH-Config, which is the higher layer signaling, is one, that is, in case that all the CORESETs have the same CORESETPoolIndex of 0 or 1, the UE may consider that the BS performs transmission using a single TRP, instead of using the multi-DCI-based multi-TRP transmission method.

Multi-PDCCH-Config configuration: a plurality of PDCCH-Configs may be configured in one BWP, and each PDCCH-Config may include PDCCH configuration for each TRP. That is, a list of CORESETs for each TRP and/or a list of search spaces for each TRP may be configured in one PDCCH-Config, and one or more CORESETs and one or more search spaces included in one PDCCH-Config may be regarded as corresponding to a specific TRP.

CORESET beam/beam group configuration: A TRP corresponding to the corresponding CORESET may be differentiated through a beam or a beam group configured for each CORESET. For example, in case that the same TCI state is configured in a plurality of CORESETs, the corresponding CORESETs may be regarded as being transmitted through the same TRP, or the PDCCH scheduling a PDSCH of the same TRP may be regarded as being transmitted from the corresponding CORESET.

Search space beam/beam group configuration: A beam or beam group may be configured for each search space, and TRPs may be differentiated for the respective search spaces through the same. For example, in case that the same beam/beam group or TCI state is configured in a plurality of search spaces, it may be considered that the same TRP transmits a PDCCH in the corresponding search space or that the PDCCH scheduling a PDSCH of the same TRP is transmitted in the corresponding search space.

By differentiating CORESETs or search spaces for respective TRPs as described above, PDSCHs and HARQ-ACK information may be classified for each TRP, and thus it is possible to independently produce HARQ-ACK codebooks and to independently use PUCCH resources for each TRP.

The above configuration may be independent for each cell or each BWP. For example, while two different CORESETPoolIndex values may be configured in the PCell, the CORESETPoolIndex value may not be configured in a specific SCell. In this case, it may be considered that NC-JT transmission is configured in the PCell, whereas NC-JT transmission is not configured in the SCell in which the CORESETPoolIndex value is not configured.

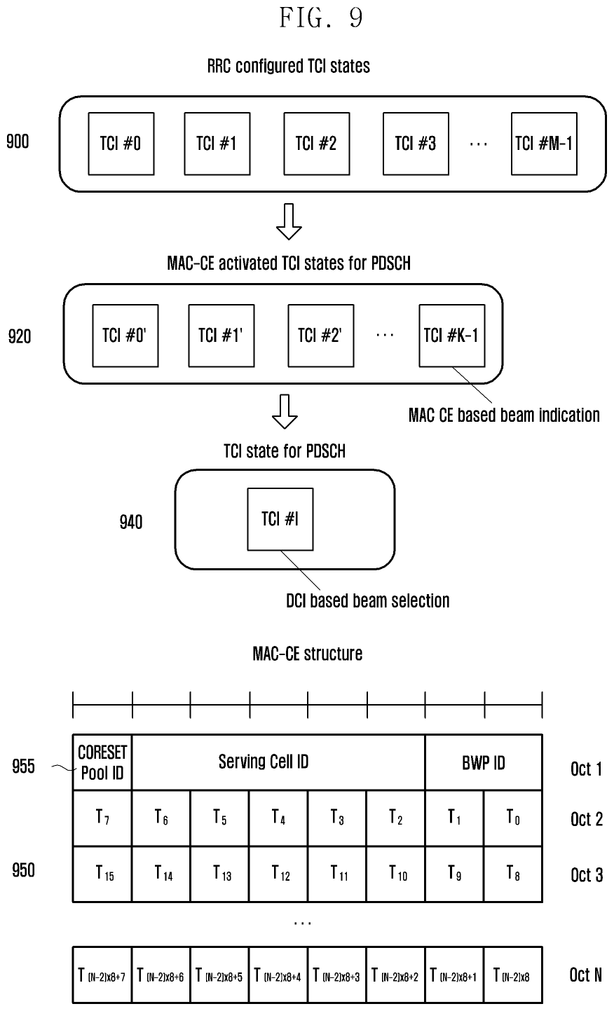

A PDSCH TCI state activation/deactivation MAC-CE applicable to the multi-DCI-based multi-TRP transmission method may follow FIG. 9 above. In case that CORESETPoolIndex is not configured in each of all CORESETs in PDCCH-Config, which is the higher layer signaling, for the UE, the UE may ignore the CORESET Pool ID field 955 in the corresponding MAC-CE 950. In case that the UE is able to support the multi-DCI-based multi-TRP transmission method, that is, in case that the UE has different CORESETPoolIndex values for the respective CORESETs in PDCCH-Config that is the higher layer signaling, the UE may activate the TCI state in DCI included in the PDCCHs transmitted from the CORESETs having the same CORESETPoolIndex value as the CORESET Pool ID field 955 value in the corresponding MAC-CE 950. For example, if the value of the CORESET Pool ID field 955 in the corresponding MAC-CE 950 is 0, the TCI state in DCI included in the PDCCHs transmitted from the CORESETs having a CORESETPoolIndex value of 0 may follow activation information of the corresponding MAC-CE.

In case that the UE is configured to use the multi-DCI-based multi-TRP transmission method from the BS, that is, in case that the number of types of CORESETPoolIndex of each of the plurality of CORESETs included in PDCCH-Config, which is the higher layer signaling, exceeds one, or in case that the respective CORESETs have different CORESETPoolIndex values, the UE may recognize the following restrictions for PDSCHs scheduled from the PDCCHs in the respective CORESETs having two different CORESETPoolIndex values.

1) In case that PDSCHs indicated by the PDCCHs in the respective CORESETs having two different CORESETPoolIndex values entirely or partially overlap, the UE may apply the TCI states indicated by the respective PDCCHs to different CDM groups. That is, two or more TCI states may not be applied to one CDM group.

2) In case that PDSCHs indicated by the PDCCHs in the respective CORESETs having two different CORESETPoolIndex values entirely or partially overlap, the UE may expect that the actual number of front loaded DMRS symbols, the actual number of additional DMRS symbols, the actual positions of the DMRS symbols, the DMRS types of the PDSCHs will not be different from each other.

3) The UE may expect that the BWPs indicated from the PDCCHs in the respective CORESETs having two different CORESETPoolIndex values will be the same and that the subcarrier spacings thereof will also be the same.

4) The UE may expect that the respective PDCCHs will completely include information about the PDSCHs scheduled from the PDCCHs in the respective CORESETs having two different CORESETPoolIndex values.

### [Single-DCI-Based Multi-TRP]

As an embodiment of the disclosure, a single-DCI-based multi-TRP transmission method will be described. The single-DCI-based multi-TRP transmission method may configure a DL control channel for NC-JT transmission, based on a single PDCCH.

In the single-DCI-based multi-TRP transmission method, PDSCHs transmitted by a plurality of TRPs may be scheduled with one DCI. In this case, the number of TCI states may be used as a method for indicating the number of TRPs transmitting the corresponding PDSCH. That is, if the number of TCI states indicated in DCI scheduling the PDSCH is two, it may be regarded as single-PDCCH-based NC-JT transmission, and if the number of TCI states is one, it may be regarded as single-TRP transmission. The above TCI states indicated in DCI may correspond to one or two TCI states among the TCI states activated by a MAC-CE. In when the TCI states of DCI correspond to two TCI states activated by a MAC-CE, a correspondence relationship between the TCI codepoint indicated in the DCI and the TCI states activated by the MAC-CE may be established, which may be the case there may be two TCI states activated by the MAC-CE, which correspond to the TCI codepoint.

Alternatively, in case that at least one codepoint among all the codepoints of a TCI state field in DCI indicates two TCI states, the UE may consider that the BS may perform transmission based on the single-DCI-based multi-TRP method. In this case, at least one codepoint indicating two TCI states in the TCI state field may be activated through an enhanced PDSCH TCI state activation/deactivation MAC-CE.

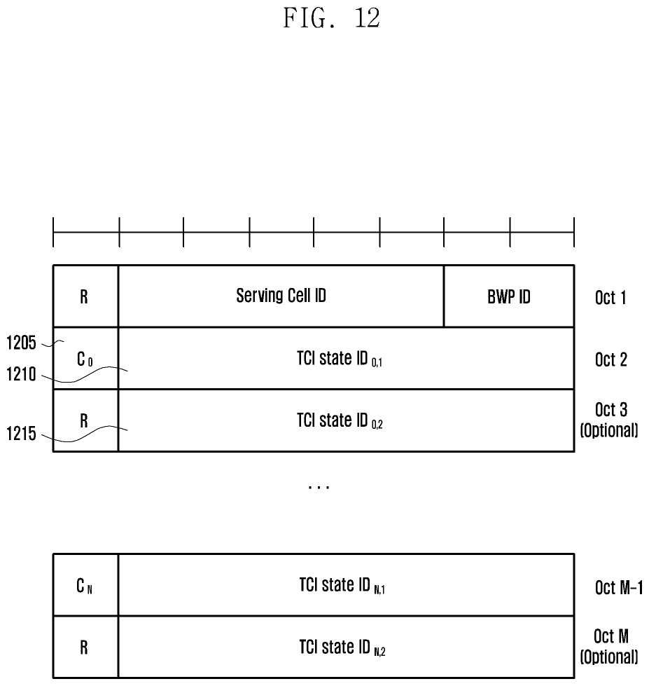

FIG. 12 illustrates an enhanced PDSCH TCI state activation/deactivation MAC-CE structure. Meanings of respective fields in the corresponding MAC CE and configurable values for the respective fields are shown in Table 21 below.

```
TABLE 16
  - Serving Cell ID: This field indicates the identity of the Serving Cell for which the
MAC CE applies. The length of the field is 5 bits. If the indicated Serving Cell is configured
as part of a simultaneousTCI-UpdateList1 or simultaneousTCI-UpdateList2 as specified in
TS 38.331 [5], this MAC CE applies to all the Serving Cells configured in the set
simultaneousTCI-UpdateList1 or simultaneousTCI-UpdateList2, respectively;
  - BWP ID: This field indicates a DL BWP for which the MAC CE applies as the
codepoint of the DCI BWP indicator field as specified in TS 38.212 [9]. The length of the
BWP ID field is 2 bits;
  - Cᵢ: This field indicates whether the octet containing TCI state ID_{i,2} is present. If this
field is set to 1, the octet containing TCI state ID_{i,2} is present. If this field is set to 0, the octet
containing TCI state ID_{i,2} is not present;
  - TCI state ID_{i,j}: This field indicates the TCI state identified by TCI-StateId as
specified in TS 38.331 [5], where i is the index of the codepoint of the DCI Transmission
configuration indication field as specified in TS 38.212 [9] and TCI state ID_{i,j} denotes the j-
th TCI state indicated for the i-th codepoint in the DCI Transmission Configuration
Indication field. The TCI codepoint to which the TCI States are mapped is determined by its
ordinal position among all the TCI codepoints with sets of TCI state ID_{i,j} fields, i.e. the first
TCI codepoint with TCI state ID_{0,1} and TCI state ID_{0,2} shall be mapped to the codepoint
value 0, the second TCI codepoint with TCI state ID_{1,1} and TCI state ID_{1,2} shall be mapped
to the codepoint value 1 and so on. The TCI state ID_{i,2} is optional based on the indication of
the Ci field. The maximum number of activated TCI codepoint is 8 and the maximum number
of TCI states mapped to a TCI codepoint is 2.
  - R: Reserved bit, set to 0.
```

In FIG. 12, if the value of a field C₀ 1205 is 1, a corresponding MAC-CE may include a field TCI state ID_{0,2} 1215 in addition to a field TCI state ID_{0,1} 1210. This may indicate that TCI state ID_{0,1} and TCI state ID_{0,2} are activated for the 0th codepoint of the TCI state field included in DCI, and if the BS indicates the corresponding codepoint to the UE, the UE may receive an indication of two TCI states. If the value of a field C₀ 1205 is 0, the corresponding MAC-CE may not include the field TCI state ID_{0,2} 1215, which indicates that one TCI state corresponding to TCI state ID_{0,1} is activated for the 0th codepoint of the TCI state field included in DCI.

The above configuration may be independent for each cell or each BWP. For example, there may be a maximum of two activated TCI states corresponding to one TCI codepoint in the PCell, whereas there may be a maximum of one activated TCI states corresponding to one TCI codepoint in a specific SCell. In this case, it may be considered that NC-JT transmission is configured in the PCell, whereas NC-JT transmission is not configured in the SCell described above.

### Single-DCI-Based Multi-TRP PDSCH Repetitive Transmission Technique (TDM/FDM/SDM) Distinguishing Method

The UE may be indicated with different single-DCI-based multi-TRP PDSCH repetitive transmission techniques (e.g., TDM, FDM, SDM) according to the value indicated by a DCI field and higher layer signaling configuration from the BS. Table 22 below shows a method for distinguishing between single- or multi-TRP-based schemes indicated to the UE according to the value of a specific DCI field and the higher layer signaling configuration.

TABLE 17

| | The | The | repetitionNumber | | Transmission |
|---|---|---|---|---|---|
| | number | number | configuration and | repetitionScheme | technique |
| | of TCI | of CDM | indication | configuration | indicated |
| Combination | states | groups | conditions | relationship | to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP TDM |
| | | | | not configured | scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP FDM |
| | | | | | scheme A/FDM |
| | | | | | scheme B/TDM |
| | | | | | scheme A |
| 9 | 2 | 1 | Condition 1 | Not configured | Multi-TRP TDM |
| | | | | | scheme B |

In Table 22 above, each column may be described as follows.

Number of TCI states (column 2) refers to the number of TCI states indicated by the TCI state field in DCI, and may be one or two.

Number of CDM groups (column 3) refers to the number of different CDM groups of DMRS ports indicated by an antenna port field in DCI. The number of CDM groups may be 1, 2, or 3.

repetitionNumber configuration and indication condition (column 4): Three conditions may exist according to whether repetitionNumber is configured for all TDRA entries that can be indicated by a time domain resource allocation field in DCI and whether the actually indicated TDRA entry has repetitionNumber configuration.

Condition 1: At least one of all TDRA entries that can be indicated by the time domain resource allocation field includes the configuration for repetitionNumber, and the TDRA entry indicated by the time domain resource allocation field in DCI includes configuration for repetition Number greater than 1.

Condition 2: At least one of all TDRA entries that can be indicated by the time domain resource allocation field includes the configuration for repetitionNumber, and the TDRA entry indicated by the time domain resource allocation field in DCI does not include the configuration for repetitionNumber.

Condition 3: Case where all TDRA entries that can be indicated by the time domain resource allocation field do not include configuration for repetitionNumber.

Relating to repetitionScheme configuration (column 5) refers to whether repetitionScheme, which is higher layer signaling, is configured. The repetitionScheme, which is higher layer signaling, may be configured with one of ‘tdmSchemeA’, ‘fdmSchemeA’, and ‘fdmSchemeB’.

Transmission technique indicated to the UE (column 6) refers to single or multiple TRP techniques indicated according to each combination (column 1) shown in Table 22 above.

Single-TRP refers to single TRP-based PDSCH transmission. If the UE is configured with the pdsch-AggregationFactor in PDSCH-config that is the higher layer signaling, the UE may receive scheduling for single TRP-based PDSCH repetitive transmission by the configured number of times. Otherwise, the UE may receive scheduling for single TRP-based PDSCH single transmission.

Single-TRP TDM scheme B refers to single TRP-based inter-slot time resource division-based PDSCH repetitive transmission. According to the above-described repetitionNumber-related Condition 1, the UE repeatedly transmits the PDSCH in the time dimension as many times as the number of slots, having the repetitionNumber having the value greater than 1, configured in the TDRA entry indicated by the time domain resource allocation field. The same start symbol and symbol length of the PDSCH indicated by the TDRA entry are applied to each slot equal to the number of repetitionNumber, and the same TCI state is applied to each PDSCH repetitive transmission. The corresponding technique is similar to a slot aggregation scheme in that an inter-slot PDSCH repetitive transmission is performed on time resources, but is different from slot aggregation in that it is possible to dynamically determine whether to indicate repetitive transmission based on the time domain resource allocation field in DCI.

Multi-TRP SDM refers to a multi-TRP-based spatial resource division PDSCH transmission scheme. This is a method for performing reception from each TRP by dividing layers. Although the multi-TRP SDM is not a repetitive transmission scheme, it is possible to increase the number of layers and lower the coding rate to transmit, so as to increase the reliability of the PDSCH transmission. The UE may receive the PDSCH by applying the two TCI states indicated through the TCI state field in DCI to two CDM groups indicated by the BS, respectively. Multi-TRP FDM scheme A refers to a multi-TRP-based frequency resource division PDSCH transmission scheme, and has one PDSCH transmission occasion, so that it is not possible to perform repetitive transmission like multi-TRP SDM, but to perform transmission with high reliability by increasing the frequency resource amount and lowering the coding rate. The multi-TRP FDM scheme A may respectively apply two TCI states, indicated through the TCI state field in DCI, to frequency resources that do not overlap each other. If the PRB bundling size is determined to be wideband, the UE performs reception by applying the first TCI state to the first ceil (N/2) RBs and applying the second TCI state to the remaining floor (N/2) RBs, in case that the number of RBs indicated by the frequency domain resource allocation field is N. The ceil(·) and the floor(·) are operators for rounding up and rounding down the first digit after decimal point. If the PRB bundling size is determined to be 2 or 4, the UE performs reception by applying the first TCI state to even-numbered PRGs and applying the second TCI state to odd-numbered PRGs.

* Multi-TRP FDM scheme B refers to a multi-TRP-based frequency resource division PDSCH repetitive transmission scheme, and has two PDSCH transmission occasions, so that the PDSCH can be repeatedly transmitted to each occasion. Multi-TRP FDM scheme B may also apply two TCI states, indicated through the TCI state field in DCI, to frequency resources that do not overlap each other, in the same manner as the multi-TRP FDM scheme A. If the PRB bundling size is determined to be wideband, the UE performs reception by applying the first TCI state to the first ceil (N/2) RBs and applying the second TCI state to the remaining floor (N/2) RBs, in case that the number of RBs indicated by the frequency domain resource allocation field is N. Here, ceil(·) and floor(·) are operators for rounding up and rounding down the first digit after decimal point. In case that the PRB bundling size is determined to be 2 or 4, the UE performs reception by applying the first TCI state to even-numbered PRGs and applying the second TCI state to odd-numbered PRGs.

Multi-TRP TDM scheme A refers to a multi-TRP-based time resource division intra-slot PDSCH repetitive transmission scheme. The UE includes two PDSCH transmission occasions in one slot, and the first reception occasion may be determined based on the start symbol and symbol length of a PDSCH indicated through the time domain resource allocation field in DCI. The start symbol of the second reception occasion of the PDSCH may be an occasion to which as many symbol offsets as StartingSymbolOffsetK, which is higher layer signaling, are applied from the last symbol of the first transmission occasion, and the transmission occasion may be determined by the indicated symbol length therefrom. If StartingSymbolOffsetK, which is higher layer signaling, is not configured, the symbol offset may be regarded as 0.

Multi-TRP TDM scheme B refers to a multi-TRP-based time resource division inter-slot PDSCH repetitive transmission scheme. The UE includes one PDSCH transmission occasion in one slot, and may receive repetitive transmission based on the start symbol and symbol length of the same PDSCH during a slot equal to the number of repetitionNumber indicated through the time domain resource allocation field in DCI. If repetitionNumber is 2, the UE may receive PDSCH repetitive transmissions in the first and second slots by applying the first and second TCI states, respectively. If repetitionNumber is greater than 2, the UE may use different TCI state application schemes according to which tciMapping, which is the higher layer signaling, is configured. In case that tciMapping is configured as cyclicMapping, the first and second TCI states are applied to the first and second PDSCH transmission occasions, respectively, and this TCI state application method is equally applied to the remaining PDSCH transmission occasions. In case that tciMapping is configured as sequentialMapping, the first TCI state is applied to the first and second PDSCH transmission occasions, the second TCI state is applied to the third and fourth PDSCH transmission occasions, and this TCI state application method is equally applied to the remaining PDSCH transmission occasions.

Herein, the UE may determine whether to apply cooperative communication using various methods such as applying a specific format to PDCCH(s) for allocating a PDSCH to which the cooperative communication is applied, including a specific indicator indicating whether the PDCCH(s) for allocating the PDSCH to which the cooperative communication is applied applies the cooperative communication, scrambling the PDCCH(s) for allocating the PDSCH to which the cooperative communication is applied with a specific RNTI, or assuming the cooperative communication applied in a specific interval indicated by a higher layer. Receiving at the UE the PDSCH to which the cooperative communication is applied based on the above similar conditions may be referred to as an NC-JT case to ease the description.

### First Embodiment: Transmission Power Parameter Configuration Method in Supporting a Unified TCI State

As an embodiment of the disclosure, a method for configuring a transmission power parameter in case that a UE supports a unified TCI state is described. This embodiment may be operated in combination with other embodiments.

A UE may be configured to ServingCellConfig, which is higher layer signaling, from a BS, and additionally, the UE may be configured to MIMOParam-r17, which is higher layer signaling within ServingCellConfig. The specific higher layer signaling structures of ServingCellConfig and MIMOParam-r17 may be as shown in Table 23 below.

TABLE 18

| | |
|---|---|
| ServingCellConfig ::= | SEQUENCE { |

...
pathlossReferenceLinking ENUMERATED {spCell, sCell} OPTIONAL, -- Cond SCellOnly

| | |
|---|---|
| mimoParam-r17 | SetupRelease {MIMOParam-r17} |

OPTIONAL, -- Need M
...
}
MIMOParam-r17 ::= SEQUENCE {

| | |
|---|---|
| additionalPCI-ToAddModList-r17 | SEQUENCE (SIZE(1..maxNrofAdditionalPCI- |
| r17)) OF SSB-MTC-AdditionalPCI-r17 | OPTIONAL, -- Need N |
| additionalPCI-ToReleaseList-r17 | SEQUENCE (SIZE(1..maxNrofAdditionalPCI- |
| r17)) OF AdditionalPCIIndex-r17 | OPTIONAL, -- Need N |
| unifiedTCI-StateType-r17 | ENUMERATED {separate, joint} |

OPTIONAL, -- Need R

| | |
|---|---|
| uplink-PowerControlToAddModList-r17 | SEQUENCE (SIZE (1..maxUL-TCI-r17)) OF |
| Uplink-powerControl-r17 | OPTIONAL, -- Need N |
| uplink-PowerControlToReleaseList-r17 | SEQUENCE (SIZE (1..maxUL-TCI-r17)) OF |
| Uplink-powerControlId-r17 | OPTIONAL, -- Need N |
| sfnSchemePDCCH-r17 | ENUMERATED |
| {sfnSchemeA,sfnSchemeB} | OPTIONAL, -- |

Need R

| | |
|---|---|
| sfnSchemePDSCH-r17 | ENUMERATED |
| {sfnSchemeA,sfnSchemeB} | OPTIONAL -- |

Need R
}

In Table 23 above, the UE may be configured to the higher layer signaling unifiedTCI-StateType-r17 within MIMOParam-r17, from the BS, and the signaling may be either separate or joint of unifiedTCI-State Type-r17.

In case that the UE is configured to unifiedTCI-StateType-r17, which is the higher layer signaling, as separate, when the UE receives the configuration and indication related to the unified TCI state from the BS may indicate that the UE may be individually configured and indicated for the TCI state applicable to DL reception (e.g., DL TCI state) and the TCI state applicable to UL transmission (e.g., UL TCI state). In this case, the UE may be configured by the BS to dl-OrJointTCI-StateList and ul-TCI-ToAddModList, which are the higher layer signaling indicating the list of DL TCI state and UL TCI state, respectively.

In case that the UE is configured to unifiedTCI-StateType-r17, which is the higher layer signaling, as joint, when the UE receives the configuration and indication related to the unified TCI state from the BS may indicate that the UE may be unifiedly configured and indicated for the TCI state applicable to DL reception and UL transmission (e.g., joint TCI state). In this case, the UE may be configured by the BS to dl-OrJointTCI-StateList, which is the higher layer signaling indicating the list of joint TCI states.

As shown in Table 23 above, the UE may be configured to the higher layer signaling, uplink-PowerControlToAddModList in MIMOParam-r17. The higher layer signaling, uplink-PowerControlToAddModList may include transmission power parameters for PUSCH, PUCCH, and SRS in case that the UE is configured to the higher layer signaling unifiedTCI-StateType in the corresponding serving cell. The higher layer signaling, uplink-PowerControlToAddModList, may include a corresponding parameter of list of up to 64 Uplink-powerControl-r17 and Uplink-powerControlId-r17 parameters. The higher layer signaling, Uplink-powerControl-r17, may have a structure as shown in Table 24 below.

As shown in Table 23 above, the UE may be configured to pathlossReferenceLinking in ServingCellConfig. pathlossReferenceLinking, which is the higher layer signaling, may indicate whether the UE refers to a list of reference signals for PL measurement in special cell (SpCell) (primary cell (PCell)) for master cell group (MCG) or primary secondary cell (PScell)/primary secondary cell group (SCG) for SCG or secondary cell (SCell).

TABLE 24

| Uplink-powerControl-r17 ::= SEQUENCE { | |
|---|---|
| ul-powercontrolId-r17 | Uplink-powerControlId-r17, |
| p0AlphaSetforPUSCH-r17 | P0AlphaSet-r17 |
| OPTIONAL, -- Need R | |
| p0AlphaSetforPUCCH-r17 | P0AlphaSet-r17 |
| OPTIONAL, -- Need R | |
| p0AlphaSetforSRS-r17 | P0AlphaSet-r17 |
| OPTIONAL -- Need R | |
| } | |
| P0AlphaSet-r17 ::= | SEQUENCE { |
| p0-r17 | INTEGER (−16..15) |
| OPTIONAL, -- Need R | |
| alpha-r17 | Alpha |
| OPTIONAL, -- Need S | |
| closedLoopIndex-r17 | ENUMERATED { i0, i1 } |

}
Uplink-powerControlId-r17 ::= INTEGER(1.. maxUL-TCI-r17)

As shown in Table 24 above, the UE may include ul-powercontrolId-r17 in one Uplink-powerControl-r17 parameter, and may be configured to individual POAlphaSet-r17 applicable to PUSCH, PUCCH, or SRS, respectively, and each POAlphaSet-r17 may include the above-described UL transmission power parameters p0, alpha, and closedLoopIndex.

The higher layer signaling in Table 23 above may be applied to all BWPs in the corresponding serving cell. Table 25 below shows the higher layer signaling structure that the UE may be configured for each UL BWP (e.g., BWP-UplinkDedicated).

TABLE 25

| | |
|---|---|
| BWP-UplinkDedicated ::= | SEQUENCE { |
| pucch-Config | SetupRelease { PUCCH-Config } |

OPTIONAL, -- Need M

| | |
|---|---|
| pusch-Config | SetupRelease { PUSCH-Config } |

OPTIONAL, -- Need M

| | |
|---|---|
| configuredGrantConfig | SetupRelease { ConfiguredGrantConfig } |

OPTIONAL, -- Need M

| | |
|---|---|
| srs-Config | SetupRelease { SRS-Config } |
| OPTIONAL, -- Need M | |

...
[[

| | |
|---|---|
| ul-TCI-StateList-r17 | CHOICE { |
| explicitlist | SEQUENCE { |
| ul-TCI-ToAddModList-r17 | SEQUENCE (SIZE (1..maxUL- |
| TCI-r17)) OF TCI-UL-State-r17 | OPTIONAL, -- Need N |
| ul-TCI-ToReleaseList-r17 | SEQUENCE (SIZE (1..maxUL-TCI- |
| r17)) OF TCI-UL-StateId-r17 | OPTIONAL -- Need N |

},

| | |
|---|---|
| unifiedTCI-StateRef-r17 | ServingCellAndBWP-Id-r17 |

}
OPTIONAL, -- Need R

| | |
|---|---|
| ul-powerControl-r17 | Uplink-powerControlId-r17 |

OPTIONAL, -- Cond NoTCI-PC
...
[[

| | |
|---|---|
| pathlossReferenceRSToAddModList-r17 | SEQUENCE (SIZE |

(1..maxNrofPathlossReferenceRSs-r17)) OF PathlossReferenceRS-r17
OPTIONAL, -- Need N

| | |
|---|---|
| pathlossReferenceRSToReleaseList-r17 | SEQUENCE (SIZE |

(1..maxNrofPathlossReferenceRSs-r17)) OF PathlossReferenceRS-Id-r17
OPTIONAL -- Need N
]]
}

In Table 25 above, the UE may be configured to ul-TCI-StateList-r17, which is the higher layer signaling, and the UE may be configured to either explicitlist or unifiedTCI-StateRef-r17. In case that the UE has configured to explicitlist for ul-TCI-StateList-r17, which is the higher layer signaling, the UE may be explicitly configured to a list of UL TCI states that may be used in the corresponding UL BWP through ul-TCI-ToAddModList-r17. In case that the UE has configured to unifiedTCI-StateRef-r17 for ul-TCI-StateList-r17, which is the higher layer signaling, the UE may use the joint TCI state or UL TCI state that may be used in the corresponding UL BWP by referencing the joint TCI state or UL TCI state configured in another UL BWP, without explicitly being configured to the joint TCI state or UL TCI state for the corresponding UL BWP. In this case, the higher layer signaling, unifiedTCI-StateRef-r17, may indicate the index of a certain BWP within a certain serving cell. In addition, the UE may expect that the serving cell including the BWP configured to unifiedTCI-StateRef-r17 and a certain serving cell including the BWP that may be configured from the BS through unifiedTCI-StateRef-r17 have the same unifiedTCI-StateType.

In Table 25, in case that the UE is configured to unifiedTCI-StateType, the UE may be configured to ul-powerControl, which is the higher layer signaling, and ul-powerControl may refer to one Uplink-powerControlId-r17. In this case, the UE may be configured to ul-powerControl, which is the higher layer signaling, for all UL BWPs within a specific serving cell, or may not be configured to ul-powerControl, which is the higher layer signaling, for all UL BWPs.

In case that the UE has been configured to unifiedTCI-StateRef-r17 in BWP-UplinkDedicated, or has received a configuration referencing another serving cell and BWP with the value of unifiedTCI-StateRef-r17 in PDSCH-Config, and unifiedTCI-State Type is configured to joint, the UE may expect to be configured to ul-powerControl in all UL BWPs of the referenced serving cell and the corresponding serving cell, or not to be configured to ul-powerControl in all UL BWPs of the referenced serving cell and the corresponding serving cell. In this case, the higher layer signaling, ul-powerControl, may be configured to the UE only in case that the condition called NoTCI-PC is met, and the meaning of the condition called NoTCI-PC may indicate when the higher layer signaling, ul-powerControl, is not configured in the joint TCI state or UL TCI state in the corresponding serving cell.

In Table 25 above, in case that the UE is configured to unifiedTCI-StateType, the UE may be configured to the higher layer signaling, pathlossReferenceRSToAddModList-r17, and the corresponding higher layer signaling, pathlossReferenceRSToAddModList-r17, may indicate a list of reference signals (e.g., CSI-RS or SSB) that may be used to calculate PL when transmitting PUSCH, PUCCH, or SRS in case that the UE supports the unified TCI state. In case that the UE is not configured to unifiedTCI-StateType, the UE may not include any list in the corresponding higher layer signaling.

In case that the UE is configured to unifiedTCI-StateType, when the UE is indicated to a reference signal for measuring PL through a TCI state indication, the corresponding indicated reference signal for PL measurement may indicate a reference signal for PL measurement configured within a serving cell to which the indicated TCI state is applied. In this case, in case that the UE has been configured to the above pathlossReferenceLinking, the UE may consider that the corresponding indicated reference signal for PL measurement means a reference signal for PL measurement configured within the serving cell configured through the above pathlossReferenceLinking.

In case that the UE operates based on the unified TCI state, that is, according to whether the UE is configured to the higher layer signaling, unifiedTCI-StateType, as joint or separate, the higher layer signaling structure of the TCI state that the UE may be indicated by the BS may be determined. In case that the UE is configured to the higher layer signaling, unifiedTCI-StateType, as joint, the UE may be configured and indicated to the joint TCI state from the BS through/using the higher layer signaling of the structure shown in Table 26 below. In case that the UE is configured to the higher layer signaling, unifiedTCI-StateType, as separate, the UE may be configured and indicated to the DL TCI state from the BS through/using the higher layer signaling of the structure shown in Table 26 below, and may be configured and indicated to the UL TCI state from the BS using the higher layer signaling structure shown in Table 27.

In case that the UE is configured to the higher layer signaling, unifiedTCI-StateType, as joint, the UE may expect that pathlossReferenceRS-Id-r17 in Table 26 below is always configured. When unifiedTCI-StateType is configured as separate or unifiedTCI-StateType is not configured, the UE may expect that pathlossReferenceRS-Id-r17 is not configured. The name of such a condition may be defined as JointTCI1.

In case that the UE is configured to the higher layer signaling, unifiedTCI-StateType, as separate, the UE may expect that pathlossReferenceRS-Id-r17 in Table 27 below is always configured. The name of such a condition may be defined as Mandatory.

TABLE 26

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |

OPTIONAL, -- Need R

| | |
|---|---|
| pathlossReferenceRS-Id-r17 | PathlossReferenceRS-Id-r17 |

OPTIONAL, -- Cond JointTCI1

| | |
|---|---|
| ul-powerControl-r17 | Uplink-powerControlId-r17 |

OPTIONAL -- Cond JointTCI
]]
}

TABLE 27
TCI-UL-State

| | |
|---|---|
| TCI-UL-State-r17 ::= | SEQUENCE { |
| tci-UL-StateId-r17 | TCI-UL-StateId-r17, |
| servingCellId-r17 | ServCellIndex |

OPTIONAL, -- Need R

| | |
|---|---|
| bwp-Id-r17 | BWP-Id |

OPTIONAL, -- Cond CSI-RSorSRS-Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | |
|---|---|
| additionalPCI-r17 | AdditionalPCIIndex-r17 |

OPTIONAL, -- Need R

| | |
|---|---|
| ul-powerControl-r17 | Uplink-powerControlId-r17 |

OPTIONAL, -- Need R

| | |
|---|---|
| pathlossReferenceRS-Id-r17 | PathlossReferenceRS-Id-r17 |

OPTIONAL, -- Cond Mandatory
...
}

The UE may be configured to the higher layer signaling related to the transmission power parameters applicable to SRS transmission according to Tables 28 and 29 below.

TABLE 28

| | |
|---|---|
| SRS-Config ::= | SEQUENCE { |
| srs-ResourceSetToReleaseList | SEQUENCE (SIZE(1..maxNrofSRS- |
| ResourceSets)) OF SRS-ResourceSetId | OPTIONAL, -- Need N |
| srs-ResourceSetToAddModList | SEQUENCE (SIZE(1..maxNrofSRS- |
| ResourceSets)) OF SRS-ResourceSet | OPTIONAL, -- Need N |
| srs-ResourceToReleaseList | SEQUENCE (SIZE(1..maxNrofSRS- |
| Resources)) OF SRS-ResourceId | OPTIONAL, -- Need N |
| srs-ResourceToAddModList | SEQUENCE (SIZE(1..maxNrofSRS- |
| Resources)) OF SRS-Resource | OPTIONAL, -- Need N |
| tpc-Accumulation | ENUMERATED {disabled} |

```
OPTIONAL, -- Need S
  ...,
  [[
```

| | |
|---|---|
| srs-RequestDCI-1-2-r16 | INTEGER (1..2) |

OPTIONAL, -- Need S

| | |
|---|---|
| srs-RequestDCI-0-2-r16 | INTEGER (1..2) |

OPTIONAL, -- Need S

| | |
|---|---|
| srs-ResourceSetToAddModListDCI-0-2-r16 | SEQUENCE (SIZE(1..maxNrofSRS- |
| ResourceSets)) OF SRS-ResourceSet | OPTIONAL, -- Need N |
| srs-ResourceSetToReleaseListDCI-0-2-r16 | SEQUENCE (SIZE(1..maxNrofSRS- |
| ResourceSets)) OF SRS-ResourceSetId | OPTIONAL, -- Need N |
| srs-PosResourceSetToReleaseList-r16 | SEQUENCE (SIZE(1..maxNrofSRS- |

PosResourceSets-r16)) OF SRS-PosResourceSetId-r16
OPTIONAL, -- Need N

| | |
|---|---|
| srs-PosResourceSetToAddModList-r16 | SEQUENCE (SIZE(1..maxNrofSRS- |
| PosResourceSets-r16)) OF SRS-PosResourceSet-r16 | OPTIONAL,-- Need N |
| srs-PosResourceToReleaseList-r16 | SEQUENCE (SIZE(1..maxNrofSRS- |
| PosResources-r16)) OF SRS-PosResourceId-r16 | OPTIONAL,-- Need N |
| srs-PosResourceToAddModList-r16 | SEQUENCE (SIZE(1..maxNrofSRS- |
| PosResources-r16)) OF SRS-PosResource-r16 | OPTIONAL -- Need N |

]]
}

TABLE 29

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS- |
| ResourcePerSet)) OF SRS-ResourceId | OPTIONAL, -- Cond Setup |
| resourceType | CHOICE { |
| aperiodic | SEQUENCE { |
| aperiodicSRS-ResourceTrigger | INTEGER (1..maxNrofSRS- |

TriggerStates-1),

| | |
|---|---|
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
        ...,
        [[
```

| | |
|---|---|
| aperiodicSRS-ResourceTriggerList | SEQUENCE |

(SIZE(1..maxNrofSRS-TriggerStates-2))

| | |
|---|---|
| | OF INTEGER |
| (1..maxNrofSRS-TriggerStates-1) | OPTIONAL -- Need M |

```
        ]]
      },
```

| | |
|---|---|
| semi-persistent | SEQUENCE { |
| associatedCSI-RS | NZP-CSI-RS-ResourceId |

```
OPTIONAL, -- Cond NonCodebook
        ...
      },
```

| | |
|---|---|
| period | SEQUENCE { |
| associatedCSI-RS | NZP-CSI-RS-ResourceId |

```
OPTIONAL, -- Cond Noncodebook
        ...
      }
  },
```

| | |
|---|---|
| usage | ENUMERATED {beamManagement, |

codebook, nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | PathlossReferenceRS-Config |

OPTIONAL, -- Need M

| | |
|---|---|
| srs-PowerControlAdjustmentStates | ENUMERATE { sameAsFci2, |
| separateClosedLoop} | OPTIONAL, -- Need S |

```
  ...,
  [[
```

| | |
|---|---|
| pathlossReferenceRSList-r16 | SetupRelease { PathlossReferenceRSList- |
| r16} | OPTIONAL -- Need M |

```
  ]],
  [[
```

| | |
|---|---|
| usagePDC-r17 | ENUMERATED {true} |

OPTIONAL, -- Need R

| | |
|---|---|
| availableSlotOffsetList-r17 | SEQUENCE (SIZE(1..4)) OF |
| AvailableSlotOffset-r17 | OPTIONAL, -- Need R |
| followUnifiedTCI-StatesSRS-r17 | ENUMERATED {enabled} |

OPTIONAL -- Need R

| | |
|---|---|
| applyIndicatedTCI-State-r18 | ENUMERATE {first, second} |

OPTIONAL -- Cond FollowUTCI
]]
}

The description of each higher layer signaling parameter in Tables 28 and 29 above may be as follows:
tpc-Accumulation: In case that the UE is not configured for tpc-Accumulation, the UE may perform an operation of additionally accumulating values of previously indicated TPC commands when receiving a TPC command indicating a change in SRS transmission power. In case that the UE is configured as disabled for tpc-Accumulation, the UE may perform an operation of applying the absolute TPC without performing an accumulation operation when receiving a TPC command indicating a change in SRS transmission power. Such an absolute TPC operation may be possible in case that SRS does not share a closed-loop index with PUSCH.
Alpha: The UE may be configured with an alpha value for determining SRS transmission power through the corresponding higher layer signaling
p0: The UE may be configured with a p0 value in the SRS-resourceSet for determining SRS transmission power through the corresponding higher layer signaling. In case that the UE has not been configured to the higher layer signaling, unifiedTCI-StateType, the UE may determine the value of P_{0_SRS,b,f,c} (qₛ) in Equation (7) above through the corresponding higher layer signaling, p0. In case that the UE has been configured to the higher layer signaling, unifiedTCI-StateType, the UE may determine the value of P_{0_SRS,b,f,c} (qₛ) in Equation (7) as the sum of p0 in the corresponding higher layer signaling, SRS-resourceSet, and the p0 value that may be configured in p0AlphaSetforSRS in the UL-powerControlId-r17 (e.g., P_{0_UE_SRS,b,f,c} (qₛ)). In this case, the UL-powerControlId-r17 may be determined through the following method.

In case that the UE determines the UL transmission power through Method 1, it may be determined through one ul-powerControl configured within a specific UL BWP.

In case that the UE determines the UL transmission power through Method 2,

In case that the UE has been configured to followUnifiedTCIstateSRS, which is the higher layer signaling, within the SRS resource set, the UE may receive P_{0_UE_SRS,b,f,c} (As), alpha, and srs-PowerControlAdjustmentStates values based on p0AlphaSetforSRS, which is the higher layer signaling associated with the TCIState or UL-TCIstate indicated by the BS, and pathlossReferenceRS, which is the higher layer signaling indicating a PL reference signal, may be provided based on pathlossReferenceRS-Id-r17, which is the higher layer signaling associated with or included in the TCIState or UL-TCIstate indicated by the BS.

In case that the UE is not configured to followUnifiedTCIstateSRS, which is the higher layer signaling, in the SRS resource set, the UE may receive P_{0_UE_SRS,b,f,c}(qₛ), alpha, and srs-PowerControlAdjustmentStates values based on p0AlphaSetforSRS, which is the higher layer signaling associated with the TCIState or UL-TCIstate configured in the SRS resource with the lowest index within the corresponding SRS resource set, and pathlossReferenceRS, which is the higher layer signaling indicating a PL reference signal, may be provided based on pathlossReferenceRS-Id-r17, which is the higher layer signaling associated with or included in the TCIState or UL-TCIstate configured in the SRS resource with the lowest index within the corresponding SRS resource set.

srs-PowerControlAdjustmentStates: The UE may be configured with a closed-loop index used in determining SRS transmission power through the corresponding higher layer signaling. In case that the UE has not been configured to the corresponding higher layer signaling, the UE may share the closed-loop index of a SRS with the first closed-loop index of a PUSCH. In case that the UE is configured to the corresponding higher layer signaling as sameAsFci2, the UE may share the closed-loop index of the SRS with the second closed-loop index of the PUSCH. In this case, the corresponding UE may be configured to the higher layer signaling to have a maximum of two closed-loop indices for the PUSCH. In case that the UE is configured to the corresponding higher layer signaling as separateClosedLoop, the UE may be configured to the closed-loop index of the SRS separately without sharing the closed-loop index with the closed circuit index of the PUSCH.

In case that the UE has been configured to the higher layer signaling, unifiedTCI-State Type, and has been configured to the srs-PowerControlAdjustmentStates within a specific SRS resource set as separateClosedLoop, the UE may consider the SRS resources included in the corresponding SRS resource set to be connected to a PUSCH and an individual closed-loop index. In this case, the UE may consider the PUSCH and the separate closed-loop index as described above, regardless of the closed-loop connected to the TCI state indicated by the BS.

In case that the UE has been configured to the higher layer signaling, unifiedTCI-State Type, and has not been configured to the srs-PowerControlAdjustmentStates within a specific SRS resource set as separateClosedLoop (i.e., has not been configured to srs-PowerControlAdjustmentStates or has been configured to sameAsFci2), the UE may consider that the SRS resources included in the corresponding SRS resource set are connected to the first or second closed-loop index connected to the PUSCH. In this case, when the closed-loop connected to the TCI state indicated by the BS is i₀, the UE may be considered to be connected to the first closed-loop index connected to the PUSCH when determining the transmission power of the SRS to which the corresponding TCI state is applied. When the closed-loop is i1, the UE may be connected to the second closed-loop index connected to the PUSCH when determining the transmission power of the SRS to which the corresponding TCI state is applied.

pathlossReferenceRSList: The UE may be configured with a list of reference signals for measuring PL for determining the transmission power of the SRS through the corresponding higher layer signaling.

followUnifiedTCI-StateSRS-r17: The UE may determine, through the corresponding higher layer signaling, whether the joint TCI state or UL TCI state indicated to the UE through DCI is going to be applied to the SRS resource within the corresponding SRS resource set in case that the UE operates in the unified TCI state, i.e., in case that the UE has been configured to unifiedTCI-StateType. In case that the corresponding higher layer signaling is configured as enabled, the UE may apply the joint TCI state or UL TCI state indicated through DCI to the SRS resource within the corresponding SRS resource set. In case that the corresponding higher layer signaling is not configured for the UE, the UE may be configured to the joint TCI state or UL TCI state for each SRS resource in the corresponding SRS resource set, and may not apply the joint TCI state or UL TCI state indicated through DCI to the SRS resources in the corresponding SRS resource set. The UE may be configured to the corresponding higher layer signaling in case that the usage of the SRS resource set has been configured as beam management and the resource Type is aperiodic, or in case that the usage of the SRS resource set has been configured as codebook, non-codebook, antenna switching, and the resourceType is aperiodic, semi-persistent, or periodic.

applyIndicatedTCI-State-r18: In case that the UE operates in the unified TCI state, i.e., the UE has been configured to unifiedTCI-StateType and operates in multiple TRPs, the UE may be configured, through the corresponding higher layer signaling, to which TCI state to apply to the SRS resource within the SRS resource set for which the corresponding higher layer signaling is configured. In case that the UE has been configured to followUnifiedTCI-StateSRS-r17, the UE may not be configured to applyIndicatedTCI-State-r18. In case that the usage of the SRS resource set has been configured as beam management and the resourceType is aperiodic, or in case that the usage of the SRS resource set has been configured as codebook, non-codebook, or antenna switching and the resourceType is aperiodic, semi-persistent, or periodic, the UE may be configured to the corresponding higher layer signaling within the SRS resource set.

In case that the UE operates in single-DCI-based multi-TRP, i.e., in case that the UE is configured with two joint TCI states or two DL TCI states or two UL TCI states for at least one codepoint of the TCI state field in DCI, if the UE has been first configured to the corresponding higher layer signaling, the UE may apply the first joint TCI state or the first UL TCI state to one or more SRS resources in the SRS resource configured for which the corresponding higher layer signaling has been configured, among one or more joint TCI states or one or more UL TCI states indicated to the UE through the DCI, and if the UE has been configured to the corresponding higher layer signaling secondly, the UE may apply the second joint TCI state or the second UL TCI state to one or more SRS resources in the SRS resource set for which the corresponding higher layer signaling has been configured, among one or more joint TCI states or one or more UL TCI states indicated to the UE through the DCI. If the UE has not been configured to the corresponding higher layer signaling, the UE may be configured with a joint TCI state or UL TCI state for each of one or more SRS resources in the corresponding SRS resource set, and may not apply the joint TCI state or UL TCI state indicated through DCI to the SRS resources in the corresponding SRS resource set.

In case that the UE operates in multi-DCI-based multi-TRP, i.e., in case that the UE has been configured to two different CORESETPoolIndexes, the UE may apply the joint TCI state or UL TCI state indicated through DCI received in the CORESET with CORESETPoolIndex configured to 0 or 1, to each of one or more SRS resources in the SRS resource set for which the corresponding higher layer signaling is configured, in case that the corresponding higher layer signaling is configured as first or second. In case that the UE has not been configured to the corresponding higher layer signaling, and an SRS resource set with resourceType configured as aperiodic is triggered via DCI, the UE may determine the joint TCI state or UL TCI state to be applied to one or more SRS resources within the corresponding SRS resource set, depending on which CORESET configured with CORESETPoolIndex the corresponding DCI has been received from. For example, in case that the UE has not been configured to the corresponding higher layer signaling, and the UE has been configured to the followUnifiedTCI-StateSRS-r17, and an SRS resource set with resourceType configured as aperiodic is triggered via DCI received within a CORESET with CORESETPoolIndex configured to 0, the UE may apply the joint TCI state or UL TCI state indicated via DCI received within the CORESET with CORESETPoolIndex configured to 0, to one or more SRS resources within the corresponding SRS resource set. Alternatively, in case that the UE has not been configured to the corresponding higher layer signaling, and an SRS resource set with resourceType configured as aperiodic is triggered through DCI received within a CORESET with CORESETPoolIndex configured to 1, the UE may apply the joint TCI state or UL TCI state indicated via DCI received within the CORESET with CORESETPoolIndex configured to 1, to one or more SRS resources within the corresponding SRS resource set. In case that the UE has not been configured to the corresponding higher layer signaling, and the UE has not been configured to the followUnifiedTCI-StateSRS-r17, the UE may be configured with the joint TCI state or UL TCI state for each of one or more SRS resources within the corresponding SRS resource set, and may not apply the joint TCI state or UL TCI state indicated via DCI, to the SRS resources within the corresponding SRS resource set.

Considering the structure of the higher layer signaling described above, the UE may use two methods for determining UL transmission power when operating in the unified TCI state. The following methods may be applied individually or at least some of the methods may be applied in combination.

### Method 1: Basic Transmission Power Determination Method: Application of Common Transmission Power Parameters

The UE may be configured to ul-powerControl parameter for each of one or more UL BWPs configured within a specific serving cell. That is, the UE may apply a set of transmission power parameters (e.g., p0, alpha, closed-loop index) that may be known through ul-powerControl configured for the corresponding UL BWP when performing all UL transmissions within each UL BWP. Therefore, the UE may use only one common transmission power parameter without using individual transmission power parameters according to the UL channel and signal.

### Method 2: Additional Transmission Power Determination Method: Different Transmission Power Parameters May be Applied

A UE may apply a set of transmission power parameters (e.g., p0, alpha, closed-loop index) that may be known through the higher layer signaling, ul-powerControl-r17, in a joint TCI state or UL TCI state in Tables 27 or 28 above, without configuring ul-powerControl parameter for each of one or more UL BWPs configured in a specific serving cell. Accordingly, the UE may be configured to different ul-powerControl-r17 for each different joint TCI state or UL TCI state, and may operate various transmission power parameters compared to Method 1, and may use different transmission power parameters depending on the UL transmission situation and the UE and BS operation scenarios.

In the above-described Method 1 and Method 2, in common, the UE may be configured with a reference signal for PL measurement in the joint TCI state or the UL TCI state. That is, when the UE operates in the unified TCI state, the UE may always be configured to a reference signal for PL measurement in the joint TCI state or the UL TCI state, and the UE may determine the PL to be reflected when determining UL transmission power by using the reference signal for PL measurement configured in the configured and indicated unified TCI state. In addition, the UE may track up to four reference signals for PL measurement per any serving cell and update up to four different PLes.

The UE may report to the BS whether it supports at least one combination of Method 1 and Method 2 through a UE capability report. In addition, the UE may be configured by the BS for at least one combination of Method 1 and Method 2 through the higher layer signaling.

### Second Embodiment: Method for Calculating a Difference Value of PL Between a UE and a BS

As an embodiment of the disclosure, a method for calculating a difference value of pathloss between a UE and a base station is described. This embodiment may be operated in combination with other embodiments.

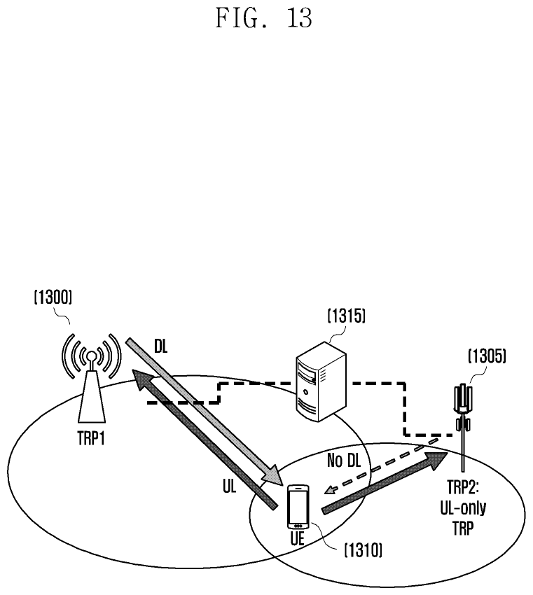

FIG. 13 illustrates a method of a BS and UE operating with multiple TRPs, including a TRP supporting only a UL reception function according to an embodiment.

A UE 1310 may be connected to and operated by a BS operating with multiple TRPs as described above. Basically, the UE may assume that each of the plurality of TRPs supports both UL reception and DL transmission. In this case, the BS may operate a TRP 1305 supporting only a UL reception function, in addition to a conventional TRP 1300 capable of both UL reception and DL transmission, for improving UL coverage from the perspective of the corresponding UE, or for energy saving gains that may be obtained by saving DL transmission power at the BS. Such a TRP supporting only UL reception may be named a UL-only TRP. The UE may assume that no DL transmission is performed from such a UL-only TRP. In this case, as an assumption for such UL-only TRP, the BS and UE may consider at least one combination among the following.

The corresponding UL-only TRP may operate as a UL-only TRP only for specific UEs. That is, the corresponding UL-only TRP actually has both UL reception and DL transmission functions, but for specific terminals, it may support only the UL reception function under specific conditions (for example, by notifying the UE that it is connected to the UL-only TRP through a combination of at least one of specific higher layer signaling, MAC-CE, and L1 signaling. For example, the corresponding notification may be received through a TRP 1300 that may operate in both UL and downlink). In other words, the UL-only TRP may support DL transmission for other UEs. Such UL-only TRP may expand the UL coverage by additionally operating only the reception function of a TRP that is already installed or a newly installed TRP near the corresponding location when specific UEs exist at the boundary of a certain cell coverage.

The UL-only TRP may be a TRP that does not support the DL transmission function for all UEs but only supports the UL reception function. That is, the corresponding UL-only TRP is a TRP with relatively low production and installation costs, and may be used to receive UL transmissions from UEs in addition to the existing installed TRPs, thereby obtaining reception diversity from the perspective of the BS.

Although the UE may receive a PL measurement reference signal from the TRP 1300 capable of UL and DL operations, since DL transmission is not performed from the UL-only TRP 1305, there may be a problem that the PL between the UL-only TRP and the UE cannot be known in case that the UE 1310 performs UL transmission toward the corresponding UL-only TRP 1305. To solve this situation, the BS and UE may consider a combination of at least one of the following methods to obtain PL information between the UL-only TRP and the UE.

### Method 3

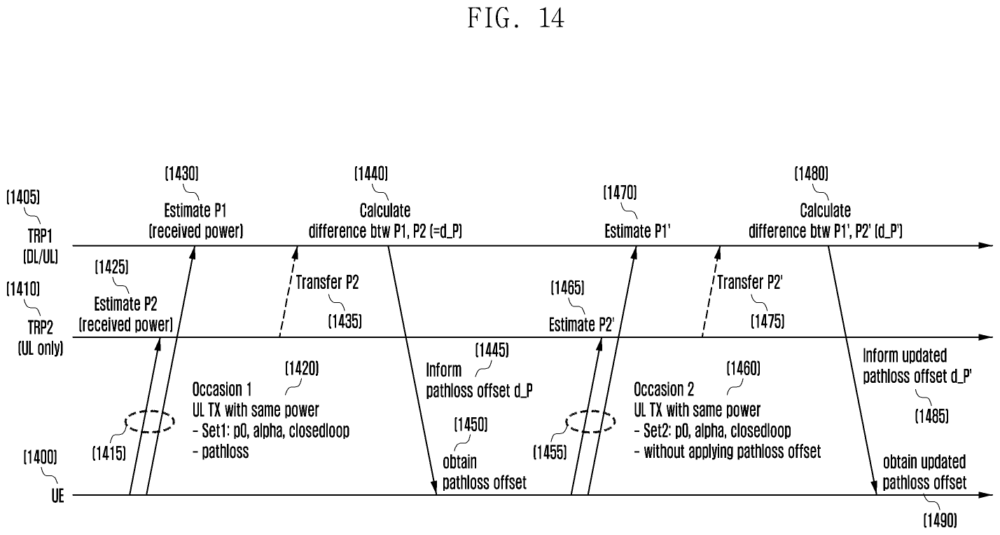

FIG. 14 illustrates a method for calculating and updating a PL difference value according to an embodiment.

A UE 1400 may be connected to and operated by a BS configured with a TRP capable of UL and DL operations (e.g., TRP1, 1410) and a UL-only TRP capable of performing UL reception only (e.g., TRP2, 1405). The UE 1400 and BS may go through a series of processes of exchanging signals between the UE 1400 and the BS to obtain information on the PL between the TRP2 1410 and the UE 1400.

### Process 1—UL Transmission of UE

The UE 1400 may transmit a UL signal to the TRP1 1405 and TRP2 1410 (1415). In this case, in case that the UE operates in frequency range 1 (FR1), the UE may transmit a UL signal to TRP1 1405 and TRP2 1410 with only a single UL transmission. When the UE operates in frequency range 2 (FR2), the UE may perform individual UL transmission by applying different transmission beams to TRP1 1405 and TRP2 1410. In case that the UE operates in FR2, when the UE determines the transmission power of individual UL signals transmitted to TRP1 1405 and TRP2 1410, the UE may apply the same transmission power parameters (1420). That is, in case that the UE determines the transmission power of two UL signals, the UE may consider the same p0, alpha, closed-loop index, and PL between TRP1 1405 and the UE. Accordingly, even when the transmission power of the UL signal transmitted by the UE to TRP2 1410, the UE may apply the PL between TRP1 1405 and the UE when determining the corresponding transmission power.

### Process 2—Calculation of a Difference in PL at a BS

Thereafter, TRP1 1405 and TRP2 1410 may receive the UL transmission of these UEs, respectively, and calculate the reception power P1 (1430) and P2 (1425) at each TRP. TRP2 1410 may transfer P2 to TRP1 1405 (1435). TRP1 1405, which receives P2 from TRP2 1410, may calculate a difference d_P between P1 and P2 (1440). Here, when calculating d_P in TRP1 1405 (1440), TRP1 1405 may consider a reception beam gain at TRP1 1405, a reception beam gain at TRP2 1410, and in case of FR2, the UE may consider each transmission beam gain considered when transmitting to TRP1 1405 and TRP2 1410 and a maximum permissible exposure (MPE) value that may determine the transmission power reduction for each transmission beam.

### Process 3—Transfer of a Difference in PL to the UE

The BS may calculate d_P, which is a difference between a PL between TRP1 1405 and the UE and a PL between TRP2 1410 and the UE, and then notify the UE of the corresponding value (1445). Through this process, the UE may obtain the d_P value (1450), and then, when transmitting UL for TRP2 1410, in addition to the PL that may be measured through the reference signal for PL measurement that may be received from TRP1 1405, the corresponding d_P value may be applied to determine the UL transmission power for TRP2 1410.

Through the above Process 1 to Process 3, the BS may calculate d_P, which is the difference value between the PL between TRP1 and the UE and the PL between TRP2 and the UE, by utilizing the reception power information of the UL signal of the UE. In the above Process 3, the BS may process (e.g., take the arithmetic mean) one or more d_P values calculated by repeating Process 1 and Process 2 one or more times and transfer them to the UE. That is, one value obtained based on one or more d_P values may be transferred to the UE.

When a UE that is not fixed to a specific location such as a customer premises equipment (CPE), for example, a UE such as a smartphone, a smartwatch, or a tablet may have a mobility without a fixed location, and therefore, d_P may be a value that changes over time. Therefore, the above Process 1 to Process 3 may be configured or activated to be repeated periodically or semi-continuously for the UE, or may be triggered aperiodically for the UE. To confirm the changing d_P value and transfer the same to the UE, the following additional processes may be considered between the UE and the BS.

Process 4—UL Transmission of a UE after Obtaining d_P

After the UE obtains d_P from the BS, the UE may transmit a UL signal to TRP1 1405 and TRP2 1410 (1455). When the UE operates in FRI, the UE may transmit a UL signal to TRP1 1405 and TRP2 1410 with only a single UL transmission. When the UE operates in FR2, the UE may perform individual UL transmission by applying different transmission beams to TRP1 1405 and TRP2 1410. In case that the UE operates in FR2, when the UE determines the transmission power of individual UL signals transmitted to TRP1 1405 and TRP2 1410, the UE may apply the same transmission power parameter to each other (1460). That is, in case that the UE determines the transmission power of the two UL signals, the UE may consider the same p0, alpha, closed-loop index, and the PL between TRP1 1405 and the UE. In addition, although the UE has obtained the d_P value through the above Process 3, the UE may transmit without applying d_P when determining the UL transmission power to TRP2 1410 so that the BS may calculate the difference value between the PL between TRP1 1405 and the UE and the PL between TRP2 1410 and the UE by applying the same transmission power parameter to the two TRPs (1460). Accordingly, even when the transmission power of the UL signal transmitted by the UE to TRP2 1410, the UE may apply only the PL between TRP1 1405 and the UE when determining the corresponding transmission power.

### Process 5—Calculation of a Difference in Path Loss at a BS

Thereafter, TRP1 1405 and TRP2 1410 may receive the UL transmission of the UE in the above Process 4, respectively, and calculate the reception power P1′ (1470) and P2′ (1465) at each TRP. TRP2 1410 may transfer P2′ to TRP1 1405 (1475). TRP1 1405, which have received P2′ from TRP2 1410, may calculate the difference d_P′ between P1′ and P2′ (1480). Here, when calculating d_P′ in TRP1 1405 (1480), TRP1 1405 may consider a reception beam gain at TRP1 1405, a reception beam gain at TRP2 1410, and in case of FR2, the UE may consider each transmission beam gain considered when transmitting to TRP1 1405 and TRP2 1410 and a maximum permissible exposure (MPE) value that may determine the transmission power reduction for each transmission beam.

### Process 6—Transfer of a Difference in PL to the UE

The BS may calculate d_P′, which is the difference in PL between TRP1 1405 and the UE and the PL between TRP2 1410 and the UE, and then notify the UE of the value (1485). Through this process, the UE may obtain an updated d_P′ value compared to the previously obtained d_P value (1490), and then, when transmitting UL transmission for TRP2 1410, in addition to the PL that may be measured through the reference signal for PL measurement that may be received from TRP1 1405, the corresponding d_P′ value may be applied to determine the UL transmission power for TRP2 1410.

Thereafter, the UE and BS may repeat the above Process 4 to Process 6 to calculate and share an updated value for the d_P value. In Process 6, the BS may process (for example, take an arithmetic mean) one or more d_P′ values calculated by repeating Process 4 and Process 5 one or more times and transfer the processed values to the UE. That is, one value obtained based on one or more d_P′ values may be transferred to the UE.

In case that the UE performs the UL transmission as illustrated in Process 1 and Process 4, the UE may be configured to one or more SRS resources in an SRS resource set in which resourceType, which is an higher layer signaling, is configured as periodic, semi-persistent, or aperiodic, and perform the above Process 1 and Process 4 based on SRS transmission, and all of the one or more SRS resources may have the same transmission power parameter. In case that the UE operates in FRI, the UE may apply the same transmission power parameters (e.g., p0, alpha, closed-loop index, and PL) to TRP1 1405 and TRP2 1410 based on one SRS resource in the corresponding SRS resource set, and even when a UL transmission for TRP2 1410, the difference value of the PL may not be applied when determining the transmission power as described above. In case that the UE operates in FR2, the UE may apply the same transmission power parameters (e.g., p0, alpha, closed-loop index, and PL) to TRP1 1405 and TRP2 1410 based on one or more SRS resources in the corresponding SRS resource set, and may apply different transmission beams to each SRS resource. Similarly, the UE may not apply the difference value of PL when determining the transmission power as described above, even in case of a UL transmission for TRP2 1410.

The UE may also perform the UL transmission illustrated in Process 1 and Process 4 for UL channels and signals other than SRS (e.g., at least some of PUCCH, PUSCH, physical random access channel (PRACH), and UL reference signal (UL RS)).

In case that the UE performs the UL transmission as shown in the above Process 1 and Process 4, it is necessary to apply the same transmission power parameter to the UL channel or signal transmitted to TRP1 1405 and TRP2 1410 within each process, but it may be possible to use different transmission power parameters between processes (for example, the transmission power parameter used in Process 1 and the transmission power parameter used in Process 4). For example, if the UE determines the UL transmission power using a first p0, a first alpha, a first closed-loop index, and a first PL in Process 1 and transmits the same to TRP1 1405 and TRP2 1410, the UE may be able to determine the UL transmission power using a second p0, a second alpha, a second closed-loop index, and a second PL in Process 4 and transmit the same to TRP1 1405 and TRP2 1410. In this case, the first p0 and the second p0 may be the same as or different from each other, and a similar relationship may be established for other transmission power parameters. That is, the first alpha, the first closed-loop index, and the first PL may be the same as or different from the second alpha, the second closed-loop index, and the second PL, respectively.

When the above Method 3, the UE may receive the d_P value from the BS through the above Process 3 and Process 6. When the above Method 3, since the UE receives the d_P value from the BS, an inaccurate value may be received compared to the d_P″ value that may be considered in the following Method 4 when the same quantization bit amount is considered. However, as described above, since there is no restriction that the same transmission power parameter must be used between each transmission time point as in the above Process 1 and Process 4, the BS may be flexible in operating such UL transmission.

### Method 4

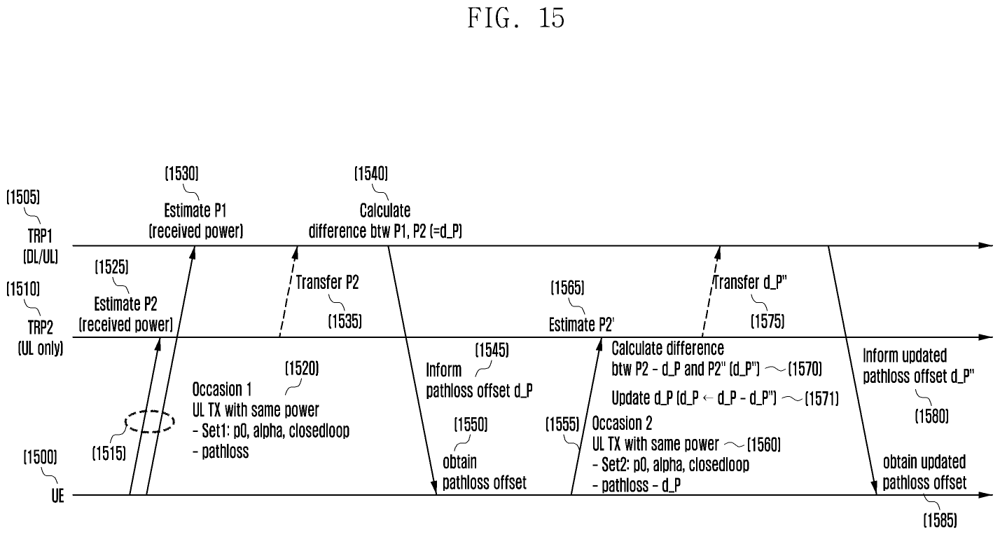

FIG. 15 illustrates another method for calculating and updating a PL difference value according to an embodiment.

A UE 1500 may be connected to and operate a BS configured with a TRP (e.g., TRP1, 1505) capable of UL and DL operations and a UL-only TRP (e.g., TRP2, 1510) capable of performing only UL reception. The UE 1500 and the BS may go through a series of processes of exchanging signals between the UE 1500 and the BS to obtain information on the PL between TRP2 1510 and the UE 1500.

### Process 1-1: UL Transmission of UE

The UE 1500 may transmit a UL signal to TRP1 1505 and TRP2 1510 (1515). When the UE operates in FR1, the UE may transmit a UL signal to TRP1 1505 and TRP2 1510 with only a single UL transmission. When the UE operates in FR2, the UE may perform individual UL transmission by applying different transmission beams to TRP1 1505 and TRP2 1510. In case that the UE operates in FR2, when the UE determines the transmission power of individual UL signals transmitted to TRP1 1505 and TRP2 1510, the UE may apply the same transmission power parameter to each other (1520). That is, in case that the UE determines the transmission power of two UL signals, it may consider the same p0, alpha, closed-loop index, and PL between TRP1 1505 and the UE. Accordingly, even in case of the transmission power of the UL signal transmitted by UE to TRP2 1510, the UE may apply the PL between TRP1 1505 and the UE when determining the transmission power.

### Process 1-2: Calculation of a Difference in PL at a BS

Thereafter, TRP1 1505 and TRP2 1510 may receive the UL transmission of these UEs, respectively, and calculate reception powers P1 (1530) and P2 (1525) at the respective TRPs. TRP2 1510 may transfer P2 to TRP1 1505 (1535). TRP1 1505, which receives P2 from TRP2 1510, may calculate a difference d_P between P1 and P2 (1540). When calculating d_P in TRP1 1505 (1540), TRP1 1505 may consider a reception beam gain at TRP1 1505, a reception beam gain at TRP2 1510, and in case of FR2, the UE may consider each transmission beam gain considered when transmitting to TRP1 1505 and TRP2 1510 and a maximum permissible exposure (MPE) value that may determine the transmission power reduction for each transmission beam.

### Process 1-3: Transfer of a Difference in PL to the UE

The BS may calculate d_P, which is a difference between the PL between TRP1 1505 and the UE and the PL between TRP2 1510 and the UE, and then notify the UE of the corresponding value (1545). Through this process, the UE may obtain the d_P value (1550), and then, when transmitting UL for TRP2 1510, in addition to the PL that may be measured through the reference signal for PL measurement that may be received from TRP1 1505, the corresponding d_P value may be applied to determine the UL transmission power for TRP2 1510.

Through the above Process 1-1 to Process 1-3, the BS may calculate d_P, which is the difference value between the PL between TRP1 and the UE and the PL between TRP2 and the UE, by utilizing the reception power information of the UL signal of the UE. In the above Process 1-3, the BS may process (for example, take the arithmetic mean) one or more d_P values calculated by repeating Process 1-1 and Process 1-2 one or more times and transfer them to the UE. That is, one value obtained based on one or more d_P values may be transferred to the UE. In addition, in the above Process 1-3, the BS may initially perform the notification of the d_P value to the UE once at the BS, and then, in case that the UE and the BS repeat Process 1-1 and Process 1-2, the BS may selectively perform the above Process 1-3.

When a UE that is not fixed to a specific location such as a customer premises equipment (CPE), for example, a UE such as a smartphone, a smartwatch, or a tablet may have a mobility without a fixed location, and therefore, d_P may be a value that changes over time. Therefore, the above Process 1-1 to Process 1-3 may be configured or activated to be repeated periodically or semi-continuously for the UE, or may be triggered aperiodically for the UE. In this case, if the above Process 4 to Process 6 were methods in which the UE and the BS updated the d_P value and shared it with each other, the following Process 1-4 to Process 1-6 may be methods in which the UE and the BS consider the d_P value obtained through the above Process 1-1 to Process 1-3 as an initial value and calculate the amount of change therein and share it with each other. To confirm the change amount in the d_P value and transmit the same to the UE in this way, the following additional processes may be considered between the UE and the BS.

Process 1-4: UL Transmission of a UE after Obtaining d_P

After the UE obtains d_P from the BS, the UE may transmit a UL signal to TRP2 1510 (1555). In this case, the UE may use p0, alpha, and closed-loop index among the transmission power parameters used in the above Process 1-1, and when PL, the d_P value obtained in the above Process 1-3 may be applied to the PL between TRP1 1505 and the UE and used (1560). In case that the UE operates in FR2, the UE may use the transmission beams used in the above Process 1-1 and the corresponding Process 1-4, which are the same or different. In case that the UE uses the same transmission beam in the above Process 1-1 and the corresponding Process 1-4, the BS does not need to compensate for the difference in the transmission beam gain value due to the change in the transmission beam at the UE when calculating the change amount in d_P in the subsequent process. However, in case that the UE uses different transmission beams in the above Process 1-1 and the corresponding Process 1-4, the BS may compensate for the difference in each transmission beam gain value in the subsequent process to increase the accuracy when calculating the change amount in the d_P value.

### Process 1-5: Calculation of a Difference in PL at a BS

Thereafter, TRP2 1510 may receive the UL transmission of the UE in the above Process 1-4 and calculate a reception power P2″ (1565). TRP2 1510 may compare the value obtained by subtracting the d_P value from P2 calculated in the above Process 1-2 (e.g., P2−d_P) with the P2″ value. In this case, the P2 is a reception power value calculated based on the transmission power parameter in which the difference value in PL is not considered, and the P2″ is a reception power value calculated by additionally applying the difference value in PL to the same transmission power parameter as when calculating the P2, so comparing the value obtained by subtracting the d_P value from P2 and P2″ may be the same as estimating the change amount in the d_P value. Through this, TRP2 1510 may calculate the d_P″ value, which is the change amount in the d_P value (1570). When calculating d_P″ in TRP2 1510 (1570), TRP2 1510 may consider a reception beam gain at TRP2 1410, and, when FR2, may consider each transmission beam gain considered by the UE when transmitting to TRP2 1510 and a maximum permissible exposure (MPE) value that may determine the transmission power reduction for each transmission beam. Thereafter, TRP2 1510 may update the previously calculated d_P value by considering d_P″ (1571, for example, d_P=d_P−d_P″), and may transfer the d_P″ value to TRP1 1505 (1575).

### Process 1-6: Transfer of a Difference in PL to the UE

The BS may calculate d_P″, which is the change amount in d_P, which is a difference between a PL between TRP1 1505 and the UE and a PL between TRP2 1510 and the UE, and then notify the UE of the corresponding value (1580). Through this process, the UE may obtain an updated d_P value compared to the previous one by applying the change amount in d_P value from the previously obtained d_P value (1585), and then, when transmitting UL for TRP2 1510, in addition to the PL that may be measured through the reference signal for PL measurement that may be received from TRP1 1505, the d_P value, which is the difference in PL, and the d_P″ value, which is the change amount in d_P value, may be applied to determine the UL transmission power for TRP2 1510.

Thereafter, the UE and the BS may repeat the above Process 1-4 to Process 1-6 to calculate and share the updated value for the d_P value. In above Process 1-6, the BS may process (for example, take the arithmetic mean) one or more d_P″ values calculated by repeating Process 1-4 and Process 1-5 one or more times and transfer them to the UE. That is, a single value obtained based on one or more d_P values may be transferred to the UE. In addition, TRP2 1510 may take the arithmetic mean one or more d_P″ values calculated by repeating Process 1-4 and Process 1-5 one or more times in Process 1-5 to update the d_P value. That is, the d_P value may be updated using one value obtained based on one or more d_P values.

In case that the UE performs the UL transmission as illustrated in the above Process 1-1, the UE may be configured to one or more SRS resources within an SRS resource set in which resourceType, which is higher layer signaling, is configured as periodic, semi-persistent, or aperiodic, and perform SRS transmission based on them, and all of these one or more SRS resources may have the same transmission power parameter. In case that the UE operates in FR1, the UE may apply the same transmission power parameter (e.g., p0, alpha, closed-loop index, and PL) to TRP1 1505 and TRP2 1510 based on one SRS resource within the SRS resource set, and even in case of a UL transmission for TRP2 1510, the difference value of the PL may not be applied when determining the transmission power as described above. In case that the UE operates in FR2, the UE may apply the same transmission power parameters (e.g., p0, alpha, closed-loop index, and PL) to TRP1 1505 and TRP2 1510 based on one or more SRS resources in the corresponding SRS resource set, and may apply different transmission beams to each SRS resource. Similarly, the UE may not apply the difference value of the PL when determining the transmission power as described above, even if it is a UL transmission for TRP2 1510.

In case that the UE performs the UL transmission illustrated in Process 1-4, the UE may be configured to one or more SRS resources in the SRS resource set in which resource Type, which is higher layer signaling, is configured as periodic, semi-persistent, or aperiodic, and perform the SRS transmission based on them, and all of these one or more SRS resources may have the same transmission power parameters.

In case that the UE performs both the UL transmission in the above Process 1-1 and the UL transmission in the above Process 1-4 based on SRS resources within an SRS resource set in which resourceType is configured as periodic or semi-persistent, the UE may assume that the period of the UL transmission for the above Process 1-1 is greater than or equal to the period of the UL transmission for the above Process 1-4. For example, if the period of the UL transmission for the above Process 1-1 is 10 slots and the period of the UL transmission for the above Process 1-4 is 2 slots, the UE does not need to consider the constraint that the transmission power parameter must be the same between respective transmission time points of the UL transmission for the above Process 1-1. Further, as described above, in case that transmissions for TRP1 1505 and TRP2 1510 are performed individually within each transmission time point of the UL transmission for the above Process 1-1, the UE may consider that the transmission power parameters are to be the same during transmission for the two TRPs. In addition, the UE may use the transmission power parameter used in the transmission period of the most recent UL transmission for the above Process 1-1 that was performed prior to the corresponding UL transmission, when the UL transmission for the above Process 1-4. For example, if the UE performs UL transmission for the above Process 1-1 in slot n and uses the first transmission power parameter set at that time, when UL transmission for the above Process 1-4 is performed from that corresponding slot to the next cycle, slot n+10, the first transmission power parameter set may be used, and as described above, the difference value of the PL described above may also be applied when performing UL transmission for the above Process 1-4. The reason for this is that in the above Process 1-4, when calculating d_P″ in TRP2 1510, since the P2 value, which is the received power calculated through the previous UL transmission, is considered, there must be a constraint that the transmission power parameter must be the same for the two UL transmissions, so that a more accurate d_P″ value may be calculated.

The UE may also perform the UL transmission illustrated in the above Process 1-1 and Process 1-4 for UL channels and signals other than SRS (for example, at least some of PUCCH, PUSCH, PRACH, and UL RS).

When the above Method 4 is performed, the UE may receive the d_P value from the BS at least once initially through the above Process 1-3, and may be notified of the d_P″ value from the BS through the above Process 1-6. In the above Method 4, since the UE may need to be configured by the BS for different UL transmissions for the above Process 1-1 and Process 1-4, signaling overhead for this may be added, but when considering the same quantization bit amount, the UE may have the advantage of receiving a more accurate value for the difference value of the PL by receiving the d_P″ value compared to receiving the d_P value from the BS.

Through the above-described Method 3 and Method 4, the UE may use the modified transmission power calculation formula as follows when determining the UL transmission power for the UL-only TRP.

For example, when determining the PUCCH transmission power for the UL-only TRP that supports only the UL reception operation, the UE may modify Equation (2) as in Equation (11) below, wherein PL_{off,b,f,c} (q_{d}*) in the following Equation 11 may be regarded as the d_P value, which is the difference in the PL, and q_{d}* may indicate that the corresponding difference in the PL corresponds to one or more PL measurement reference signals. The UE may consider q_{d}*=q_{d} in case that q_{d}* corresponds to one PL measurement reference signal.

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{0 \_ PUCCH , b , f , c} ( {q}_{u} ) + 10 {log}_{10} ( {2}^{μ} * {M}_{RB , b , f , c}^{PUCCH} ( i ) ) + \\ \begin{matrix}{PL}_{b , f , c} ( {q}_{d} ) + {PL}_{off , b , f , c} ( {q}_{d}^{*} ) + {Δ}_{F \_ PUCCH} ( F ) + \\ {Δ}_{TF , b , f , c} ( i ) + {f}_{b , f , c} ( i , l )\end{matrix}\end{matrix}\end{matrix} \} [ dBm ] \qquad ( 11 )$$

Alternatively, when determining PUSCH transmission power for UL-only TRP supporting only UL reception operation, the UE may modify Equation (4) as in Equation (12) or Equation (13) below, wherein PL_{off,b,f,c} (q_{d}*) may be regarded as the d_P value which is the difference in PL, and, q_{d}* may indicate that the corresponding difference in the PL corresponds to one or more PL measurement reference signals. The UE may consider q_{d}*=q_{d} in case that q_{d}* corresponds to one PL measurement reference signal. Equation (12) and Equation (13) may be distinguished depending on whether the value of PL_{off,b,f,c} (q_{d}*), which is the difference in PL, is directly applied to the PL.

$${P}_{PUSCH , b , f , c} ( i , j , {q}_{d} , l ) = min \{ \begin{matrix}{P}_{CMAX , f , c} ( i ) , \\ \begin{matrix}{P}_{0 \_ PUSCH , b , f , c} ( j ) + 10 {log}_{10} ( {2}^{μ} * {M}_{RB , b , f , c}^{PUSCH} ( i ) ) + \\ \begin{matrix}{α}_{b , f , c} ( j ) \cdot ( {PL}_{b , f , c} ( {q}_{d} ) + {PL}_{off , b , f , c} ( {q}_{d}^{*} ) ) + \\ {Δ}_{TF , b , f , c} ( i ) + {f}_{b , f , c} ( i , l )\end{matrix}\end{matrix}\end{matrix} \} [ dBm ] \qquad ( 12 )$$

$${P}_{PUSCH , b , f , c} ( i , j , {q}_{d} , l ) = min \{ \begin{matrix}{P}_{CMAX , f , c} ( i ) , \\ \begin{matrix}{P}_{0 \_ PUSCH , b , f , c} ( j ) + 10 {log}_{10} ( {2}^{μ} * {M}_{RB , b , f , c}^{PUSCH} ( i ) ) + \\ \begin{matrix}{α}_{b , f , c} ( j ) \cdot {PL}_{b , f , c} ( {q}_{d} ) + {PL}_{off , b , f , c} ( {q}_{d}^{*} ) + \\ {Δ}_{TF , b , f , c} ( i ) + {f}_{b , f , c} ( i , l )\end{matrix}\end{matrix}\end{matrix} \} [ dBm ] \qquad ( 13 )$$

Alternatively, when the UE determines the PUSCH transmission power for the UL-only TRP supporting only the UL reception operation, the UE may modify Equation (7) above as in Equation (14) or Equation (15) below, wherein PL_{off,b,f,c} (q_{d}*) may be regarded as the d_P value which is the difference in PL, and q_{d}* may indicate that the corresponding difference in the PL corresponds to one or more PL measurement reference signals. The UE may consider q_{d}*=q_{d} in case that q_{d}* corresponds to one PL measurement reference signal. Equation (14) and Equation (15) may be distinguished depending on whether the value of PL_{off,b,f,c} (q_{d}*), which is the difference in PL, is directly applied to the PL.

$${P}_{SRS , b , f , c} ( i , {q}_{s} , l ) = min \{ \begin{matrix}{P}_{CMAX , f , c} ( i ) , \\ \begin{matrix}{P}_{0 \_ SRS , b , f , c} ( {q}_{s} ) + 10 {log}_{10} ( {2}^{μ} * {M}_{SRS , b , f , c} ( i ) ) + \\ {α}_{SRS , b , f , c} ( {q}_{s} ) \cdot ( {PL}_{b , f , c} ( {q}_{d} ) + {PL}_{off , b , f , c} ( {q}_{d}^{*} ) ) + {h}_{b , f , c} ( i , l )\end{matrix}\end{matrix} \} [ dBm ] \qquad ( 14 )$$

$${P}_{SRS , b , f , c} ( i , {q}_{s} , l ) = min \{ \begin{matrix}{P}_{CMAX , f , c} ( i ) , \\ \begin{matrix}{P}_{0 \_ SRS , b , f , c} ( {q}_{s} ) + 10 {log}_{10} ( {2}^{μ} * {M}_{SRS , b , f , c} ( i ) ) + \\ {α}_{SRS , b , f , c} ( {q}_{s} ) \cdot {PL}_{b , f , c} ( {q}_{d} ) + {PL}_{off , b , f , c} ( {q}_{d}^{*} ) + {h}_{b , f , c} ( i , l )\end{matrix}\end{matrix} \} [ dBm ] \qquad ( 15 )$$

The UE may be notified of at least one combination of Method 3 and Method 4 from the BS through at least one combination of higher layer signaling, MAC-CE signaling, and L1 signaling, or may expect that at least one combination of Method 3 and Method 4 is fixedly defined in the standard. Additionally, in case that the UE is notified of a combination of specific one or more methods from the BS through at least one combination of higher layer signaling, MAC-CE signaling, and L1 signaling, it may indicate that the UE cannot support specific one or more other combinations of methods. For example, the UE may expect that Method 3 or Method 4 is fixedly defined in the standard for a method for obtaining and updating a difference in PL. Alternatively, the UE may be notified of the above Method 3 from the BS through a combination of at least one of higher layer signaling, MAC-CE signaling, and L1 signaling, and in this case, the UE may consider that the UE has been notified from the BS that the above Method 4 is not supported.

The UE may report to the BS whether it may support at least one combination of the above Method 3 and Method 4 as a UE capability. When the UE reports to the BS as a UE capability that a combination of specific one or more methods is supportable, it may be considered that the UE has reported that it cannot support specific one or more other combinations of methods. As an example, the UE may report to the BS whether it may support the above Method 3 or Method 4. Alternatively, the UE may report to the BS that it may support the above Method 3, and this UE capability report may indicate that the UE cannot support Method 4. Alternatively, the UE may report to the BS that it may support the above Method 4, and this UE capability report may indicate that the UE cannot support Method 3.

### Third Embodiment: Method for Updating a Difference Value of PL Between a UE and a BS

As an embodiment of the disclosure, a method for updating difference values of pathloss between a UE and a base station is described. This embodiment may be operated in combination with other embodiments.

In Process 3 and Process 6 of the above Method 3, and/or Process 1-3 of the above Method 4, the UE may receive a d_P value, which is a difference value between a PL between a UE and a TRP capable of both UL and DL operations and a PL between a UE and a UL-only TRP capable of only UL reception operations, from the BS. In addition, the UE may receive a d_P″ value, which is a change amount of the d_P, from the BS in Process 1-6 of the above Method 4. The d_P value or the d_P″ value may be any integer in dB units. For example, the UE may assume that a distance between the UE and the TRP capable of performing only UL reception operation is shorter than a distance between the UE and the TRP capable of performing both UL and DL operations, and based on this, the d_P value may only have a value less than or equal to 0, and the d_P″ value may be an integer. In case that the distance between the UE and the TRP capable of performing only UL reception operation is shorter than the distance between the UE and the TRP capable of performing both UL and DL operations, the d_P value may be an integer less than or equal to 0, and the d_P″ value may be an arbitrary integer. The UE may consider at least one combination of the following items as a method for receiving the difference value or the change amount of the PL from the BS in this way.

### Method 5

The UE may be configured to the d_P value, which is the difference value of the PL, or the d_P″ value, which is the change amount of the d_P value, from the BS through higher layer signaling. The UE may be configured to one or more d_P values, which are the difference value of the PL, or the d_P″ value, which is the change amount of the d_P value, for each BWP or each cell. For example, the UE may be configured to have as many d_P values or d_P″ values as four, which is the maximum number of PL measurement reference signals that may be tracked within a specific cell by the UE, through the higher layer signaling. Since the UE may receive the d_P value, which is the difference value of the PL, or the d_P″ value, which is the change amount of the d_P value, from the BS only through the higher layer signaling through the corresponding method, in case that RRC reconfiguration is not performed on the UE, the UE cannot change the corresponding configured value.

In case that the UE is configured to the d_P value, which is the difference value of the PL, or the d_P″ value, which is the change amount of the d_P value, through the higher layer signaling, as in the corresponding Method 5, the difference value of the PL between the UE and the BS may be configured semi-statically and may not be dynamically changed, which may be inflexible, and if the UE has mobility, the time interval for correcting the difference value of the PL may be very long. However, in case that the UE has a fixed location such as a CPE or has very low mobility, or in case that the information exchange between TRPs is very slow, this may be an effective method for determining the transmission power when transmitting UL to UL-only TRPs by reflecting the difference value of the PL while saving additional dynamic signaling.

### Method 6

The UE may be configured to the d_P value, which is the difference value of the PL, or the d_P″ value, which is the change amount in the d_P value, from the BS through higher layer signaling, and then, may receive MAC-CE signaling from the BS to update a preconfigured value. The UE may be configured to one or more d_P values, which is the difference value of the PL, or the d_P″ value, which is the change amount in the d_P value, for each BWP or each cell. For example, the UE may be configured to have as many d_P values or d_P″ values as four, which is the maximum number of PL measurement reference signals that the UE may track in a specific cell, through the higher layer signaling. The UE may consider at least one combination of the following items as information that may be included in the MAC-CE signaling. That is, the MAC-CE signaling may include at least one combination of the following items.
Serving cell ID field (e.g., 5 bits)
UL BWP ID field (e.g., 2 bits)
PL measurement reference signal ID field (e.g., 6 bits)
PL measurement reference signal group field (e.g., 2 bits)
Activated PL measurement reference signal ID field (e.g., 2 bits)
PL difference value d_P field (e.g., 5 to 8 bits)
PL difference value change amount d_P″ field (e.g., 5 to 8 bits)
Joint TCI state or UL TCI state field (e.g., 7 or 6 bits, respectively)

As a combination of MAC-CE signaling configuration information, in case that the UE is configured to one d_P value, which is a difference value of the PL, or one d_P″ value, which is a change amount of the d_P value, for each BWP through higher layer signaling, the UE may expect that the MAC-CE signaling includes a Serving cell ID field, a UL BWP ID field, a PL difference value d_P field, or/and a PL difference value change amount d_P″ field among the pieces of information. The UE may receive the corresponding MAC-CE signaling and update one d_P value, which is a difference value of the PL, or one d_P″ value, which is a change amount of the d_P value, configured in the BWP.

Alternatively, in case that the UE is configured to one d_P value, which is the difference value of the PL, or one d_P″ value, which is the variation of the d_P value, for each activated PL measurement reference signal within the cell, through higher layer signaling, the UE may expect that the MAC-CE signaling includes a Serving cell ID field, a UL BWP ID field, an activated PL measurement reference signal ID field, a PL difference value d_P field, or/and a PL difference value variation d_P″ field, among the pieces of information. The UE may receive the corresponding MAC-CE signaling to update one d_P value, which is the difference value of the PL, or one d_P″ value, which is the change amount of the d_P value, for each specific activated PL measurement reference signal within the cell.

The UE and BS additionally define a field indicating the d_P value or d_P″ value in the MAC-CE signaling that changes the PL measurement reference signal, so that in case that the UE receives the corresponding MAC-CE, the PL measurement reference signal may be changed and the corresponding d_P value or d_P″ value may be indicated at the same time.

After the UE receives the corresponding MAC-CE from the BS, 3 slots after the PUCCH transmission including HARQ-acknowledgement (HARQ-ACK) information for the PDSCH including the corresponding MAC-CE, the UE may update the d_P value, which is the difference value of the PL configured through the higher layer signaling, or the d_P″, which is the change amount of the d_P value, to the value received through the MAC-CE signaling, and apply the same when determining the UL transmission power.

In case that the UE updates the d_P value, which is the difference value of the PL, or the d_P″ value, which is the change amount of the d_P value, to the value received through the MAC-CE signaling as in the corresponding Method 6, the UE may update the difference value of the PL relatively dynamically in addition to the method for being configured semi-statically, so that it may be useful for compensating for the PL when determining the transmission power of the UE in case that the UE has mobility. However, as described above, the UE and BS need to define new MAC-CE signaling, the BS must be able to periodically measure the d_P value, which is the difference value of the PL, or the d_P″ value, which is the change amount of the difference value of the PL, and the delay time should not be large when exchanging information between TRPs.

### Method 7

The UE may be configured to the d_P value, which is the difference value of the PL, or the d_P″ value, which is the change amount of the d_P value, from the BS through higher layer signaling, and then be indicated through DCI. The UE may be configured to one or more d_P values, which is the difference value of the PL, or one or more the d_P″ value, which is the change amount of the d_P value, for each BWP or each cell. For example, the UE may be configured to have as many d_P values or d_P″ values as four, which is the maximum number of PL measurement reference signals that the UE may track within a specific cell, through higher layer signaling, and the UE may update one of the corresponding four d_P values or d_P″ values to a value received through DCI.

The UE receives a newly defined UE group common DCI, and an RNTI applicable to the corresponding DCI is additionally defined and the UE may be configured to the corresponding RNTI, and the UE may receive update information about the d_P value, which is the difference value of the PL, or the d_P″ value, which is the change amount of the d_P value, through the corresponding UE group common DCI.

The UE may be indicated with update information about the d_P value, which is the difference value of the PL, or the d_P″ value, which is the change amount of the d_P value, as a new field in the conventional UE-specific DCI (e.g., DCI format 0_1, 0_2, 0_3, 1_1, 1_2, or 1_3).

In case that the UE updates the d_P value, which is the difference value of the PL, or the d_P″ value, which is the change amount of the d_P value, through the DCI, a scheme similar to the TPC accumulation or absolute TPC may be used. In case that the UE uses a method such as the TPC accumulation when updating the d_P value, which is the difference value of the PL, or the d_P″ value, which is the change amount of the d_P value, through DCI, the UE may update the d_P value, which is the difference value of the PL configured through the higher layer signaling, by additionally adding the d_P″ value, which is the change amount of the d_P value, through DCI. In case that the UE uses a method such as the absolute TPC when updating the d_P value, which is the difference value of the PL, or the d_P″ value, which is the change amount of the d_P value, through DCI, the UE may replace the d_P value configured through the higher layer signaling with the d_P value received through DCI.

In case that the UE performs an update of the d_P value or d_P″ value through DCI, there may be cases where the UE fails to receive the DCI. Therefore, by defining a HARQ-ACK transmission operation for the corresponding DCI, the UE may report to the BS whether the DCI for updating the d_P or d_P″ value has been received according to the corresponding HARQ-ACK transmission operation. After 3 slots from a PUCCH transmission including HARQ-ACK information for the corresponding DCI, the d_P value, which is a difference value of the PL configured to the UE through the higher layer signaling or d_P″, which is a change amount of the d_P value, is updated to a value received through the DCI and may be applied when determining the UL transmission power. In another scheme, the UE may update the d_P value, which is the difference value of the PL configured to the UE through the higher layer signaling after a certain time from the HARQ-ACK information, or the d_P″ value, which is the change amount of the d_P value, with the value received through DCI and apply the updated value when determining the UL transmission power, and the certain time may be reported as the UE capability.

In case that the UE updates the d_P value, which is the difference value of the PL, or the d_P″ value, which is the change amount of the d_P value, using the value received through DCI signaling as in the corresponding Method 7, the UE may update the dynamic PL difference value based on DCI in addition to the method for configuring it semi-statically. Thus, when the UE has mobility, it may be useful for compensating for the PL between the UL-only TRP and the UE when determining the transmission power of the UE. However, as described above, the UE and BS may need to define additional fields in the DCI, which may result in increased DCI overhead, and the BS may need to periodically measure the d_P value, which is the difference in PL, or the d_P″ value, which is the change amount of the difference in PL, and the delay time may not be large when exchanging information between TRPs.

### Method 8

The UE may be configured to the d_P value, which is the difference value of the PL, or the d_P″ value, which is the change amount of the d_P value, from the BS through higher layer signaling, and thereafter, receives two or more CSI-RSs from the BS and implicitly receives the d_P or d_P″ value through the difference in reception power of the corresponding CSI-RSs. The UE may be configured to one or more d_P values, which is the difference value of the PL, or one or more the d_P″ value, which is the change amount of the d_P value, for each BWP or each cell. For example, the UE may be configured to have as many d_P values or d_P″ values as four, which is the maximum number of PL measurement reference signals that the UE may track within a specific cell, through the higher layer signaling, and the UE may receive CSI-RSs assuming different transmission powers from the BS to receive an updated value from the BS for one of the corresponding four d_P values or d_P″ values, and may implicitly identify the d_P or d_P″ value by using the difference in the reception power. To this end, the UE may be configured to CSI-RS resources for updating the corresponding values according to the number of d_P value, which is the difference value of the PL configured through the higher layer signaling, or d_P″ value, which is the change amount of the d_P value.

In case that the UE updates the d_P value, which is the difference value of the PL, or the d_P″ value, which is the change amount of the d_P value, by using the difference in the reception power values for different CSI-RS resources configured with different transmission power as in the corresponding Method 8, the UE may update the dynamic PL difference value based on DCI in addition to the method for configuring it semi-statically, so that in case that the UE has mobility, it may be useful for compensating for the PL between the UL-only TRP and the UE when determining the transmission power of the UE, and the accuracy of information may be improved in that the unquantized d_P or d_P″ value may be transferred to the UE through the difference between the transmission powers of the CSI-RS resources in case that no interference signal exists. However, since the UE must define CSI-RS resources in which different transmission powers are assumed to update the d_P value or d_P″ value, and the difference between the transmission powers of the corresponding CSI-RS resources may also vary depending on the d_P or d_P″ value calculated by the BS, overhead at the BS may increase.

### Method 9

The UE may receive the d_P or d_P″ value from the BS through at least one combination of Method 5 to Method 8 and update the preconfigured value. In this case, the BS may notify the UE to update the preconfigured or already activated value by transferring the d_P or d_P″ value in case that a specific event defined in the BS occurs. The corresponding specific event possible at the BS is, for example, in case that the d_P or d_P″ value calculated by the above Method 3 and/or Method 4 changes by a specific ratio or more compared to the previously calculated d_P or d_P″ value (e.g., in case of decreasing or increasing by 10% or more), the BS may transfer the newly calculated d_P or d_P″ value to the UE to update it. The UE may be configured to a timer from the BS. In case that the BS does not update the d_P value, which is the difference value of the PL, or the d_P″ value, which is the change amount of d_P, within the time defined by the corresponding timer (within the time the timer is running), the UE may perform at least one combination of the following:

The UE may request the BS to update the d_P or d_P″ value.

The UE may perform UL transmission to the BS without applying the d_P or d_P″ value.

The UE may perform UL transmission to the BS by applying the d_P value or d_P″ value that was initially received from the BS.

The UE may determine that the situation is a radio link failure and request the BS to reconfigure higher layer signaling (RRC reconfiguration).

The UE may be notified of at least one combination of the above Method 5 to Method 9 from the BS through at least one combination of higher layer signaling, a MAC-CE signaling, and an L1 signaling, or may expect that at least one combination of the above Method 5 to Method 9 is fixedly defined in the standard. Additionally, in case that the UE is notified of a combination of specific one or more methods from the BS through at least one combination of the higher layer signaling, the MAC-CE signaling, and the L1 signaling, it may indicate that the UE cannot support specific one or more other combinations of methods. For example, the UE may expect that the above Method 6 is fixedly defined in the standard for the update method for the difference value of the PL. Alternatively, the UE may be notified of the above Method 5 by a combination of at least one of the higher layer signaling, the MAC-CE signaling, and the L1 signaling from the BS, and in this case, the UE may consider that the UE has been notified by the BS that the above Method 6 is not supported.

The UE may report to the BS whether it may support at least one combination of the above Method 5 to Method 9 as a UE capability. In this case, in case that the UE reports to the BS as a UE capability that a combination of specific one or more methods is supportable, it may be considered that the UE has reported that it cannot support specific one or more other combinations of methods. As an example, the UE may report to the BS whether it may support the above Method 5 or Method 6. Alternatively, the UE may report to the BS that it may support the above Method 5, and this UE capability report may indicate that the UE cannot support Method 6. Alternatively, the UE may report to the BS that it may support the above Method 6, and this UE capability report may indicate that the UE cannot support Method 5.

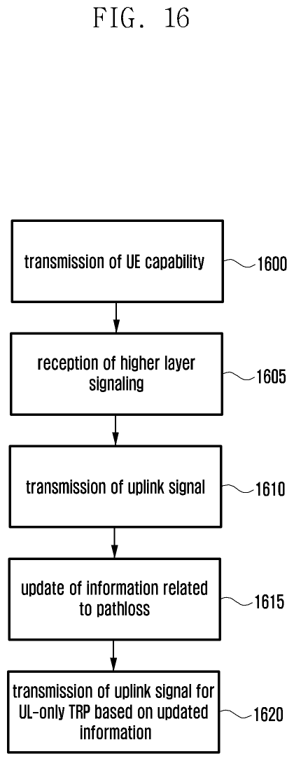

FIG. 16 illustrates an operation of a UE for UL transmission power control according to an embodiment.

In step 1600, the UE may transmit UE capabilities to the BS. In this case, UE capability signaling that may be reported may be a combination of at least one of UE capability related to UL signal (e.g., PUSCH, PUCCH, SRS) transmission and transmission power parameters, UE capability related to unified TCI state operation, and UE capability corresponding to the above Method 3 and Method 4, Method 5 to Method 9. The operation 1600 may also be omitted.

In step 1605, the UE may receive higher layer signaling from the BS according to the reported UE capability. In this case, the UE may define, by the BS, higher layer parameters for at least one combination of the higher layer signaling related to UL signal transmission (e.g., PUSCH, PUCCH, SRS) and transmission power parameters, the higher layer signaling related to unified TCI state operation, and the higher layer signaling related to support of the above Method 3 and Method 4, Method 5 to Method 9, and use one of them.

In step 1610, the UE may transmit a UL signal to the BS. In this case, the UE may perform a method for transmitting the corresponding UL signal through at least one combination of the above Method 3 and Method 4.

In step 1615, the UE may be notified of signaling indicating update of PL information from the BS. In this case, the UE may receive a signaling from the BS indicating an update of the PL related information using at least one combined method among the above Method 5 to Method 9.

In operations 1620, the UE may perform UL transmission for UL-only TRP based on the updated PL related information.

The above-described flowchart illustrates an exemplary method that may be implemented according to the principles of the disclosure, and various changes may be made to the method illustrated in the flowchart in the present specification. For example, although illustrated as a series of operations, various operations in each drawing can overlap, occur in parallel, occur in different orders, or occur multiple times. In other examples, operations can be omitted or replaced with other operations.

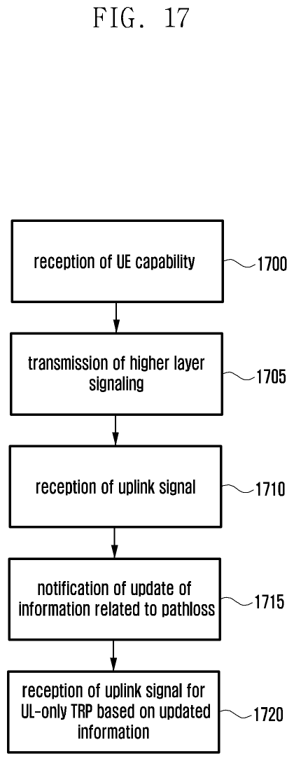

FIG. 17 illustrates an operation of a BS for UL transmission power control according to an embodiment.

In step 1700, a BS may receive UE capability from a UE. In this case, the UE capability signaling that may be received from the BS may be a combination of at least one of UE capability related to UL signal (e.g., PUSCH, PUCCH, SRS) transmission and transmission power parameters, UE capability related to unified TCI state operation, and UE capability corresponding to the above Method 3 and Method 4, Method 5 to Method 9. The above operation 1700 may be omitted.

In step 1705, the BS may transmit higher layer signaling to the UE according to the UE capability reported by the UE. In this case, the UE may define, by the BS, higher layer parameters for at least one combination of higher layer signaling related to UL signal (e.g., PUSCH, PUCCH, SRS) transmission and transmission power parameters, higher layer signaling related to unified TCI state operation, and higher layer signaling related to support of the above Method 3 and Method 4, Method 5 to Method 9, and use one of them.

In step 1710, the BS may receive a UL signal from the UE. In this case, the BS may expect that the UE performs a method for transmitting the corresponding UL signal through at least one combination of the above Method 3 and Method 4.

In step 1715, the BS may transmit signaling indicating the UE to update information related to PL. In this case, the BS may transmit a signaling indicating the UE to update the PL related information using at least one combined method among the above Method 5 to Method 9.

In step 1720, the BS may expect that the UE performs UL transmission for UL-only TRP based on the updated PL related information, and may receive the same.

The above-described flowchart illustrates an exemplary method that can be implemented according to the principles of the disclosure, and various changes can be made to the method illustrated in the flowchart in the present specification. For example, although illustrated as a series of operations, various operations in each drawing can overlap, occur in parallel, occur in different orders, or occur multiple times. In other examples, operations can be omitted or replaced with other operations.

### Fourth Embodiment: UL Scheduling Method Based on PL Difference Value

As an embodiment of the disclosure, a method for scheduling uplink transmission for UL-only TRP by indicating a pathloss difference value to a UE is described. This embodiment may be combined with other embodiments.

In the disclosure, the PL difference value may be referred to as PL offset or PL offset.

As described above, the UE may be configured to the PL difference value from the BS through higher layer signaling. Since the UE cannot receive a PL measurement reference signal from the UL-only TRP, the UE may not directly measure the PL between the UE and the UL-only TRP. Therefore, the UE may indirectly calculate the PL from the UL-only TRP by applying the PL difference value to the PL value calculated based on the PL measurement reference signal received from the TRP capable of both UL and DL operations. The UE may receive a UL scheduling from the BS, and may distinguish whether the UL scheduling is a transmission for a UL-only TRP or a transmission for a TRP capable of both UL and DL operations based on information included in the corresponding UL scheduling. In this case, information related to a difference value of PLes may be included in the corresponding UL scheduling. In this way, a method for a UE to receive a UL scheduling including information related to a difference value of PLes from a BS may consider a combination of at least one of the following items.

### Method 10

The UE may be configured to one or more joint TCI states or UL TCI states from the BS through higher layer signaling, and in this case, as shown in Table 30 below, the UE may be configured to information about the difference value of PL within one or more joint TCI states or UL TCI states. The name of RRC information element (IE) in Table 30 may be expressed by other names.

TABLE 30
TCI-State ::= SEQUENCE {

| tci-StateId | TCI-StateId, | |
|---|---|---|
| qcl-Type1 | QCL-Info, | |
| qcl-Type2 | QCL-Info | OPTIONAL, -- Need R |

```
  ...,
  [[
```

| | | |
|---|---|---|
| additionalPCI-r17 | AdditionalPCIIndex-r17 | OPTIONAL, -- Need R |

| | |
|---|---|
| pathlossReferenceRS-Id-r17 | PathlossReferenceRS-Id-r17 OPTIONAL, -- Cond |

JointTCI1

| | | |
|---|---|---|
| ul-powerControl-r17 | Uplink-powerControlId-r17 | OPTIONAL -- Cond |

JointTCI
]]

| | | |
|---|---|---|
| pathlossOffset | INTEGER (Xs..Xe) | OPTIONAL -- Cond ULonlyNode |

}
TCI-UL-State-r17 ::= SEQUENCE {

| tci-UL-StateId-r17 | TCI-UL-StateId-r17, | |
|---|---|---|
| servingCellId-r17 | ServCellIndex | OPTIONAL, -- Need R |
| bwp-Id-r17 | BWP-Id | OPTIONAL, -- Cond CSI-RSorSRS- |

Indicated
referenceSignal-r17 CHOICE {

| | |
|---|---|
| ssb-Index-r17 | SSB-Index, |
| csi-RS-Index-r17 | NZP-CSI-RS-ResourceId, |
| srs-r17 | SRS-ResourceId |

},

| additionalPCI-r17 | AdditionalPCIIndex-r17 | OPTIONAL, -- Need R |
|---|---|---|
| ul-powerControl-r17 | Uplink-powerControlId-r17 | OPTIONAL, -- Need R |
| pathlossReferenceRS-Id-r17 | PathlossReferenceRS-Id-r17 OPTIONAL, -- Cond | |
| Mandatory | | |
| pathlossOffset | INTEGER (Xs..Xe) | OPTIONAL -- Cond ULonlyNode |

}

In Table 30 above, the UE may be configured to pathlossOffset through higher layer signaling for the difference value of the PL, and the value may be an integer from Xs to Xe. For example, Xs and Xe may be 0 and 30, respectively. That is, pathlossOffset may be a natural number including 0 (or an integer greater than or equal to 0, a non-negative integer), and its value may be in units of 1 dB. That is, pathlossOffset may be an integer greater than or equal to 0 and less than or equal to 30. The reason why negative values of pathlossOffset are not considered is because when the UE considers a plurality of UL-only TRPs, it is assumed that a distance between the UE and the UL-only TRP is closer than a distance between the UE and the TRPs capable of operating in UL and downlink, and thus, a higher reception signal quality may be assumed when receiving from the UL-only TRP during UL transmission of the UE.

Alternatively, Xs and Xe may be −10 and 50, respectively. That is, pathlossOffset may be an integer that includes positive and negative numbers, and its value may be in units of 1 dB. That is, pathlossOffset may be an integer greater than or equal to −10 and less than or equal to 50. The reason why pathlossOffset may consider even negative numbers is because when the UE considers the plurality of UL-only TRPs, the distance between the UE and some UL-only TRPs is considered to be longer than the distance between the UE and the TRPs capable of operating in UL and downlink, so that even if the UE receives low reception signal quality in some UL-only TRPs during UL transmission, if the same signal is received in the plurality of UL-only TRPs, the diversity effect may be obtained.

Alternatively, Xs and Xe may be 2 and 32, respectively, and their values may be in units of 2 dB. That is, pathlossOffset may be one of 2, 4, 6, 8, . . . , 32. The range and unit of such values may be borrowed from the range and unit of the differential reference signal received power (RSRP) value that the UE may report to the BS. When the UE reports L1-RSRP, which is one of the channel state information that may indicate the strength of the received signal, the largest value of the L1-RSRP corresponding to the number of values configured to the UE through the higher layer signaling may be quantized into 7 bits and reported in the range of −140 dBm to 44 dBm in units of 1 dB, and one or more L1-RSRP values smaller than that may be reported by calculating them as differential RSRP that may be expressed as the difference value with respect to the largest value. In this case, the differential RSRP value may be quantized into 4 bits and the range of the value may be reported in the range of 2 dB to 32 dB in units of 2 dB. The PL is calculated as the difference between the RSRP value calculated by the UE and the transmission power value of the reference signal that may be received from the BS for calculating the corresponding PL. If the differential value of the PL is calculated, the range and unit of the differential RSRP value may be reused.

ULonlyNode may be defined as a condition for the pathlossOffset to be configured by the BS in the joint TCI state or UL TCI state for the UE. The condition ULonlyNode may indicate that the UE operates in a cell including the UL-only TRP, which may indicate when a specific higher layer signaling is configured. That is, the UE may be optionally configured to the pathlossOffset in case that a specific higher layer signaling is configured. The name of this condition ULonlyNode is only an example and may be expressed by other names. In case that the UE is not configured to the pathlossOffset in the joint TCI state or UL TCI state, the UE may consider the difference value of the PL as 0.

The UE may be indicated with one or more TCI states among the joint TCI state or UL TCI state configured as in the above Table 30 from the BS as a TCI state field in the DCI. In this case, in case that the UE receives the joint TCI state or UL TCI state in which the pathlossOffset is configured, and receives scheduling information from the BS to perform UL transmission by applying the corresponding joint TCI state or UL TCI state, the UE may consider the corresponding UL transmission to be a transmission for UL-only TRP. When calculating the transmission power for the corresponding UL transmission, the UE may calculate the PL between the UE and the UL-only TRP by applying the difference value of the PL indicated by the pathlossOffset value configured in the corresponding joint TCI state or UL TCI state, in addition to the PL measured through the PL measurement reference signal (e.g., pathlossReferenceRS-Id-r17 in Table 30 above) configured in the corresponding joint TCI state or UL TCI state. In this case, it may be assumed that the UE has received the PL measurement reference signal (e.g., pathlossReferenceRS-Id-r17 in Table 30 above) from a TRP capable of operating in both UL and downlink.

When using Method 10 above, the UE may be configured to different PL difference values by the BS for each TCI state, so that even if the same PL reference signal is configured in each TCI state using different TCI states, the UE may calculate different PLes by using the different PL difference values configured in each TCI state. Through the corresponding method, the UE may easily use a plurality of PL difference values in case that one or more UL-only TRPs are installed in the network to which the UE is connected. However, in case that the UE uses the corresponding method, the number of PL difference values that the UE and BS must manage increases, and since the update for this must be supported for each TCI state, a lot of signaling overhead may be consumed.

### Method 11

The UE may be configured to one or more joint TCI states or UL TCI states through higher layer signaling from the BS, and the UE may be configured to one or more difference values of PL in BWP-UplinkDedicated, which is higher layer signaling for UL BWP, and each difference value of PL may be connected to one or more groups of PL measurement reference signals. In addition, the UE may be additionally configured to higher layer signaling, which indicates whether to apply the difference value of PL, in the joint TCI state or UL TCI state, in addition to the PL measured through the PL measurement reference signal that may be configured through higher layer signaling. Table 31 below is one example that may express the above method, and the connection between the difference values of PL and the groups of PL measurement reference signals may not be limited thereto. The names of RRC IEs in Table 31 are only examples and may be expressed by other names.

TABLE 31
BWP-UplinkDedicated ::= SEQUENCE {
...
pathlossReferenceRSToAddModList-r17 SEQUENCE

| | |
|---|---|
| | (SIZE (1..maxNrofPathlossReferenceRSs-r17)) OF |
| PathlossReferenceRS-r17 | OPTIONAL, -- Need N |

pathlossReferenceRSToReleaseList-r17 SEQUENCE

| | |
|---|---|
| | (SIZE (1..maxNrofPathlossReferenceRSs-r17)) OF |
| PathlossReferenceRS-Id-r17 | OPTIONAL -- Need N |
| pathlossOffsetList | SEQUENCE (SIZE (1.. |

maxNrofPathlossReferenceRSGroup-r19)) OF PathlossReferenceRSGroup-r19
OPTIONAL -- Need R
}
PathlossReferenceRSGroup ::= SEQUENCE {

| | |
|---|---|
| PathlossReferenceRSGroupId | INTEGER (1..maxNrofPathlossReferenceRSGroup- |

r19))

| | |
|---|---|
| pathlossOffset | INTEGER (Xs..Xe) |
| pathlossReferenceRSList | SEQUENCE (SIZE |

(1..maxNrofPathlossReferenceRSsPerGroup-r19)) OF PathlossReferenceRS-Id-r17
}
TCI-State ::= SEQUENCE {

| tci-StateId | TCI-StateId, | |
|---|---|---|
| qcl-Type1 | QCL-Info, | |
| qcl-Type2 | QCL-Info | OPTIONAL, -- Need R |

```
    ...,
    [[
```

| | | |
|---|---|---|
| additionalPCI-r17 | AdditionalPCIIndex-r17 | OPTIONAL, -- Need R |

| | |
|---|---|
| pathlossReferenceRS-Id-r17 | PathlossReferenceRS-Id-r17 OPTIONAL, -- Cond |

JointTCI1

| | | |
|---|---|---|
| ul-powerControl-r17 | Uplink-powerControlId-r17 | OPTIONAL -- Cond |

JointTCI
]]

| | | |
|---|---|---|
| enablePathlossOffset | ENUMARATE{enabled} | OPTIONAL -- Cond |

ULonlyNode1
}
TCI-UL-State-r17 ::= SEQUENCE {

| tci-UL-StateId-r17 | TCI-UL-StateId-r17, | |
|---|---|---|
| servingCellId-r17 | ServCellIndex | OPTIONAL, -- Need R |
| bwp-Id-r17 | BWP-Id | OPTIONAL, -- Cond CSI-RSorSRS- |

Indicated
referenceSignal-r17 CHOICE {

| | |
|---|---|
| ssb-Index-r17 | SSB-Index, |
| csi-RS-Index-r17 | NZP-CSI-RS-ResourceId, |
| srs-r17 | SRS-ResourceId |

},

| | | |
|---|---|---|
| additionalPCI-r17 | AdditionalPCIIndex-r17 | OPTIONAL, -- Need R |
| ul-powerControl-r17 | Uplink-powerControlId-r17 | OPTIONAL, -- Need R |

| | |
|---|---|
| pathlossReferenceRS-Id-r17 | PathlossReferenceRS-Id-r17 OPTIONAL, -- Cond |

Mandatory

| | | |
|---|---|---|
| enablePathlossOffset | ENUMARATE{enabled} | OPTIONAL -- Cond |

ULonlyNode1
}

In Table 31 above, the UE may be configured to a plurality of higher layer signaling, pathlossReferenceRSGroup-r19s, in BWP-UplinkDedicated corresponding to the UL BWP, and may configure pathlossOffsetList through this. Each pathlossReferenceRSGroup may include pathlossReferenceRSGroupId which may indicate the ID of the corresponding pathlossReferenceRSGroup, pathlossOffset which may indicate the difference value of PL that may be applied to one or more PL measurement reference signals included in the corresponding pathlossReferenceRSGroup, and pathlosReferenceRSList which may indicate the list of one or more PL measurement reference signals in included the corresponding pathlossReferenceRSGroup. In this case, the UE may consider the following items regarding the higher layer signaling, pathlossOffset.
The UE may be configured to pathlossOffset, which is higher layer signaling for the difference value of the PL, and the value may be an integer from Xs to Xe.
For example, Xs and Xe may be 0 and 30, respectively. That is, pathlossOffset may be a natural number including 0 (or an integer greater than or equal to 0, a non-negative integer), and its value may be in units of 1 dB. That is, pathlossOffset may be an integer greater than or equal to 0 and less than or equal to 30. The reason why negative values of pathlossOffset are not considered is because when the UE considers a plurality of UL-only TRPs, it is assumed that a distance between the UE and the UL-only TRP is closer than a distance between the UE and the TRPs capable of operating in UL and downlink, and thus a higher reception signal quality may be assumed when receiving from the UL-only TRP during UL transmission of the UE.
Alternatively, Xs and Xe may be −10 and 50, respectively. That is, pathlossOffset may be an integer that includes positive and negative numbers, and its value may be in units of 1 dB. That is, pathlossOffset may be an integer greater than or equal to −10 and less than or equal to 50. The reason why the pathlossOffset value may consider even negative numbers is that when the UE considers a plurality of UL-only TRPs, a distance between the UE and some UL-only TRPs may be longer than a distance between the UE and the TRPs capable of operating in UL and downlink, so that even if the UE receives low reception signal quality in some UL-only TRPs during UL transmission, if the same signal is received in the plurality of UL-only TRPs, the diversity effect can be obtained.
Alternatively, Xs and Xe may be 2 and 32, respectively, and their values may be in units of 2 dB. That is, pathlossOffset may be one of 2, 4, 6, 8, . . . , 32. The range and unit of such values may be borrowed from the range and unit of differential RSRP values that the UE may report to the BS. When the UE reports L1-RSRP, which is one of the channel state information that may indicate the strength of the received signal, the largest value of the L1-RSRP corresponding to the number of values configured to the UE through the higher layer signaling may be quantized into 7 bits and reported in the range from −140 dBm to 44 dBm in units of 1 dB, and one or more L1-RSRP values smaller than that may be calculated and reported as differential RSRP that may be expressed as a difference value compared to the largest value, and in this case, the differential RSRP value may be quantized into 4 bits and the range of the value may be reported in the range from 2 dB to 32 dB in units of 2 dB. The PL is calculated by calculating the difference between the RSRP value calculated by the UE and the transmission power value of the reference signal that may be received from the BS for calculating the corresponding PL. If the difference value of the PL is calculated, the range and unit of the differential RSRP value may be reused.

In Table 31 above, the UE may be configured to a higher layer signaling, enablePathlossOffset, in the joint TCI state or the UL TCI state. enablePathlossOffset may be configured to the UE by the BS under the condition of ULonlyNode1, and in this case, ULonlyNode1 may indicate when at least one of the higher layer signaling, pathlossReferenceRSGroup, is configured, or when a specific higher layer signaling, which means that it operates with multiple TRPs including UL-only TRP, is configured to the UE. The name of this condition ULonlyNode1 is only an example and may be expressed by another name. In addition, the UE may consider a condition, such as Need R, when a condition such as ULonlyNode1 does not exist for the enablePathlossOffset. The higher layer signaling, enablePathlossOffset, may have a value of enabled. When the UE is configured to the higher layer signaling, enablePathlossOffset, as enabled in the joint TCI state or UL TCI state in Table 31 above, the UE may determine or calculate the final PL by applying the pathlossOffset configured in the pathlossReferenceRSGroup that includes the PL measurement reference signal (e.g., pathlossReferenceRS-Id-r17) configured in the same joint TCI state or UL TCI state, in addition to the PL measured through the PL measurement reference signal. The name of the above condition ULonlyNode1 is only an example and may be expressed by other names. In case that the UE is not configured to the enablePathlossOffset in the joint TCI state or the UL TCI state, the UE may consider the difference value of the PL's as 0, or may consider the pathlossOffset configured in the pathlossReferenceRSGroup as not being applied to the PL measurement reference signal (e.g., pathlossReferenceRS-Id-r17) indicated through the corresponding TCI state. For example, the UE may be configured with up to 64 PL measurement reference signals per cell through the higher layer signaling, but may track up to 4 of the PL measurement reference signals, and therefore the number of the above-mentioned pathlossReferenceRSGroup may be up to 4.

In case of using the above Method 11, in case that more than one UL-only TRP is installed in the network to which the UE is connected, the UE may easily use the difference values of the plurality of PLes by using different pathlossReferenceRSGroups, and since the update of the difference values of the above-described PL's is also possible for each pathlossReferenceRSGroup, the management thereof can be easy. However, the UE needs to newly configure higher layer signaling called pathlossReferenceRSGroup with the BS.

### Method 12

The UE may be configured with one or more joint TCI states or UL TCI states as higher layer signaling from the BS, and the UE may be configured with one difference value of PL in BWP-UplinkDedicated, which is higher layer signaling for the UL BWP. In this case, the UE may assume that the difference value of PL is always applied to a specific TCI state depending on a method for the UE to operate in multiple TRPs. For example, in case that the UE operates in multiple TRPs based on the multi-DCI scheme, the UE does not apply the difference value of the PL to the TCI state indicated through the DCI transmitted to the UE within the CORESET in which the higher layer signaling, coresetPoolIndex, is configured to 0, and, for the TCI state indicated through the DCI transmitted to the UE within the CORESET in which the higher layer signaling, coresetPoolIndex, is configured to 1, the UE may determine the final PL by applying the difference value of the configured PL to the PL calculated using the pathlossReferenceRS-Id-r17 indicated through the corresponding TCI state. Alternatively, in case that the UE operates in multi-TRP based on the single-DCI scheme, the UE does not apply the difference value of the PL to the first TCI state (or UL TCI state) among the two TCI states (or UL TCI states) indicated through the DCI, and applies the difference value of the configured PL to the PL calculated using pathlossReferenceRS-Id-r17 indicated through the corresponding TCI state (or UL TCI state) for the second TCI state (or UL TCI state) to determine the final PL. Table 32 below may be one example that may express the above method, and may not be limited thereto. The names of the RRC IEs in Table 32 are only examples and may be expressed by other names.

TABLE 32
BWP-UplinkDedicated ::= SEQUENCE {
...
pathlossReferenceRSToAddModList-r17 SEQUENCE

| | |
|---|---|
| | (SIZE (1..maxNrofPathlossReferenceRSs-r17)) OF |
| PathlossReferenceRS-r17 | OPTIONAL, -- Need N |

pathlossReferenceRSToReleaseList-r17 SEQUENCE

| | (SIZE (1..maxNrofPathlossReferenceRSs-r17)) OF | |
|---|---|---|
| PathlossReferenceRS-Id-r17 | OPTIONAL -- Need N | |
| pathlossOffset | INTEGER (Xs..Xe) | OPTIONAL -- Cond |

ULonlyNode2
}

For the UE, ULonlyNode2 may be defined as a condition for which the pathlossOffset may be configured from the BS in BWP-UplinkDedicated that is the higher layer signaling. The condition ULonlyNode2 may indicate that the UE operates in a cell including UL-only TRP, which may indicate when a specific higher layer signaling is configured. In other words, the UE may be optionally configured to the pathlossOffset in case that a specific higher layer signaling is configured. The name of this condition ULonlyNode2 is only an example and may be expressed by another name. In addition, the UE may consider a condition such as Need R without a condition such as ULonlyNode2 for the pathlossOffset. In case that the UE is not configured to the pathlossOffset in BWP-UplinkDedicated, the UE may consider the difference value of the PL as 0.

In this case, the UE may consider the following items for pathlossOffset that is the higher layer signaling.

The UE may be configured to pathlossOffset as higher layer signaling for the difference value of the PL, and the value may be an integer from Xs to Xe.

For example, Xs and Xe may be 0 and 30, respectively. That is, pathlossOffset may be a natural number including 0 (or an integer greater than or equal to 0, a non-negative integer), and its value may be in units of 1 dB. That is, pathlossOffset may be an integer greater than or equal to 0 and less than or equal to 30. The reason why negative values of pathlossOffset are not considered is because when the UE considers a plurality of UL-only TRPs, it is assumed that a distance between the UE and the UL-only TRP is closer than a distance between the UE and the TRPs capable of operating in UL and downlink, and thus a higher reception signal quality may be assumed when receiving from the UL-only TRP during UL transmission of the UE.

Alternatively, Xs and Xe may be −10 and 50, respectively. That is, pathlossOffset may be an integer that includes positive and negative numbers, and its value may be in units of 1 dB. That is, pathlossOffset may be an integer greater than or equal to −10 and less than or equal to 50. The reason why pathlossOffset can consider even negative numbers is because when the UE considers the plurality of UL-only TRPs, the distance between the UE and some UL-only TRPs is considered to be longer than the distance between the UE and the TRPs capable of operating in UL and downlink, so that even if the UE receives low reception signal quality in some UL-only TRPs during UL transmission, if the same signal is received in the plurality of UL-only TRPs, the diversity effect may be obtained.

Alternatively, Xs and Xe may be 2 and 32, respectively, and their values may be in units of 2 dB. That is, pathlossOffset may be one of 2, 4, 6, 8, . . . , 32. The range and unit of such values may be borrowed from the range and unit of differential RSRP values that the UE may report to the BS. When the UE reports L1-RSRP, which is one of the channel state information that may indicate the strength of the received signal, the largest value of the L1-RSRP corresponding to the number of values configured by the higher layer signaling to the UE may be quantized into 7 bits and reported in the range from −140 dBm to 44 dBm in units of 1 dB, and one or more L1-RSRP values smaller than that may be calculated and reported as differential RSRP that may be expressed as a difference value with respect to the largest value, and in this case, the differential RSRP value may be quantized into 4 bits and the range of the value may be reported in the range from 2 dB to 32 dB in units of 2 dB. The PL is calculated by calculating the difference between the RSRP value calculated by the UE and the transmission power value of the reference signal that may be received from the BS for calculating the corresponding PL. If the difference value of the PL is calculated, the range and unit of the differential RSRP value may be reused.

In case of using the above Method 12, the existing TCI state structure may be reused because information related to the difference value of the PL is not included in the TCI state. However, in case that the UE uses the above Method 12, in case that there are a plurality of TRPs capable of UL and DL operations in the cell to which the UE is connected, and there are the plurality of TRPs capable of only UL reception operations, the UE assumes that the difference value of the PL is always applied to a specific TCI state (for example, in the multi-DCI-based multi-TRP operation, it may be a TCI state indicated through DCI transmitted from a CORESET in which coresetPoolIndex is configured to 1, or a second TCI state (or UL TCI state) indicated through DCI in the single-DCI-based multi-TRP operation). Therefore, the UE may not be able to dynamically switch between scheduling that uses two different TRPs capable of UL and DL operations and scheduling that includes at least one TRP capable of only UL reception operations when performing the UL multi-TRP operation from the BS. That is, it may be assumed that the UE is quasi-statically connected to a TRP capable of UL reception operations within the corresponding cell and operates therein. In case that one or more UL-only TRPs are installed in the network to which the UE is connected, a scheme for configuring the difference value of one PL as in Method 12 above may not be appropriate.

### Method 13

The UE may be configured to one difference value of PL from the BS through higher layer signaling. The configuration for the difference value of the corresponding PL may be different for each BWP, and may be different for each cell and the same value may be configured for all BWPs in the cell. In this case, the UE may expect that a new field indicating whether to apply the difference value of the PL is included in the DCI in case that the difference value of the PL is configured. Through the corresponding new field in the DCI, the UE may distinguish whether the UL transmission is for a UL-only TRP or a UL transmission for a TRP capable of both UL and DL operations from the BS through the DCI. The corresponding new field may be 1 bit, and if its value is 1 (or 0), the difference value of the PL may be applied when determining the PL within the transmission power for the corresponding UL transmission, and the corresponding UL transmission may be considered for the UL-only TRP, and if its value is 0 (or 1), the difference value of the PL may be not applied for the corresponding UL transmission, and the corresponding UL transmission may be considered for the TRP that may operate both in the UL and downlink. Alternatively, if the corresponding new field is included in the DCI, the difference value of the PL may be applied when determining the PL within the transmission power for the corresponding UL transmission, and the corresponding UL transmission may be considered for the UL-only TRP. When it is not included, the difference value of the PL may be not applied for the corresponding UL transmission.

Since the UE may be configured to one difference value of the PL and use the same, the signaling exchange between the UE and the BS may be relatively simplified from the perspective of managing the difference value of the PL. In addition, depending on the characteristics of the unified TCI state, in case that the UE is indicated to a specific TCI state, it may be applied from a specific time and maintained and used until a new TCI state is indicated and applied, and the UE may dynamically switch UL transmission for UL-only TRP and UL transmission for TRP capable of operating in both UL and downlink, based on the DCI, without indicating a new TCI state through the corresponding method. However, when considering the difference value of one PL, there may be a problem in when more than one UL-only TRP is considered.

The UE may be configured to one difference value of PL from the BS through higher layer signaling. The configuration for the corresponding difference value of the PL may be different for each BWP, or may be different for each cell and the same value may be configured for all BWPs in the cell. In this case, the UE may expect that a new field indicating whether to apply the difference value of the PL is included in the DCI in case that the difference value of the PL is configured. The UE may distinguish, through the corresponding new field in the DCI, whether the UL transmission is for the UL-only TRP from the BS through the DCI or for a UL transmission for the TRP capable of both UL and DL operations, and the corresponding new field may indicate an additional offset of a specific value from the difference value of one PL configured through higher layer signaling. The corresponding new field may be 2 bits, and if its value is 00, the difference value of the PL configured through higher layer signaling may be applied when determining the PL within the transmission power for the corresponding UL transmission (i.e., it may be considered that no additional offset is applied from the difference value of the PL configured through higher layer signaling). If the value is 01, 10, or 11, the UE may assume that the additional offset from the difference value of the PL configured through higher layer signaling is considered to determine the final difference value of the PL, and if it is 01, 10, or 11, −3 dB, 1 dB, or 3 dB may be applied, respectively. In another method, the new field in the DCI may be 2 bits, and if the value is 00, the difference value of the PL may not be applied, and if the value is 11, the difference value of the PL configured through the higher layer signaling may be applied when determining the PL within the transmission power for the corresponding UL transmission (i.e., it may be considered that no additional offset is applied from the difference value of the PL configured through the higher layer signaling), and if the value is 01 or 10, the UE may assume that the additional offset from the difference value of the PL configured through the higher layer signaling is considered to determine the final difference value of the PL, and −3 dB or 3 dB may be applied when 01 or 10, respectively. The above example shows the value (or codepoint) of the corresponding new field and the corresponding operation, and each value of the corresponding new field and the corresponding operation may be different from the above example.

Since the UE may be configured to and use one PL difference value and additionally compensate for the PL difference value through DCI, it may use a relatively accurate PL difference value rather than using only the value configured through the higher layer signaling in case that the UE has high mobility. However, there may be a disadvantage in that additional DCI overhead may increase to indicate such an accurate PL difference value.

The UE may be configured to one or more PL difference values from the BS through higher layer signaling. The configuration for the corresponding PL difference value may be different for each BWP, or may be different for each cell, so that the same value may be configured for all BWPs in the cell. In this case, the UE may expect that a new field indicating whether to apply the PL difference value is included in the DCI in case that the PL difference value is configured. The UE may distinguish whether the UL transmission is for the UL-only TRP or a UL transmission for the TRP capable of operating in both UL and DL through the DCI from the BS, through the corresponding new field in the DCI. The corresponding new field may be expressed as a number of bits that may express the number of difference values of the configured PL, and may transfer a specific difference value of the PL for each codepoint, and may indicate that at least one of all codepoints does not apply the difference value of the PL.

Since the UE may be configured to and use a plurality of difference values of the PL, from the perspective of managing the difference value of the PL, the signaling exchange between the UE and the BS may be relatively additional compared to the situation of managing one PL, but when considering the difference values of a plurality of PL's, it may be advantageous when considering more than one UL-only TRP.

### Method 14

The UE may consider at least one combined method among the above Method 10 to Method 13.

For example, the UE may consider a combined method of the above Method 11 and the above Method 12.

The UE may be configured to a plurality of pathlossReferenceRSGroups as higher layer signaling as in the above Method 11, and may recognize a connection relationship between pathlossOffset, which may indicate a difference value of PL, and pathlossReferenceRSList, which consists of one or more PL measurement reference signals (e.g., PathlossReferenceRS-Id-r17) through pathlossReferenceRSGroup.

The UE may assume that the difference value of PL is applied to a specific TCI state as in the above Method 12. For example, in case that the UE operates with multiple TRPs based on the multi-DCI scheme, the UE does not apply the difference value of the PL to the TCI state indicated through the DCI transmitted to the UE within the CORESET in which the higher layer signaling, coresetPoolIndex, is configured to 0, and, for the TCI state indicated through the DCI transmitted to the UE within the CORESET in which the higher layer signaling, coresetPoolIndex, is configured to 1, the UE may determine the final PL by applying the difference value of the configured PL to the PL calculated using pathlossReferenceRS-Id-r17 indicated through the corresponding TCI state. Alternatively, in case that the UE operates in multi-TRP based on the single-DCI scheme, the UE may not apply the difference value of the PL to the first TCI state (or UL TCI state) among the two TCI states (or UL TCI states) indicated through DCI, and may apply the difference value of the PL configured above to the PL calculated using pathlossReferenceRS-Id-r17 indicated through the corresponding TCI state (or UL TCI state) for the second TCI state (or UL TCI state) to determine the final PL.

In this case, the UE may apply different PL difference values depending on which pathlossReferenceRSGroup the PL measurement reference signal indicated through the corresponding TCI state is included in for the specific TCI state considered in the above Method 12, through the connection relationship between the pathlossOffset, which may indicate the difference value of the PL considered in the above Method 11, and the pathlossReferenceRSList, which is composed of one or more PL measurement reference signals (e.g., PathlossReferenceRS-Id-r17). In addition, some of the PL measurement reference signals are configured not to be included in the pathlossReferenceRSGroup, so that even if a specific TCI state considered in the above Method 12 is indicated, the difference value of the PL may not be applied in some cases. For example, in case that the UE operates with multiple TRPs based on the multi-DCI scheme and pathlossReferenceRS-Id-r17 in the TCI state indicated through DCI transmitted to the UE within a CORESET in which higher layer signaling, coresetPoolIndex, is configured to 1, is not included in any of the one or more configured pathlossReferenceRSGroups, since the corresponding pathlossReferenceRS-Id-r17 does not have a difference value for the associated PL, the UE may not apply the difference value for the PL to the UL signal corresponding to the corresponding specific TCI state. Alternatively, in case that the UE operates with multiple TRPs based on the single-DCI scheme, and the pathlossReferenceRS-Id-r17 in the second TCI state (or UL TCI state) indicated through the DCI is not included in any of the one or more configured pathlossReferenceRSGroups, the corresponding pathlossReferenceRS-Id-r17 does not have a difference value of the associated PL, so the UE may not apply the difference value of the PL to the UL signal corresponding to the corresponding specific TCI state (or UL TCI state).

When using the combined method as described above, since the difference values of the plurality of PLes may be operated without changing the TCI state structure, it may be convenient when receiving scheduling in a cell where a plurality of UL-only TRPs are installed. Further, since the difference value of the PL does not always have to be applied for a specific TCI state, it may not be necessary to consider the constraint that scheduling for UL-only TRPs must be included semi-statically, so it can be advantageous for receiving flexible scheduling.

Alternatively, the UE may consider a method that combines the above Method 12 and the above Method 13.

The UE may be configured to one difference value of the PL through higher layer signaling as in the above Method 12, and may apply or not apply the PL to a specific TCI state.

In this case, the UE may apply an additional offset to the difference value of the PL through a new field in the DCI as in the above Method 13.

As an example, the UE operates in a multi-TRP based on the above multi-DCI scheme, and may receive an indication on whether to apply the PL itself and, if applied, what additional offset will be considered, through a new field indicated in the same DCI, to calculate the PL when the TCI state indicated through the DCI transmitted to the UE in the CORESET in which the higher layer signaling, coresetPoolIndex, is configured to 1, is applied. Alternatively, the UE operates in multi-TRP based on the single-DCI scheme, and may receive an indication on whether to apply the PL itself and, if applied, what additional offset will be considered, through a new field indicated in the same DCI, to calculate the PL when UL transmission to which the second TCI state (or UL TCI state) indicated through DCI is applied.

### Method 15

The UE may be configured to one or more PL difference values (PL offset: PL offset) from the BS through higher layer signaling. The higher layer signaling for the corresponding PL difference values may be different for each BWP, or may be different for each cell, and the same value may be configured for all BWPs in the cell.

The UE may be configured to higher layer signaling for the PL difference values in the joint TCI state or UL TCI state configured through higher layer signaling. In the description of an embodiment of the disclosure, the higher layer signaling for the PL difference values may be named PL offset configuration. Each PL offset configuration has its own index and its own PL difference value. When the maximum number of PL offset configurations that the UE may be configured to is K, the corresponding index may be from 0 to K−1. The corresponding index may be from 0 to a value (K−1) that is one less than the maximum number of PL offset configurations. Alternatively, the corresponding index may be from 1 to the maximum number of PL offset configurations (K). In case that the UE receives a joint TCI state or UL TCI state in which the index of the PL offset configuration (or the PL offset configuration) is not configured, the UE may consider the difference value of the PL as 0 dB. In this case, the UE may expect that the joint TCI state connected to the PL offset configuration is configured only in FRI, and the UL TCI state connected to the PL offset configuration may be configured in both FRI and FR2.

Through the above method, the same one PL offset configuration index may be configured to one or more joint TCI states or one or more UL TCI states. In this case, in case that the UE uses one or more joint TCI states or one or more UL TCI states in which the index of the same PL offset configuration is configured, the difference value of the PL to be applied to the PL may be considered equally when determining the UL transmission power.

The UE may update the difference value of the PL for the PL offset configuration of a specific index by receiving MAC-CE from the BS. The UE may receive a PDSCH including the corresponding MAC-CE and update and use the difference value of the PL activated by the corresponding MAC-CE from 3 ms after the PUCCH transmission including HARQ-ACK information for the corresponding PDSCH. In this case, in case that the same PL offset configuration is connected to one or more joint TCI states and UL TCI states. When the UE is indicated by the BS to update the difference value of the PL for a specific PL offset configuration through the MAC-CE, the UE may update the difference value of the PL within the PL offset configuration, and such update may be applied to all joint TCI states or UL TCI states to which the corresponding PL offset configuration is connected. In other words, the UE may simultaneously update the difference value of the PL for one or more joint TCI states or UL TCI states through the corresponding MAC-CE. In this case, when the UE performs an update on the difference value of the PL for a specific PL offset configuration through MAC-CE, the UE may apply the corresponding MAC-CE only to the activated joint TCI state or UL TCI state within the activated BWP of the UE, or may apply the corresponding MAC-CE not only to the activated joint TCI state or UL TCI state, but also to the joint TCI state or UL TCI state that is configured to the UE but is not activated. In this case, the activation of the joint TCI state or UL TCI state for the UE may indicate that the UE receives a MAC-CE that activates the TCI state from the BS, and the joint TCI state or UL TCI state included in the corresponding MAC-CE is activated and may be dynamically indicated to the UE through the codepoint of the TCI state field in the DCI. At least one or a combination of at least two of the following items may be considered as information that may be included in the corresponding MAC-CE signaling: Serving cell ID field (e.g., 5 bits), UL BWP ID field (e.g., 2 bits), PL measurement reference signal ID field (e.g., 6 bits), PL offset configuration index field (e.g., 2 to 6 bits), PL difference value d_P field (e.g., 5 to 8 bits), PL difference value change amount d_P″ field (e.g., 5 to 8), and joint TCI state or UL TCI state field (each 7 or 6 bits).

In addition, simultaneous updates for a plurality of PL offset configurations may also be possible for the UE through the corresponding MAC-CE. To this end, the UE may expect that there are one or more PL offset configuration index fields, one or more PL difference values, or a change amount field of PL difference value, in the corresponding MAC-CE.

Table 33 below reflects the above Method 15 using when a list of PL offset configurations is configured within a BWP.

In Table 33, TCI-State and TCI-UL-State may represent higher layer signaling for joint TCI state and UL TCI state, respectively. In each PL offset configuration, the higher layer signaling called pathlossOffset, which represents an index of the PL offset configuration and a PL offset value, such as pathlossOffsetConfigId-r19, may be configured. In this case, the UE may similarly consider the items regarding the pathlossOffset value considered within the above Method 11, for the minimum value, maximum value, and total value range of the pathlossOffset, which is the higher layer signaling. In addition, as described above, the UE may be configured with an index of a PL offset configuration through higher layer signaling in each joint TCI state or UL TCI state. When the UE receives a joint TCI state or UL TCI state in which the index of the PL offset configuration is configured, the UE may apply the pathlossOffset value included in the PL offset configuration corresponding to the index of the corresponding PL offset configuration to the PL when calculating UL transmission power. In case that the UE receives a joint TCI state or UL TCI state in which the index of the PL offset configuration is not configured, the UE may regard the pathlossOffset value as 0 dB. The UE may report the maximum number of PL offset configurations that the UE may be configured (i.e., the maximum value of the PL offset configuration index) and the maximum number of PL offset configurations that the UE may be activated as UE capability.

TABLE 33
BWP-UplinkDedicated ::= SEQUENCE {
...

| | |
|---|---|
| pathlossOffsetConfigList | SEQUENCE (SIZE (1.. |

| | |
|---|---|
| maxNrofPathlossOffsetConfig-r19)) OF pathlossOffsetConfig-r19 | OPTIONAL -- |

Need R
}
pathlossOffsetConfig::= SEQUENCE {

| | |
|---|---|
| pathlossOffsetConfigId-r19 | INTEGER (0... maxNrofPathlossOffsetConfig-r19- |

1)OPTIONAL -- Need R

| | | |
|---|---|---|
| pathlossOffset | INTEGER (Xs..Xe) | OPTIONAL -- Need R |

}
TCI-State ::= SEQUENCE {

| tci-StateId | TCI-StateId, | |
|---|---|---|
| qcl-Type1 | QCL-Info, | |
| qcl-Type2 | QCL-Info | OPTIONAL, -- Need R |

```
    ...,
    [[
```

| | | |
|---|---|---|
| additionalPCI-r17 | AdditionalPCIIndex-r17 | OPTIONAL, -- Need R |
| pathlossReferenceRS-Id-r17 | PathlossReferenceRS-Id-r17 | OPTIONAL, -- Cond |

JointTCI1

| | | |
|---|---|---|
| ul-powerControl-r17 | Uplink-powerControlId-r17 | OPTIONAL -- Cond |

JointTCI
]]

| | | |
|---|---|---|
| pathlossOffsetConfig | pathlossOffsetConfigId-r19 | OPTIONAL -- Cond |

ULonlyNode
}
TCI-UL-State-r17 ::= SEQUENCE {

| tci-UL-StateId-r17 | TCI-UL-StateId-r17, | |
|---|---|---|
| servingCellId-r17 | ServCellIndex | OPTIONAL, -- Need R |
| bwp-Id-r17 | BWP-Id | OPTIONAL, -- Cond CSI-RSorSRS- |

Indicated
referenceSignal-r17 CHOICE {

| | |
|---|---|
| ssb-Index-r17 | SSB-Index, |
| csi-RS-Index-r17 | NZP-CSI-RS-ResourceId, |
| srs-r17 | SRS-ResourceId |

},

| | | |
|---|---|---|
| additionalPCI-r17 | AdditionalPCIIndex-r17 | OPTIONAL, -- Need R |
| ul-powerControl-r17 | Uplink-powerControlId-r17 | OPTIONAL, -- Need R |
| pathlossReferenceRS-Id-r17 | PathlossReferenceRS-Id-r17 | OPTIONAL, -- Cond |

Mandatory

| | | |
|---|---|---|
| pathlossOffsetConfig | pathlossOffsetConfigId-r19 | OPTIONAL -- Cond |

ULonlyNode
}

### Method 16

The UE may be configured to one or more PL difference values from the BS through higher layer signaling. The higher layer signaling for the corresponding PL difference values may be different for each BWP, or may be different for each cell, and the same value may be configured for all BWPs within the cell.

The UE may be configured to the higher layer signaling for the PL difference values in the joint TCI state or UL TCI state configured through higher layer signaling. In the following description, the higher layer signaling for the PL difference values may be named PL offset configuration. Each PL offset configuration has its own index and its own PL difference value. When the maximum number of PL offset configurations that the UE may be configured to is K, the corresponding index may be from 0 to K−1. The corresponding index may be from 0 to a value (K−1) that is one less than the maximum number of PL offset configurations. Alternatively, the corresponding index may be from 1 to the maximum number of PL offset configurations (K). In case that the UE receives a joint TCI state or UL TCI state in which the index of the PL offset configuration (or PL offset configuration) is not configured, the UE may regard the difference value of the PL as 0 dB. In this case, the UE may expect that the joint TCI state connected to the PL offset configuration is configured only in FR1, and the UL TCI state connected to the PL offset configuration may be configured in both FRI and FR2. The higher layer signaling structure of the PL offset configuration and the higher layer signaling structure in which the PL offset configuration is connected to the joint TCI state and UL TCI state may be referred to in Table 33 above.

The UE may receive MAC-CE from the BS to update the connection relationship between a specific joint TCI state or UL TCI state and a specific PL offset configuration. For example, after the UE is configured to the first PL offset configuration in the first joint TCI state from the BS through higher layer signaling, the UE may additionally receive a MAC-CE from the BS to update the second PL offset configuration to be connected to the first joint TCI state, instead of the first PL offset configuration. For example, the second PL offset configuration may be indicated in the corresponding additionally received MAC-CE. The UE may receive a PDSCH including the corresponding MAC-CE and update and use the difference value of the PL activated by the corresponding MAC-CE from 3 ms after the PUCCH transmission including HARQ-ACK information for the corresponding PDSCH. The UE may expect that the MAC-CE received from the BS may include one PL offset configuration and include one or more joint TCI states or one or more UL TCI states, and through this, the UE may update each PL offset configuration connected to one or more joint TCI states or one or more UL TCI states with the same PL offset configuration.

As information that may be included in the corresponding MAC-CE signaling, at least one combination of the following items may be considered. That is, the MAC-CE signaling may include at least one combination of the following items. In addition, the UE may update different groups of joint TCI states or UL TCI states to be connected to different PL offset configurations through the corresponding MAC-CE. To this end, the UE may include one or more PL offset configuration index fields and one or more joint TCI states or one or more UL TCI states in the corresponding MAC-CE. In this case, one PL offset configuration may be connected corresponding to some of the joint TCI states or some UL TCI states among the one or more joint TCI states or the one or more UL TCI states, and another PL offset configuration may be connected corresponding to some of the joint TCI states or some UL TCI states among the one or more joint TCI or UL TCI states: Serving cell ID field (e.g., 5 bits), UL BWP ID field (e.g., 2 bits), PL measurement reference signal ID field (e.g., 6 bits), PL offset configuration index field (e.g., 2 to 6 bits), PL difference value d_P field (e.g., 5 to 8 bits), PL difference value change amount d_P″ field (e.g., 5 to 8), and joint TCI state or UL TCI state field (each 7 or 6 bits).

The PL offset configuration considered in the above-described Method 15 and Method 16 may be similarly used/applied not only for indicating a difference value of PL through a joint TCI state or UL TCI state, but also for when the difference value of PL is applied to a PRACH transmission triggered through a PDCCH order that the UE may receive through DCI format 1_0. For example, in case that the difference value of PL is applied to a PRACH transmission triggered through a PDCCH order, the UE may be indicated of one value among one or more PL offset configurations configured to the UE through higher layer signaling and a value corresponding to 0 dB through a field in the corresponding PDCCH order. For example, in case that the UE is configured to N PL offset configurations in a BWP or in a cell, the UE may be indicated about the difference value of the PL through a new field of ceil (log 2 (N+1)) bits that may indicate the difference value of the PL within the PDCCH order (e.g., a new field in DCI received through a PDCCH order that triggers a PRACH transmission). In this case, one more codepoint is additionally considered in addition to the N codepoints because it should be able to indicate the difference value of the PL of 0 dB, which may indicate transmission in the TRP capable of both DL and UL operations, not the UL only TRP. As another method, the UE may consider that a new field capable of indicating a difference value of PL within a PDCCH order (e.g., a new field within DCI received through PDCCH order that triggers PRACH transmission) is fixed to an arbitrary M bits or configured through higher layer signaling from the BS. In case that a total number of PL offset configurations configured by the UE through higher layer signaling is greater than 2^{M}, the UE may select 2^{M} of the total PL offset configurations from the BS through MAC-CE and activate the meaning of each codepoint of the new field capable of indicating a difference value of PL within a PDCCH order (e.g., a new field within DCI received through PDCCH order that triggers PRACH transmission).

The UE may be notified from the BS through at least one combination of higher layer signaling, MAC-CE signaling, and L1 signaling for at least one combined method among the above Method 15 and Method 16, or may follow a scheme fixedly defined in the standard. In addition, each of the above Method 15 and Method 16, the UE may support only the method configured through higher layer signaling, or may perform individual UE capability reporting for supporting a method for updating specific information through MAC-CE as described above, in addition to the method configured through higher layer signaling, and may be configured with higher layer signaling for distinguishing them. That is, in case that the UE has been configured to the corresponding higher layer signaling, the UE may support the update scheme through MAC-CE for the above Method 15 and Method 16, otherwise (in case that the UE has not been configured to the corresponding higher layer signaling), the UE may support only the configuration method through higher layer signaling for the above Method 15 and Method 16 and not the update scheme through MAC-CE. As another method, in case that the UE supports the update scheme through MAC-CE, in addition to the configuration method through higher layer signaling for the above Method 15 and Method 16, the UE may report the UE capability to the BS, and the BS that has received the UE capability may support the update scheme through MAC-CE without configuring additional higher layer signaling for the UE.

The UE may be notified of at least one combination of the above Method 10 to Method 16 from the BS through at least one combination of higher layer signaling, MAC-CE signaling, and L1 signaling, or may expect that at least one combination of the above Method 10 to Method 16 is fixedly defined in the standard. Additionally, in case that the UE is notified of a combination of specific one or more methods from the BS through at least one combination of higher layer signaling, MAC-CE signaling, and L1 signaling, it may indicate that the UE cannot support specific one or more other combinations of methods. For example, the UE may be indicated of the difference value of the PL and may expect that Method 11 is fixedly defined in the standard for a method for determining UL transmission power for a TRP capable of UL and DL operations, or determining UL transmission power for a TRP capable of only UL reception operations. Alternatively, the UE may be notified of the above Method 10 by a combination of at least one of higher layer signaling, MAC-CE signaling, and L1 signaling from the BS, and in this case, the UE may consider that the UE has been notified by the BS that the above Method 11 is not supported.

The UE may report to the BS as a UE capability whether it may support at least one combination of the above Method 10 to Method 16. In this case, in case that the UE reports, to the BS, a UE capability that a combination of specific one or more methods is supportable, it may be considered that the UE has reported that it cannot support specific one or more other combinations of methods. As an example, the UE may report to the BS as to whether it may support the above Method 10 or Method 11. Alternatively, the UE may report to the BS that it may support the above Method 10, and this UE capability report may indicate that the UE cannot support Method 11. Alternatively, the UE may report to the BS that it may support the above Method 11, and this UE capability report may indicate that the UE cannot support Method 10.

The UE may determine whether to apply the difference value of the PL by considering at least one combination of Method 10 to Method 16 when performing a PUSCH transmission based on a dynamic grant scheduled on the basis of DCI, a PUSCH transmission based on a Type-2 configured grant activated through DCI, a PUSCH transmission based on a Type-1 configured grant configured through higher layer signaling, a PUCCH transmission, an SRS transmission, or a PRACH transmission.

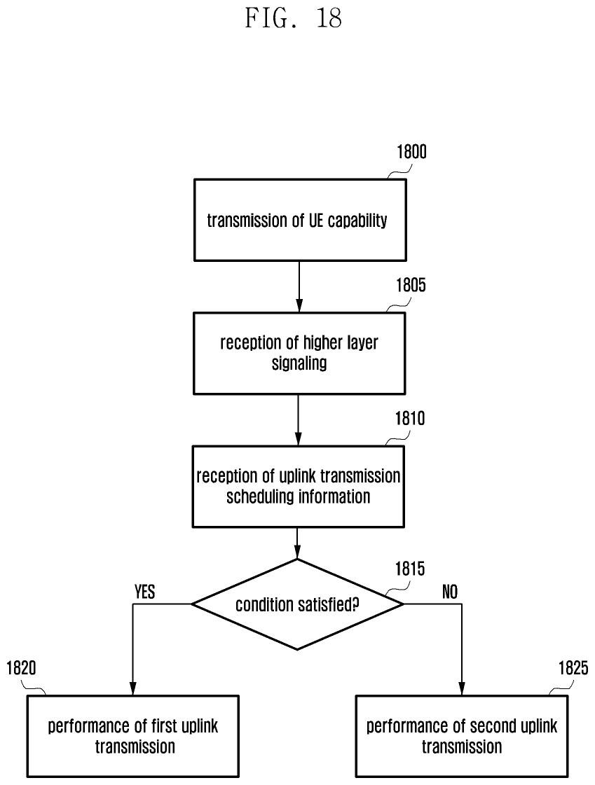

FIG. 18 illustrates an operation of a UE for determining a UL transmission scheme according to an embodiment.

In step 1800, a UE may transmit UE capability to the BS. The UE capability signaling that may be reported in this case may be for a combination of at least one or more of UE capability related to PUSCH, PUCCH, SRS transmission and transmission power parameters, UE capability related to unified TCI state operation, and UE capability indicating whether to support Method 3 and Method 4, Method 5 to Method 9, and Method 10 to Method 16. Step 1800 may be omitted. In step 1805, the UE may receive higher layer signaling from the BS according to the reported UE capability. In this case, the UE may define higher layer parameters for at least one combination of higher layer signaling related to UL signal transmission (e.g., PUSCH, PUCCH, SRS) and transmission power parameters from the BS, higher layer signaling related to unified TCI state operation, and higher layer signaling related to support of Method 3 and Method 4, Method 5 to Method 9, and Method 10 to Method 16, and use one of them.

In step 1810, the UE may receive UL transmission scheduling information from the BS. The UE may receive information about a difference value of PL through at least one combined method of the above Method 10 to Method 16. In addition, the UE may be notified of at least one of a dynamic grant-based PUSCH transmission scheduled based on DCI, a Type-2 configured grant-based PUSCH transmission activated via DCI, a Type-1 configured grant-based PUSCH transmission configured through higher layer signaling, a periodic, semi-persistent, or aperiodic PUCCH transmission, a periodic, semi-persistent, or aperiodic SRS transmission, and a PRACH transmission, through a combination of at least one of higher layer signaling, MAC-CE signaling, and L1 signaling.

In step 1815, the UE may perform different UL transmission operations according to conditions of the UL transmission scheduling information received in step 1810. In case that the UL transmission scheduling information received by the UE in step 1810 includes information related to a difference value of PL, the UE may perform a first UL transmission operation in step 1820. That is, the corresponding UL transmission operation of the UE may be understood as a UL transmission for UL-only TRP. In case that the UL transmission scheduling information received by the UE in step 1810 does not include information related to the difference value of the PL, the UE may perform the second UL transmission operation (1825). That is, the corresponding UL transmission operation of the UE may be understood as a UL transmission for TRP that may operate in both UL and downlink.

The above-described flowchart illustrates an exemplary method that can be implemented according to the principle of the disclosure, and various changes can be made to the method illustrated in the flowchart in the present specification. For example, although illustrated as a series of operations, various operations in each drawing can overlap, occur in parallel, occur in different orders, or occur multiple times. In other examples, operations can be omitted or replaced with other operations.

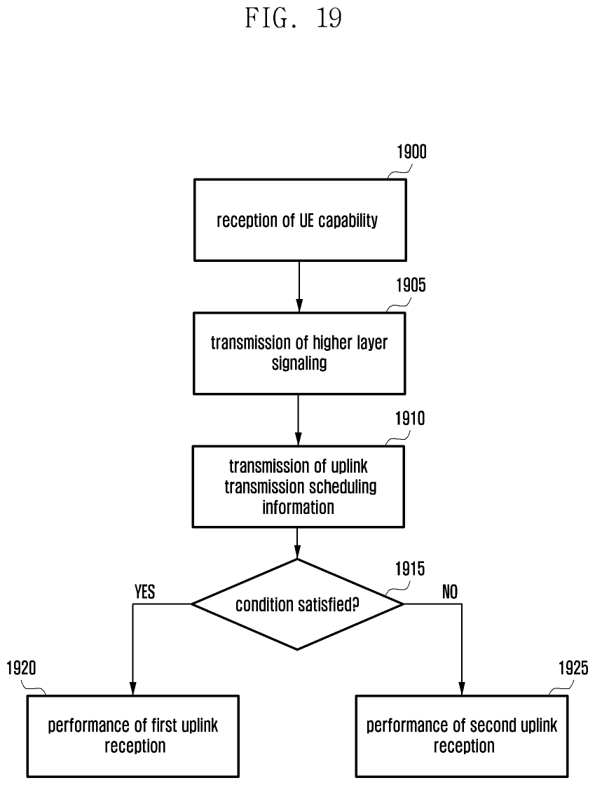

FIG. 19 illustrates a method of a BS for determining a UL transmission scheme according to an embodiment.

In step 1900, a BS may receive UE capability from the UE. The UE capability signaling that may be reported in this case may be for a combination of at least one or more of UE capability related to UL signal (e.g., PUSCH, PUCCH, SRS) transmission and transmission power parameters, UE capability related to unified TCI state operation, and UE capability indicating whether to support Method 3 and Method 4, Method 5 to Method 9, and Method 10 to Method 16. The operation 1900 may be omitted.

In step 1905, the BS may transmit higher layer signaling to the UE according to the UE capabilities reported by the UE. In this case, the BS may define higher layer parameters for at least one combination of higher layer signaling related to UL signal (e.g., PUSCH, PUCCH, SRS) transmission and transmission power parameters for the UE, higher layer signaling related to unified TCI state operation, and higher layer signaling related to support of [Method 3] and [Method 4], [Method 5] to [Method 9], and [Method 10] to [Method 16], and use one of them.

In step 1910, the BS may transmit UL transmission scheduling information to the UE. In this case, the BS may transmit information about a difference value of PL to the UE through at least one combined method among the above Method 10 to Method 16. In addition, the bae station may notify the UE of at least one of a dynamic grant-based PUSCH transmission scheduled based on DCI, a Type-2 configured grant-based PUSCH transmission activated via DCI, a Type-1 configured grant-based PUSCH transmission configured through higher layer signaling, a periodic, semi-persistent, or aperiodic PUCCH transmission, a periodic, semi-persistent, or aperiodic SRS transmission, and a PRACH transmission, through a combination of at least one of higher layer signaling, MAC-CE signaling, and L1 signaling.

In step 1915, the BS may perform different UL transmission operations according to the conditions of the UL transmission scheduling information transmitted to the UE in step 1910. In case that the UL transmission scheduling information transmitted by the BS in step 1910 includes information related to the difference value of the PL, the BS may perform a first UL reception operation (1920). That is, the BS may understand that the corresponding UL transmission operation of the UE is UL reception in the UL-only TRP. In case that the UL transmission scheduling information transmitted by the BS in step 1910 does not include information related to the difference value of the PL, the BS may perform a second UL reception operation (1925). That is, the BS may understand that the corresponding UL transmission operation of the UE is UL reception in the TRP that may operate both in the UL and downlink.

The above-described flowchart illustrates an exemplary method that can be implemented according to the principles of the disclosure, and various changes can be made to the method illustrated in the flowchart in the present specification. For example, although illustrated as a series of operations, various operations in each drawing can overlap, occur in parallel, occur in different orders, or occur multiple times. In other examples, operations can be omitted or replaced with other operations.

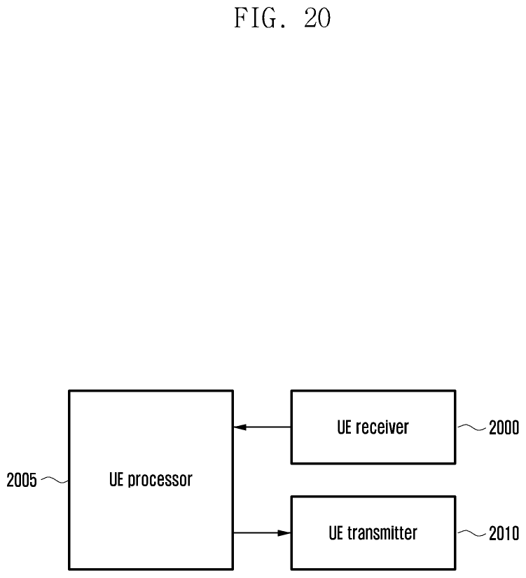

FIG. 20 illustrates the structure of a UE in a wireless communication system according to an embodiment.

Referring to FIG. 20, the UE may include a transceiver with reference to a UE receiver 2000 and a UE transmitter 2010, a memory, and a UE processor 2005 (or a UE controller or processor). According to the above-described communication method of the UE, the UE transceiver 2000 and 2010, the memory, and the UE processor 2005 may operate. However, the elements of the UE are not limited to the above-described examples. For example, the UE may include more or fewer elements than the aforementioned elements. In addition, the transceiver, the memory, and the processor may be implemented in the form of one chip.

The transceiver may transmit/receive a signal to/from the BS. The signal may include control information and data. To this end, the transceiver may include an RF transmitter for up-converting and amplifying a frequency of a transmitted signal, an RF receiver for low-noise amplifying a received signal and down-converting a frequency, and the like. However, this is only one embodiment of the transceiver, and the elements of the transceiver are not limited to the RF transmitter and the RF receiver.

In addition, the transceiver may receive a signal through a wireless channel, output the same to the processor, and transmit a signal output from the processor through a wireless channel.

The memory may store programs and data necessary for the operation of the UE. In addition, the memory may store control information or data included in a signal transmitted and received by the UE. The memory may include a storage medium such as a read only memory (ROM), a random access memory (RAM), a hard disk, a compact disc read only memory (CD-ROM), and a digital versatile disc (DVD), or a combination thereof. In addition, a plurality of memories may be provided. In addition, the processor may control a series of processes such that the UE operates according to the above-described embodiment. For example, the processor may control the elements of the UE to receive DCI configured with two layers, thereby simultaneously receiving a plurality of PDSCHs. A plurality of processors may be provided, and the processor may execute a program stored in the memory to perform an element control operation of the UE.

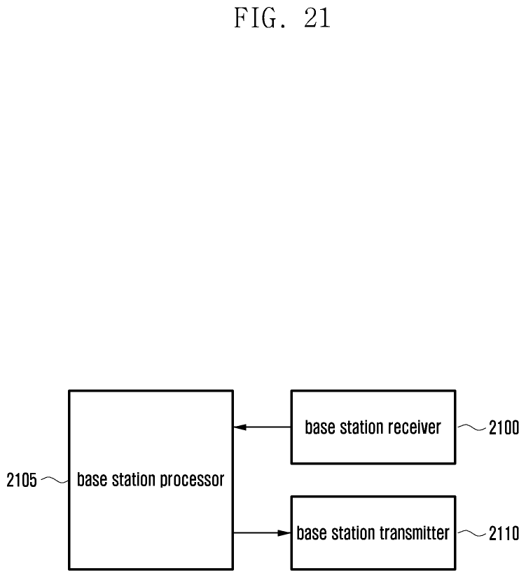

FIG. 21 illustrates the structure of a BS in a wireless communication system according to an embodiment.

Referring to FIG. 21, the BS may include a transceiver with reference to a BS receiver 2100 and a BS transmitter 2110, a memory, and a BS processor 2105 (or a BS controller or processor). According to the above-described communication method of the BS, the BS transceiver 2100 and 2110, the memory, and the BS processor 2105 may operate. However, the elements of the BS are not limited to the above-described examples. For example, the BS may include more or fewer elements than the aforementioned elements. In addition, the transceiver, the memory, and the processor may be implemented in the form of one chip.

The transceiver may transmit/receive a signal to/from the BS. The signal may include control information and data. To this end, the transceiver may include an RF transmitter for up-converting and amplifying a frequency of a transmitted signal, an RF receiver for low-noise amplifying a received signal and down-converting a frequency, and the like. However, this is only one embodiment of the transceiver, and the elements of the transceiver are not limited to the RF transmitter and the RF receiver.

In addition, the transceiver may receive a signal through a wireless channel, output the same to the processor, and transmit a signal output from the processor through a wireless channel.

The memory may store programs and data necessary for the operation of the BS. In addition, the memory may store control information or data included in a signal transmitted and received by the BS. The memory may include a storage medium such as a ROM, a RAM, a hard disk, a CD-ROM, and a DVD, or a combination thereof. In addition, a plurality of memories may be provided.

The processor may control a series of processes such that the BS operates according to the above-described embodiment. For example, the processor may control the respective elements of the BS so as to configure and transmit two-layer DCI including allocation information for a plurality of PDSCHs. A plurality of processors may be provided, and the processor may execute a program stored in the memory to perform an element control operation of the BS.

The methods according to embodiments described in the claims or the specification of the disclosure may be implemented by hardware, software, or a combination of hardware and software.

In case that the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access an apparatus performing the embodiments of the disclosure, via an external port. Further, a separate storage device on the communication network may access an apparatus performing the embodiments of the disclosure.

Herein, each block of the flowchart illustrations, and combinations of blocks in the flowchart illustrations, can be implemented by computer program instructions. These computer program instructions may be loaded in a processor of a general purpose computer, a special purpose computer, or other programmable data processing equipment, and thus, the instructions performed by a processor of a computer or other programmable data processing equipment may generate a means configured to perform functions described in flowchart block(s). These computer program instructions may also be stored in a computer usable or computer-readable memory that can direct a computer or other programmable data processing equipment to function in a particular manner, such that the instructions stored in the computer usable or computer-readable memory produce an article of manufacture including instruction means that implement the function specified in the flowchart block(s). These computer program instructions may also be loaded in a computer or other programmable data processing equipment, and thus, a computer-executable process may also be generated by performing a series of operation steps on the computer or the other programmable data processing equipment so that the instructions executed in the computer or the other programmable data processing equipment provide steps for executing functions described in flowchart block(s).

Furthermore, each block may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the corresponding function

As used herein, the unit refers to a software element or a hardware element, such as a field programmable gate array (FPGA) or application specific integrated circuit (ASIC), which performs a predetermined function. However, the unit does not always have a meaning limited to software or hardware. The unit may be constructed either to be stored in an addressable storage medium or to execute one or more processors. Therefore, the unit includes, for example, elements such as software elements, object-oriented software elements, class elements and task elements, processes, functions, properties, procedures, sub-routines, segments of a program code, drivers, firmware, micro-codes, circuits, data, database, data structures, tables, arrays, and parameters. The elements and functions provided by the unit may be either combined into fewer elements, and a unit, or divided into more elements, and a unit. Moreover, the elements and unit or may be implemented to reproduce one or more CPUs within a device or a security multimedia card. Also, in an embodiment, a unit may include one or more processors.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a communication system, the method comprising:
receiving, via higher layer signaling, a first configuration of a list of transmission configuration indication (TCI) states;
receiving a first medium access control (MAC) control element (CE) mapping TCI states among the TCI states in the list to codepoints of a TCI field in downlink control information (DCI);
receiving the DCI including the TCI field with a codepoint;
identifying an indicated TCI state based on the codepoint;
identifying first transmission power for a first uplink transmission based on a pathloss offset value included in the indicated TCI state; and
transmitting the first uplink transmission based on the first transmission power.

2. The method of claim 1, wherein at least some of the TCI states in the list respectively include pathloss offset values.

3. The method of claim 1, further comprising receiving, via the higher layer signaling, a second configuration of unified TCI state type,
wherein, in case that the second configuration indicates joint, the TCI states in the list are joint TCI states for uplink and downlink operation, and
wherein, in case that the second configuration indicates separate, the TCI states in the list are uplink TCI states.

4. The method of claim 1, further comprising:
receiving a second MAC CE to update the pathloss offset value;
identifying an updated pathloss offset value based on the second MAC CE;
identifying second transmission power for second uplink transmission based on the updated pathloss offset value; and
transmitting the second uplink transmission based on the second transmission power.

5. The method of claim 4, wherein the second MAC CE includes at least one of:
a serving cell identifier (ID) field;
an uplink bandwidth part (BWP) ID field;
a pathloss reference signal ID field;
a pathloss reference signal group field;
an activated pathloss reference signal ID field;
a pathloss offset value field; or
a TCI state field.

6. A user equipment (UE) in a communication system, the UE comprising:
a transceiver; and
a processor coupled with the transceiver and configured to:
receive, via higher layer signaling, a first configuration of a list of transmission configuration indication (TCI) states,
receive a first medium access control (MAC) control element (CE) mapping TCI states among the TCI states in the list to codepoints of a TCI field in downlink control information (DCI),
receive the DCI including the TCI field with a codepoint,
identify an indicated TCI state based on the codepoint,
identify first transmission power for a first uplink transmission based on a pathloss offset value included in the indicated TCI state, and
transmit the first uplink transmission based on the first transmission power.

7. The UE of claim 6,
wherein at least some of the TCI states in the list respectively include pathloss offset values.

8. The UE of claim 6,
wherein the processor is further configured to receive, via the higher layer signaling, a second configuration of a unified TCI state type,
wherein, in case that the second configuration indicates joint, the TCI states in the list are joint TCI states for uplink and downlink operation, and
wherein, in case that the second configuration indicates separate, the TCI states in the list are uplink TCI states.

9. The UE of claim 6, wherein the processor is further configured to:
receive a second MAC CE to update the pathloss offset value,
identify an updated pathloss offset value based on the second MAC CE,
identify second transmission power for second uplink transmission based on the updated pathloss offset value, and
transmit the second uplink transmission based on the second transmission power.

10. The UE of claim 9, wherein the second MAC CE includes at least one of:
a serving cell identifier (ID) field;
an uplink bandwidth part (BWP) ID field;
a pathloss reference signal ID field;
a pathloss reference signal group field;
an activated pathloss reference signal ID field;
a pathloss offset value field; or
a TCI state field.

11. A method performed by a base station in a communication system, the method comprising:
transmitting, via higher layer signaling, a first configuration of a list of transmission configuration indication (TCI) states;
transmitting a first medium access control (MAC) control element (CE) mapping TCI states among the TCI states in the list to codepoints of a TCI field in downlink control information (DCI);
transmitting the DCI including the TCI field with a codepoint; and
receiving a first uplink transmission associated with first transmission power, wherein the first transmission power is based on a pathloss offset value included in a TCI state indicated by the codepoint.

12. The method of claim 11,
wherein at least some of the TCI states in the list respectively include pathloss offset values.

13. The method of claim 11, further comprising transmitting, via the higher layer signaling, a second configuration of a unified TCI state type,
wherein, in case that the second configuration indicates joint, the TCI states in the list are joint TCI states for uplink and downlink operation, and
wherein, in case that the second configuration indicates separate, the TCI states in the list are uplink TCI states.

14. The method of claim 11, further comprising:
transmitting a second MAC CE to update the pathloss offset value; and
receiving second uplink transmission associated with second transmission power,
wherein the second transmission power is based on an updated pathloss offset value associated with the second MAC CE.

15. The method of claim 14, wherein the second MAC CE includes at least one of:
a serving cell identifier (ID) field;
an uplink bandwidth part (BWP) ID field;
a pathloss reference signal ID field;
a pathloss reference signal group field;
an activated pathloss reference signal ID field;
a pathloss offset value field; or
a TCI state field.

16. A base station (BS) in a communication system, the BS comprising:
a transceiver; and
a processor coupled with the transceiver and configured to:
transmit, via higher layer signaling, a first configuration of a list of transmission configuration indication (TCI) states,
transmit a first medium access control (MAC) control element (CE) mapping TCI states among the TCI states in the list to codepoints of a TCI field in downlink control information (DCI),
transmit the DCI including the TCI field with a codepoint, and
receive a first uplink transmission associated with first transmission power,
wherein the first transmission power is based on a pathloss offset value included in a TCI state indicated by the codepoint.

17. The BS of claim 16,
wherein at least some of the TCI states in the list respectively include pathloss offset values.

18. The BS of claim 16, wherein the processor is further configured to transmit, via the higher layer signaling, a second configuration of unified TCI state type,
wherein, in case that the second configuration indicates joint, the TCI states in the list are joint TCI states for uplink and downlink operation, and
wherein, in case that the second configuration indicates separate, the TCI states in the list are uplink TCI states.

19. The BS of claim 16, wherein the processor is further configured to:
transmit a second MAC CE to update the pathloss offset value, and
receive second uplink transmission associated with second transmission power,
wherein the second transmission power is based on an updated pathloss offset value associated with the second MAC CE.

20. The BS of claim 19, wherein the second MAC CE includes at least one of:
a serving cell identifier (ID) field;
an uplink bandwidth part (BWP) ID field;
a pathloss reference signal ID field;
a pathloss reference signal group field;
an activated pathloss reference signal ID field;
a pathloss offset value field; or
a TCI state field.
